(19) United States
(12) Patent Application Publication
(10) Pub. No.: US 2024/0278207 A1
(43) Pub. Date: Aug. 22, 2024

(54) A SIMPLE METAL-ORGANIC FRAMEWORK FOR THE SELECTIVE ADSORPTION OF CARBON DIOXIDE FROM FLUE GAS

(71) Applicants: National University of Singapore, Singapore (SG); Agency for Science, Technology and Research, Singapore (SG)

(72) Inventors: Dinesh Mullangi, Singapore (SG); Zeyu Deng, Singapore (SG); Yuxiang Wang, Singapore (SG); John Wang, Singapore (SG); Pieremanuele Canepa, Singapore (SG); Dan Zhao, Singapore (SG); Anthony Kevin Cheetham, Singapore (SG); Fengxia Wei, Singapore (SG)

(73) Assignees: c/o National University of Singapore, Singapore (SG); Agency for Science, Technology and Research, Singapore (SG)

(21) Appl. No.: 18/568,156

(22) PCT Filed: Jun. 6, 2022
(86) PCT No.: PCT/SG2022/050383

§ 371 Date: Dec. 7, 2023

(51) Int. Cl. B01J 20/22; B01D 53/04; B01J 20/28; B01J 20/34; C07F 5/06; C07F 15/02

(52) U.S. Cl. CPC B01J 20/226; B01D 53/04; B01J 20/28061; B01J 20/28064; B01J 20/3483; B01J 20/3491; C07F 5/061; C07F 15/02; B01D 2257/104; B01D 2257/504

(57) ABSTRACT

Discloses herein is an activated metal-organic framework of formula as defined in the application, and the metal organic framework has a BET surface area of from 250 to 1,000 m²/g as obtained from a 298 K CO₂ sorption isotherm. In a particular embodiment, the activated metal-organic framework is aluminium formate (Al(HCOO)₃) or vanadium formate (V(HCOO)₃).

### FIELD OF INVENTION

The invention relates to a simple metal-organic framework for the selective adsorption of CO₂ from flue gas. The current invention also relates to methods of adsorbing CO₂ and/or O₂ from a gas with the metal-organic framework, releasing CO₂ and/or O₂ from the metal-organic framework, and obtaining the activated metal-organic framework.

### BACKGROUND

The listing or discussion of a prior-published document in this specification should not necessarily be taken as an acknowledgement that the document is part of the state of the art or is common general knowledge.

As of 2020, more than 80 percent of the global energy supply is powered by fossil fuel combustion technologies. These combustion methods emit large quantities of greenhouse gases, in particular CO₂, leading to global warming, ocean acidification, sea-level rises, and other serious environmental issues. To reduce the environmental impact of fossil fuel utilization, there is an urgent need for efficient CO₂ capture and storage technologies. Conventional chemical sorbents based on aqueous amine solutions have a considerable capacity for post-combustion CO₂ capture, but their thermal degradation, corrosion, oxidative reactions, and usually energy-intensive regeneration processes are significant disadvantages. By contrast, porous solid sorbents that capture CO₂ via physisorption require less energy for regeneration and are showing great potential for cost-effective CO₂ capture (M. Oschatz & M. Antonietti, Energy Environ. Sci. 2018, 11, 57-70). However, traditional solid sorbents, such as zeolites and porous carbon-based materials also have considerable limitations. In particular, zeolites have inadequate CO₂ uptake capacity in humid gas streams and poor stability in aqueous environments while porous polymer and carbonaceous materials have low adsorption capacities and poor CO₂/N₂ selectivities (R. L. Siegelman et al., Energy Environ. Sci. 2019, 12, 2161-2173).

Metal-organic frameworks (MOFs), with their high surface areas, tuneable pore sizes, surface functionality, and structural diversity, offer several advantages as the next-generation solid adsorbent materials for CO₂ capture (M. Ding et al., Chem. Soc. Rev. 2019, 48, 2783-2828; and J. A. Mason et al., J. Am. Chem. Soc. 2015, 137, 4787-4803). There has been a significant effort to identify MOFs that are capable of the selective capture of CO₂ from post-combustion sources, which typically contain CO₂ (8-16%), O₂ (3-4%), and H₂O (5-7%) balanced by N₂. Several MOFs have shown substantial gravimetric CO₂ uptake capacities for dried flue gas streams, which are normally expressed in terms of mmol of CO₂ per gram of sorbent. However, for practical applications in fixed-bed reactors, a high volumetric capacity, expressed in mmol/cm³, is more relevant, and only a handful of MOFs meet the fixed-bed industrial requirements. Among the leading MOF sorbents, Mg-MOF-74, based on the ligand 2,5-dihydroxyterephthalate (dhtp), displayed 7.4 mmol/cm³ in volumetric capacity and a leading gravimetric capacity of 8.04 mmol/g (1 bar, 298 K) (D.-A. Yang et al., Energy Environ. Sci. 2012, 5, 6465). In addition, porous materials with open metals sites and/or Lewis basic sites, micropores (4-6 Å) and excess polar functionalities (e.g., OH, NH₂, pyridyl, and SH) also showed considerable CO₂ adsorption capacities (T. M. McDonald et al., Nature 2015, 519, 7543). These materials would require a drying step prior to CO₂ capture to be practical, adding extra cost to the overall process. Other MOFs perform quite well in wet flue gas streams. For example, the SIFSIX family of materials showed impressive performance under realistic flue gas conditions (P. Nugent et al., Nature 2013, 495, 80-84; and W. Liang et al., Chem 2019, 5, 950-963) but they contain relatively expensive organic linkers, and even one of the most practical systems reported to date contains relatively expensive triazole ligands (R. Vaidhyanathan et al., Chem. Comm. 2009, 35, 5230-5232; R. Vaidhyanathan et al., Science 2010, 330, 650-653; and J.-B. Lin et al., Science 2021, 374, 1464-1469). Therefore, it remains extremely challenging to find MOF materials that can separate and capture CO₂ from combustion point sources in a cost-effective and scalable manner (S. Deutz & A. Bardow, Nat. Energy 2021, 6, 1-11). Furthermore, except for introducing chemisorption binding sites, such as alkyl amines into the frameworks, the methodologies for achieving efficient water-resistant CO₂ capture with MOFs remain under-explored.

Therefore, there exists an urgent need to discover new and cost-effective MOFs for selective and water-resistant CO₂ capture.

### SUMMARY OF INVENTION

Aspects and embodiments of the invention are discussed in the following numbered clauses.
1. An activated metal-organic framework of formula I:

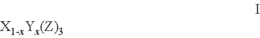

where:
X is a metal in the +3 oxidation state;
Y is one or more metals in the +3 oxidation state, provided that each of the metals that represent X are different to each of the one or metals that represent Y;
x is from 0 to 0.9999, wherein
Z is selected from the group consisting of: NO₂⁻ and, more particularly, HCOO⁻, R¹COO⁻, H₂PO₂⁻,

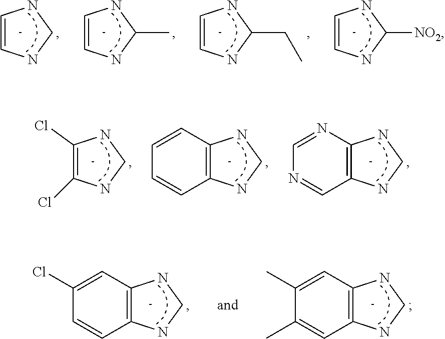

R¹ is C₁ to C₆ alkyl; and
the metal-organic framework has a BET surface area of from 250 to 1,000 m²/g as obtained from a 298 K CO₂ sorption isotherm.
2. The metal-organic framework of formula I according to Clause 1, wherein the BET surface area is from 500 to 600 m²/g, such as from 514 to 599 m²/g, such as from 582 to 599 m²/g.
3. The metal-organic framework of formula I according to Clause 1 or Clause 2, wherein the metal-organic framework has a set of unit-cell parameters where a=b=c=from 11.303 to 11.894 Å, α=β=γ=90°, Volume=from 1562 to 1600 Å³, space group: I m-3.
4. The metal-organic framework of formula I according to any one of the preceding clauses, wherein x is from 0 to 0.99, such as from 0.25 to 0.85.
5. The metal-organic framework of formula I according to any one of the preceding clauses, wherein X is selected from Al, Fe, Mn, Y, Sc, Ga, In, Ti, Fe, Mn, V, Cr, Co, TI, Bi, Ru, Os, Re, Ir, Rh, Ce, La, Pr, Nd, Sm, Eu, Gd, Tb, Dy, Ho, Er, Tm, Yb and Lu.
6. The metal-organic framework of formula I according to Clause 5, wherein X is Al.
7. The metal-organic framework of formula I according to any one of the preceding clauses, wherein Y, when present is selected from one or more of the group consisting of Al, Fe, Mn, Y, Sc, Ga, In, Ti, Fe, Mn, V, Cr, Co, TI, Bi, Ru, Os, Re, Ir, Rh, Ce, La, Pr, Nd, Sm, Eu, Gd, Tb, Dy, Ho, Er, Tm, Yb and Lu, optionally wherein:
(a) Y, when present, is selected from one or more of the group consisting of Al, TI, Fe, Ga, In, Mn, V and Cr;
(b) Y, when present, is selected from one or more of the group consisting of Fe, Ga, In, Mn, V and Cr;
(c) Y, when present, is selected from the group consisting of Al, TI, Fe, Ga, In, Mn, V and Cr; or
(d) Y, when present, is selected from the group consisting of Fe, Ga, In, Mn, V and Cr.
8. The metal-organic framework of formula I according to Clause 7, wherein Y, when present, is Fe.
9. The metal-organic framework of formula I according to any one of the preceding clauses, wherein Z is selected from the group consisting of: NO₂⁻ and, more particularly, HCOO⁻, R¹COO⁻ and H₂PO₂⁻.
10. The metal-organic framework of formula I according to Clause 9, wherein Z is HCOO⁻.
11. The metal-organic framework of formula I according to any one of the preceding clauses, wherein the metal-organic framework displays a CO₂ adsorption value of from 3 to 6 (e.g., from about 4 to about 5) mmol/g at 298 K and under 1 atmosphere of CO₂.
12. The metal-organic framework of formula I according to any one of the preceding clauses, wherein the metal-organic framework displays a CO₂ adsorption value of from 2 to 3 (e.g., about 2.3) mmol/g and from 90 to 150 (e.g., about 100) selectivity over N₂ at 298 K and under 1 atmosphere of total pressure provided by a gas stream of 15% CO₂ and 85% N₂ vol:vol.
13. The metal-organic framework of formula I according to any one of the preceding clauses, wherein the metal-organic framework displays an O₂ adsorption value of from 0.5 to 4 (e.g., from about 1 to about 3) mmol/g at 298 K and under 1 atmosphere of O₂.
14. The metal-organic framework of formula I according to any one of the preceding clauses, wherein it is selected from:
(a) Al(HCOO)₃;
(b) Al_{0.75}Fe_{0.25}(HCOO)₃;
(c) Al_{0.5}Fe_{0.5}(HCOO)₃;
(d) Al_{0.25}Fe_{0.75}(HCOO)₃;
(e) Al_{0.15}Fe_{0.85}(HCOO)₃,
(f) V(HCOO)₃; and
(g) V_{0.3}Al_{0.7}(HCOO)₃, optionally wherein the metal-organic framework of formula I according to any one of the preceding clauses, wherein it is selected from:
(a) Al(HCOO)₃;
(b) Al_{0.75}Fe_{0.25}(HCOO)₃;
(c) Al_{0.5}Fe_{0.5}(HCOO)₃;
(d) Al_{0.25}Fe_{0.75}(HCOO)₃;
(e) Al_{0.15}Fe_{0.85}(HCOO)₃.
15. A method of adsorbing CO₂ and/or O₂ from a gas, comprising subjecting a metal-organic framework of formula I according to any one of Clauses 1 to 14 to a flow of a gas comprising one or both of CO₂ and O₂, optionally wherein the gas further comprises nitrogen and water vapour.
16. The method according to Claim 15, wherein the gas further comprises nitrogen and water vapour.
17. The method according to Claim 15 or Claim 16, wherein the gas has a relative humidity of from less than or equal to 25% to 90%.
18. The method according to Claim 17, wherein the gas has a relative humidity of less than or equal to 25%.
19. A method of releasing CO₂ and/or O₂ from a metal-organic framework of formula I according to any one of Clauses 1 to 14 to which CO₂ and/or O₂ has been adsorbed, the process comprising:
(a) providing a metal-organic framework of formula I to which CO₂ and/or O₂ has been adsorbed; and
(b) activating it by subjecting it to:
   (i) a temperature of from 90 to 160° C. (e.g., from 100 to 150° C., such as 120° C.) under a reduced pressure for a period of time (e.g. from 1 to 2 hours); or
   (ii) a temperature of from 170 to 250° C. (e.g., from 175 to 185° C., such as about 180° C.) under 1 atmosphere pressure for a period of time (e.g. from 1 to 2 hours).
20. A method of obtaining an activated metal-organic framework of formula I according to any one of Clauses 1 to 14, the method comprising the steps of:
(a) providing an unactivated metal-organic framework of formula I; and
(b) activating it by subjecting it to:
   (i) a temperature of from 90 to 160° C. (e.g., from 100 to 150° C., such as 120° C.) under a reduced pressure for a period of time (e.g. from 1 to 2 hours); or
   (ii) a temperature of from 170 to 250° C. (e.g., from 175 to 185° C., such as about 180° C.) under 1 atmosphere pressure for a period of time (e.g., from 1 to 2 hours).
for a period of time, whereby the BET surface area of the metal-organic framework of formula I is increased to a value of from 500 to 600 m²/g as obtained from a 298 K CO₂ sorption isotherm following step (b).

### DRAWINGS

FIG. 1 depicts the variable temperature X-ray diffraction (XRD) of the as-made Al(HCOO)₃ upon heating in air. It was observed that the intensity of the first peak sizably increased upon CO₂ loss between 425 K and ≈523 K, and eventual degradation of the compound between 533 K and 543 K, which is in line with observations from thermogravimetric analysis (TGA).

FIG. 2 depicts the powder X-ray diffraction (PXRD) patterns (taken at 300 K), illustrating the chemical resistance of the as-made Al(HCOO)₃ in various (a) acid/base, and (b) boiled solvent media after exposure. This data was normalized to the peak near 29 angle of 40° to account for differing sample amounts in each diffraction pattern. The as-made pattern is included for comparison in both panels. It is noted that after exposure to these media, the structural integrity of the as-made Al(HCOO)₃ was largely maintained. The aspect ratios between panels (a) and (b) are different, but the as-made diffraction pattern used for comparison is the same for both panels.

FIG. 3 depicts the PXRD patterns (taken at 300 K), illustrating the chemical resistance of activated Al(HCOO)₃ (ALF) in various (a) acid/base (12 h of exposure, except for NaOH), and (b) boiled solvent media (7 days of exposure). This data was normalized to the peak near 29 angle of 40° to account for differing sample amounts in each diffraction pattern. The activated pattern is included for comparison in both panels. It is noted that after exposure to these media, the structural integrity of ALF was largely maintained. The aspect ratios between panels (a) and (b) are different, but the as-made diffraction pattern used for comparison is the same for both panels. In certain patterns, there is formation of very small peaks next to the main peak near 29 angle of 15°; these are from an unknown side phase. If ALF is boiled in water, it will gradually dissolve. However, the dissolved compound can be isolated and recycled in a similar process to that shown in FIG. 45.

FIG. 4 depicts the TGA of as-made Al(HCOO)₃ and ALF performed under a N₂ atmosphere. The degradation product in both samples was alumina, evident from the approximately 30% mass weight leftover upon degradation. [4 Al(HCOO)₃+3O₂→4CO₂+6H₂O+2Al₂O₃]

FIG. 5 depicts the experimental and theoretical results on the structure of ALF with and without CO₂. (a) The structure of ALF at 300 K determined from neutron powder diffraction (NPD). Space group=Im3̅; a=11.3905(1); V=1477.85(5); (b) Structure of ALF illustrating the two types of interpenetrating large cavity (LC)-small cavity (SC)-LC (circles) and SC-SC-SC (squares) channels within ALF; (c and d) Position energy of CO₂ and N₂ as the molecules are translated in the SC (upper boxes) and LC (lower boxes) of ALF. In (c) and (d), positive energies represent energetically unfavourable positions, and the crosses serve as guides for the eye. The absolute values of the position energies are different in (c) and (d); (e) SC, illustrating hydrogen bonding with formate ligands and CO₂. Error value is 1; and (f) LC, illustrating lack of hydrogen bonding between the formate ligands and the disordered CO₂.

FIG. 6 depicts the structure of ALF at 14 K annotated with values of the atom-atom distances (in Å) along the SC only and S/LC channels. Values in brackets indicate 1σ.

FIG. 7 depicts the structure of ALF at 300 K annotated with values of the atom-atom distances (in Å) along the SC only and S/LC channels. It can be seen that the size limiting distance along the small pore only channel is between hydrogen atoms [4.103(19) Å]. For the small/large pore channels, the smallest distance is between oxygen atoms of the formate ligands [4.561(7) Å]. This suggests that the favoured pathway of gas adsorption is most likely through the small/large pore channel. Values in brackets indicate 1σ.

FIG. 8 depicts the Brunauer-Emmett-Teller (BET) fits obtained from 298 K CO₂ isotherms of ALF.

FIG. 9 depicts the scheme of the breakthrough setup used in this study.

FIG. 10 depicts the dynamic vapor sorption (DVS) measurements at 303 K, 313 K, or 323 K, on ALF of H₂O in (a-c) N₂ or (d-f) CO₂ carrier gas. The water content is varied by combining a flow of dry carrier gas with a second flow of carrier gas bubbled through a H₂O reservoir held at the measurement temperature. The left ordinate (i) tracks the mass change normalized by the initial weight at the start of the humidity ramp, which approximates the “dry weight”. The right ordinate (ii), denoted as “wet concentration”, is the relative flow of wetted carrier gas normalized by the total flow of dry and wet carrier gas, with units of percent.

FIG. 11 depicts the isotherm and breakthrough adsorption data. (a) CO₂ adsorption isotherms at various temperatures; (b) Comparison of the CO₂ and N₂ adsorption isotherms at 298 K. The inset shows the CO₂/N₂ sorption selectivity (based on ideal adsorbed solution theory (IAST) for a 15/85 mixture of CO₂/N₂ at 298 K (323 K in FIG. 44); (c) Comparison of the H₂O vapor sorption isotherms of ALF, MOF-74-Ni, and UiO-66-(OH)₂ at 298 K; (d) Breakthrough curves (uncalibrated) of a 15/85 CO₂/N₂ mixed gas through an ALF-packed column at 323 K. The CO₂ uptake and CO₂/N₂ selectivity from these curves were 0.80(1) mmol/g and 75(21), respectively; (e) Comparison of the CO₂ breakthrough curves through a dry and H₂O-saturated-ALF packed column at 323 K. The curves are calibrated after a point-by-point correction; (f) A summary of the CO₂ dynamic capacity of the MOF-packed columns under dry and H₂O-presaturated conditions at 323 K. ALF had a ≈70% retention of performance versus ≈15% for UiO-66-(OH)₂ and =10% for MOF-74-Ni. Refinements of the MOF-74-Ni and the UiO-66-(OH)₂ are shown in FIG. 12-13. Virial fits for the CO₂ isotherms collected are shown in FIG. 14. Langmuir fits and pore size distributions can be found in FIGS. 15 and 16; (g-h) Breakthrough curves of the adsorption column of ALF using dry 15/85 CO₂/N₂ mixtures at (g) 298 K, and (h) 323 K; (i) The coadsorption CO₂ uptake capacity and CO₂/N₂ sorption selectivity of ALF derived from breakthrough experiments of 15/85 CO₂/N₂ mixed gas at 423 K; and (j) Water sorption isotherms of ALF at 298 K; and (k) Breakthrough curves of 15/85 CO₂/N₂ mixed gas with and without SO₂ (50 ppm) and NO (50 ppm) through an ALF-packed column at 323 K.

FIG. 12 depicts the Pawley fit of a bench PXRD spectrum of MOF-74-Ni. Space group R-3, refined lattice parameters a=b=25.871(3), c=6.680(2).

FIG. 13 depicts the Pawley fit of a bench PXRD spectrum of UiO-66-OH₂. Space group F-43m, refined lattice parameters a=b=c=20.8521(8).

FIG. 14 depicts the virial fits for the CO₂ isotherms collected at 298 K, 308 K, and 313 K.

FIG. 15 depicts the Langmuir fits obtained from 298 K CO₂ isotherms of ALF. The value in parenthesis denotes 1σ.

FIG. 16 depicts the pore size distribution of ALF after activation at 150° C. (423 K), obtained by fitting the CO₂ model to the 298 K CO₂ adsorption isotherms.

FIG. 17 depicts the variable temperature N₂ sorption isotherms of ALF (closed shapes are the adsorption data, and open shapes are the desorption data).

FIG. 18 depicts the variable temperature CO₂ sorption isotherms of ALF (closed shapes are the adsorption data, and open shapes are the desorption data).

FIG. 19 depicts (a) the in-situ CO₂ TGA cycling studies on activated ALF under CO₂ at different temperatures. The * denotes the start temperature of 298 K at 0 min and 100 weight percent; and (b) (top panel) in situ TGA cycling studies on ALF under dry CO₂ atmosphere. This graph shows 130 cycles where degassing occurs at 353 K and CO₂ adsorption takes place on cooling to 313 K. Each cycle was approximately 30 minutes. (Bottom panel) In situ TGA cycling studies on ALF under 3% humid 15/85 CO₂/N₂ atmosphere for 50 cycles. Each cycle was approximately 60 min long.

FIG. 20 depicts the isotherms of the first and second CO₂ carrier gas DVS experiments done at 303 K. percent wet concentration is defined in the DVS experimental section of this document.

FIG. 21 depicts (a) comparison of the adsorption of CO₂ and N₂ into ALF at room temperature; (b) CO₂ adsorption into the as-made Al(HCOOH)₃ at room temperature compared with adsorption into the activated material; and (c) N₂ adsorption into the as-made Al(HCOOH)₃ at room temperature compared with adsorption into the activated material.

FIG. 22 depicts the IAST-predicted uptakes of CO₂ and H₂O in ALF at 298 K for a CO₂/H₂O binary system with varying CO₂ partial pressures and a fixed relative humidity of 91%.

FIG. 23 depicts the isosteric heat of adsorption (Qst) for CO₂, which was estimated by applying the Clausius-Clapeyron relation using the CO₂ desorption isotherms measured at 298 K, 308 K, and 313 K.

FIG. 24 depicts the NPD results from experiments on ALF. [NCNR, BT1, λ=2.079 Å]. (a) Top panel: Rietveld refinement fit of ALF at 300 K; a=11.39051(12), R_{wp}=2.74%, Rₚ=2.19%. Bottom panel: Rietveld refinement fit of ALF exposed to 1 bar of CO₂ at 320 K; R_{wp}=3.35%, Rₚ=3.43. The scan time for the activated sample data was twice that of the CO₂ exposed data. The change in the lattice parameter of the activated sample versus temperature is shown in FIG. 25. Refinements of other data set are shown in FIG. 26-28; and (b) Top panel: Lattice parameters obtained from Rietveld refinements as a function of CO₂ dosing pressure for ALF at 320 K. Bottom panel: CO₂ crystallographic occupancies obtained from Rietveld refinements as a function of the CO₂ dosing pressure for ALF at 320 K. Error bars in graphs denote 16.

FIG. 25 depicts the cubic unit cell parameter change of ALF as a function of temperature determined with NPD. Error bars denote 16.

FIG. 26 depicts the Rietveld refinement of NPD data for ALF at 14 K [NCNR, BT-1, λ=2.079 Å], Space group: Im\hat{3}(204), a=11.36001(9) Å, V=1466.01(4) Å³. Goodness-of-fit parameters: R_{wp}=2.71%; Rₚ=2.14%. Values in parentheses indicate 1σ.

FIG. 27 depicts the Rietveld refinement of NPD data of ALF at 420 mmHg CO₂ at 320 K [NCNR, BT-1, λ=2.079 Å], Space group: Im3̅(204), a=11.3900(1) Å, V=1477.67(5) Å³. Goodness-of-fit parameters: R_{wp}=2.92%; Rₚ=2.33%. Values in parentheses indicate 1σ.

FIG. 28 depicts the Rietveld refinement of NPD data of ALF at 1150 mmHg CO₂ at 320 K [NCNR, BT-1, λ=2.079 Å], Space group: Im3̅(204), a=11.38798(13) Å, V=1476.86(5) Å³. Goodness-of-fit parameters: R_{wp}=3.46%; Rₚ=2.79%. Values in parentheses indicate 1σ.

FIG. 29 depicts the density functional theory (DFT) calculated thermal expansion coefficient (in K⁻¹) as a function of temperature (in K). The y axis is on the order of 1E⁻⁵.

FIG. 30 depicts a scheme of the three-step TSA cycle used in the shortcut model.

FIG. 31 depicts the Fourier transform infrared (FT-IR) spectra of as-made Al(HCOO)₃, 423 K ALF, H₂O soaked ALF, and CO₂ reloaded ALF.

FIG. 32 depicts the comparison between ALF and 2-week-air exposed ALF diffraction patterns at 300 K [NCNR, BT-1, λ=2.079 Å]. Top panel: total patterns. Bottom panel: a zoomed-in view of the same patterns at the most affected Bragg reflections upon adsorption. The air exposed pattern was scaled to be of comparable intensity as it was measured for slightly less time relative to the ALF pattern. This lack of change between the samples indicates that there is no water adsorption or formation of an amorphous phase of Al(HCOO)₃, as the background of the NPD pattern would be highly sensitive to this change.

FIG. 33 depicts the summary of 1 kg sample of ALF, including a picture of the amount prepared, powder X-ray diffraction of 1 kg sample and 1 kg sample pelletized at 15 tons. There is a small Al(OH)₃ impurity in the powder (peak at ˜ 17° 20) arising from the difficulty stirring such large quantities at the laboratory scale.

FIG. 34 depicts the isotherm measurements of 1 kg synthesis samples, including one pelletized at 15 tons. The pelletized sample has a decreased hysteresis between adsorption and desorption isotherms.

FIG. 35 depicts the purity and recovery of sorbents that pass the purity (83%, double dashed line) and recovery (80%, double solid line) performance threshold of the 3-step temperature-swing adsorption (TSA) process. Higher purity (95%) and recovery (90%) requirement are highlighted by single dashed and single solid lines, respectively.

FIG. 36 depicts the working capacity and specific thermal energy of sorbents that pass the 95% purity and 90% recovery performance threshold of the 3-step TSA process.

FIG. 37 depicts the contour maps showing the effect of adsorption temperature (Tₐ) and desorption temperature (T_{d}) on the performance of ALF: (a) purity, (b) recovery, (c) specific thermal energy demand, and (d) working capacity.

FIG. 38 depicts the schematic representation of the carbon cycle via ALF synthesis.

FIG. 39 depicts (a) PXRD patterns of Fe-doped activated MOFs (Al₁₋ₓFeₓ(COOH)₃); and (b) TGA of Fe-doped activated MOFs (Al₁₋ₓFeₓ(COOH)₃).

FIG. 40 depicts (a) CO₂ adsorption isotherms of Fe-doped activated MOFs (Al₁₋ₓFeₓ(COOH)₃) measured at 298 K; and (b) N₂ adsorption isotherms of Fe-doped activated MOFs (Al₁₋ₓFeₓ(COOH)₃) measured at 298 K.

FIG. 41 depicts (a) O₂ adsorption isotherms of Fe-doped activated MOFs (Al₁₋ₓFeₓ(COOH)₃) measured at 195 K; and (b) N₂ adsorption isotherms of Fe-doped activated MOFs (Al₁₋ₓFeₓ(COOH)₃) measured at 195 K.

FIG. 42 depicts the comparison of the adsorption of O₂ and N₂ into activated Al₁₋ₓFeₓ(COOH)₃ at 195 K. The capacity is greater in the Fe-doped material than in the pure, activated Al(COOH)₃.

FIG. 43 depicts pore size distribution curves of Fe-doped activated MOFs (Al₁₋ₓFeₓ(COOH)₃) obtained by fitting the DFT model to the 298 K CO₂ adsorption isotherms: (a) x=0.25; (b) x=0.5; (c) x=0.75; and (d) x=0.85.

FIG. 44 depicts the IAST CO₂/N₂ sorption selectivity for a 15/85 CO₂/N₂ mixture at 298 K (circle) and 323 K (square).

FIG. 45 depicts the PXRD plots showing resynthesis of ALF from 623 K annealed residual material in formic acid. The full cycle is show in FIG. 38.

FIG. 46 depicts the water isotherms at 298 K of the MOFs and CO₂ sorption isotherm of ALF at 298 K and 323 K. This figure directly indicates that under the separation conditions (e.g, adsorption at near 100% RH and 15 kPa (112 mmHg)), the single component uptakes of CO₂ and H₂O are very similar. Furthermore, the DFT-modelled adsorption enthalpies are also similar (Table 9). It is important to note that these two observations do not contradict a substantial CO₂ loading in a multinary separation system. To quantitatively illustrate this point, we modelled the competitive uptake of CO₂ and H₂O at 298 K and 91% RH for aluminum formate using IAST as a representative co-adsorption model (see FIG. 22).

FIG. 47 depicts the hydrolytic stability studies of ALF. (a) PXRD of ALF after exposure to 85 percent humidity at 85° C. (358 K) between 1 h and 24 h; (b) TGA runs of ALF samples after exposure to 85 percent humidity at 85° C. (358 K) between 1 hour and 24 hours; (c) CO₂ adsorption isotherms of ALF samples after exposure to 85 percent humidity at 85° C. (358 K) between 1 hour and 24 hours. The box in the lower left-hand corner is the graphed range for (d); (d) zoomed-in area of the CO₂ adsorption isotherms from (c). Graph legend same as (c); (e) CO₂ adsorption isotherms for four separate samples of ALF exposed to 85 percent humidity at 85° C. (358 K) for 24 hours. The box in the lower left-hand corner is the graphed range for (f); and (f) zoomed-in area of the CO₂ isotherms from (e). Graph legend same as (e).

FIG. 48 depicts PXRD patterns of as-made V(HCOO)₃ and activated V(HCOO)₃.

FIG. 49 depicts TGA of as-made V(HCOO)₃ and activated V(HCOO)₃ performed under a N₂ atmosphere.

FIG. 50 depicts PXRD patterns of as-made V_{0.3}Al_{0.7}(HCOO)₃ and activated V_{0.3}Al_{0.7}(HCOO)₃.

FIG. 51 depicts TGA of as-made V_{0.3}Al_{0.7}(HCOO)₃ and activated V_{0.3}Al_{0.7}(HCOO)₃ performed under a N₂ atmosphere.

FIG. 52 depicts (a) CO₂ adsorption isotherms of V(HCOO)₃ and V-doped activated Al(HCOO) (V_{0.3}Al_{0.7}(COOH)₃) measured at 298 K; and (b) N₂ adsorption isotherms of V(HCOO)₃ and V-doped activated Al(HCOO) (V_{0.3}Al_{0.7}(COOH)₃) measured at 298 K.

FIG. 53 depicts (a) pore size distribution curves of V(HCOO)₃ and V_{0.3}Al_{0.7}(COOH)₃ MOFs obtained by fitting the DFT model to the 298 K CO₂ adsorption isotherms.

FIG. 54 depicts O₂ adsorption isotherms of V(HCOO)₃ MOFs measured at various temperatures.

FIG. 55 depicts a scheme showing the point by point correction of a breakthrough curve.

### DESCRIPTION

Some or all of the problems have been surprisingly solved through the use of some of the simplest metal-organic frameworks possible. Thus, in a first aspect of the invention, there is provided an activated metal-organic framework of formula I:

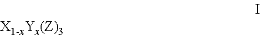

where:
X is a metal in the +3 oxidation state;
Y is one or more metals in the +3 oxidation state, provided that each of the metals that represent X are different to each of the one or metals that represent Y;
x is from 0 to 0.9999, wherein
Z is selected from the group consisting of: NO₂⁻ and, more particularly, HCOO⁻, R¹COO⁻, H₂PO₂⁻,

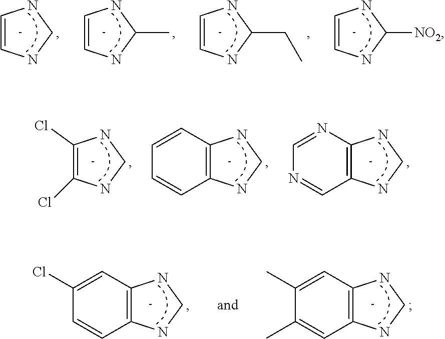

R¹ is C₁ to C₆ alkyl; and
the metal-organic framework has a BET surface area of from 250 to 1,000 m²/g as obtained from a 298 K CO₂ sorption isotherm.

The metal-organic frameworks disclosed herein have been surprisingly found to provide a stable and affordable adsorbent material that can capture CO₂ from a flue gas (e.g., a flue-gas having water vapour in the range of from less than or equal to 25% to 90% relative humidity). Similarly, the metal-organic frameworks disclosed herein have been surprisingly found to provide a simple sorbent material for the selective adsorption of O₂ from air (e.g., relative to nitrogen).

In embodiments herein, the word “comprising” may be interpreted as requiring the features mentioned, but not limiting the presence of other features. Alternatively, the word “comprising” may also relate to the situation where only the components/features listed are intended to be present (e.g., the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

The phrase, “consists essentially of” and its pseudonyms may be interpreted herein to refer to a material where minor impurities may be present. For example, the material may be greater than or equal to 90% pure, such as greater than 95% pure, such as greater than 97% pure, such as greater than 99% pure, such as greater than 99.9% pure, such as greater than 99.99% pure, such as greater than 99.999% pure, such as 100% pure.

As used herein, the singular forms “a,” “an,” and “the” include plural referents unless the context clearly dictates otherwise. Thus, for example, reference to “a composition” includes mixtures of two or more such compositions, reference to “an oxygen carrier” includes mixtures of two or more such oxygen carriers, reference to “the catalyst” includes mixtures of two or more such catalysts, and the like.

Unless otherwise stated, the term “alkyl” refers to an unbranched or branched, acyclic and saturated hydrocarbyl radical. The alkyl group is preferably C₁₋₆ alkyl (such as ethyl, propyl (e.g., n-propyl or isopropyl), butyl (e.g., branched or unbranched butyl), pentyl or, more preferably, methyl). More particularly when alkyl is C₃₋₆ alkyl, it may be a branched alkyl chain.

The activated metal-organic framework of formula I as disclosed herein can be shaped into pellets, spheres, cylinders, or other architectures, and packed into adsorption beds for pressure or temperature swing adsorption. The activated metal-organic framework of formula I as disclosed herein can also be coated onto substrates such as polymers, ceramics, or metals for adsorption purposes. The activated metal-organic framework of formula I as disclosed herein can also be incorporated into polymer matrices for adsorption or membrane processes. The activated metal-organic framework of formula I as disclosed herein can also be synthesized directly on any substrate or surface. The metal-organic framework of formula I can be processed into different 3D shapes or architectures.

The term “activated metal-organic framework” when used herein refers to a metal-organic framework where materials that block the MOF's channels (e.g., from formation and/or sorption) are removed. As noted this may be achieved through the application of heat alone or by the application of vacuum and heat for a suitable period of time. The exact conditions can be readily determined by a person skilled in the art considering the entire disclosure of the application as filed.

The activated nature of the metal-organic framework may be established by measuring the resulting BET surface area of metal-organic framework as-made (or after use in sorption) and following the treatments described above. If the BET surface area has increased, then the metal-organic framework may be considered to have been activated. Additionally or alternatively, the unit-cell parameters of the metal-organic framework may be used for this purpose too.

The BET surface area may be obtained using a CO₂ sorption isotherm at 298 K. The BET surface area may range from 250 to 1,000 m²/g, which can be tuned through pore configurations and/or surface modifications. Examples of particular BET surface areas that may be mentioned herein include, but are not limited to 500 to 600 m²/g, such as from 514 to 599 m²/g, such as, from 582 to 599 m²/g. A skilled person will understand how to conduct a CO₂ sorption isotherm at 298 K and further details may be found in the examples section below.

At least some of the metal-organic frameworks disclosed herein may have the following unit-cell parameters: a=b=c=from 11.303 to 11.894 Å, α=β=γ=90°, Volume=from 1562 to 1600 Å³, space group: I m-3. As will be appreciated, the crystal system or space group may change depending on ligand and metal combination.

Any suitable metal in the +3 oxidation state may be used herein. Examples of such metals include, but are not limited to Al, Fe, Mn, Y, Sc, Ga, In, Ti, Fe, Mn, V, Cr, Co, TI, Bi, Ru, Os, Re, Ir, Rh, Ce, La, Pr, Nd, Sm, Eu, Gd, Tb, Dy, Ho, Er, Tm, Yb and Lu.

The value of x may range from 0 to 0.9999. For example, x may be from 0 to 0.99, such as, from 0.25 to 0.85. Particular point values of x that may be mentioned herein include 0.25, 0.50, 0.75 and 0.85. As will be appreciated, this approach essentially results in X being doped by Y (or vice versa, depending on the relative amounts of X and Y). It is believed that such doped metal-organic frameworks may display enhanced adsorption for CO₂, O₂ etc.

For the avoidance of doubt, it is explicitly contemplated that where several numerical ranges related to the same feature are cited herein, that the end points for each range are intended to be combined in any order to provide further contemplated (and implicitly disclosed) ranges.

Thus, for the values of x mentioned herein, there is disclosed the following ranges for x:
from 0 to 0.25, from 0 to 0.50, from 0 to 0.75, from 0 to 0.85, from 0 to 0.99, from 0 to 0.9999;
from 0.25 to 0.50, from 0.25 to 0.75, from 0.25 to 0.85, from 0.25 to 0.99, from 0.25 to 0.9999;
from 0.50 to 0.75, from 0.50 to 0.85, from 0.50 to 0.99, from 0.50 to 0.9999;
from 0.75 to 0.85, from 0.75 to 0.99, from 0.75 to 0.9999;
from 0.85 to 0.99, from 0.85 to 0.9999; and
from 0.99 to 0.9999.

As noted herein, the lists of metals for X and Y may be the same list of metals. However, it is explicitly contemplated that when X is a metal, Y is not the same metal.

As noted herein, Y may be one or more metals (e.g., two metals). When Y is one or more metals, any suitable proportion of said metals may be used. For example, when there are two metals, Y may be represented by Y′_{1-y}Y″_{y}, where the values of y may be the same as the values of x discussed above.

In particular embodiments that may be mentioned herein, Y may be a single metal (that differs from the metal of X).

In particular embodiments of the invention, X may be selected from Al, Fe, Mn, Y, Sc, Ga, In, Ti, Fe, Mn, V, Cr, Co, TI, Bi, Ru, Os, Re, Ir, Rh, Ce, La, Pr, Nd, Sm, Eu, Gd, Tb, Dy, Ho, Er, Tm, Yb and Lu. In particular embodiments that may be mentioned herein, X may be Al.

In particular embodiments of the invention, Y may be selected from Al, Fe, Mn, Y, Sc, Ga, In, Ti, Fe, Mn, V, Cr, Co, TI, Bi, Ru, Os, Re, Ir, Rh, Ce, La, Pr, Nd, Sm, Eu, Gd, Tb, Dy, Ho, Er, Tm, Yb and Lu, with the caveat that Y is not the same metal as X. For example, when present, Y may be selected from
(a) one or more of the group consisting of Al, TI, Fe, Ga, In, Mn, V and Cr;
(b) one or more of the group consisting of Fe, Ga, In, Mn, V and Cr;
(c) from the group consisting of Al, TI, Fe, Ga, In, Mn, V and Cr; or
(d) from the group consisting of Fe, Ga, In, Mn, V and Cr.

As will be appreciated, (a) and (b) above allow for the presence of 2 or more (e.g., 2, 3 or 4 metals as Y), while (c) and (d) only allow for the presence of one metal as Y.

In particular embodiments that may be mentioned herein, Y, when present, may be Fe.

In certain embodiments, Z may be selected from the group consisting of: HCOO⁻, R¹COO⁻, H₂PO₂⁻, and NO₂⁻. In particular embodiments, Z may be selected from the group consisting of:
HCOO⁻, R¹COO⁻, and H₂PO₂⁻. In particular embodiments of the invention Z may be HCOO⁻.

The metal-organic framework of formula I disclosed herein may display a CO₂ adsorption value of from 3 to 6 (e.g., from about 4 to about 5) mmol/g at 298 K and under 1 atmosphere of CO₂. In certain embodiments, this CO₂ adsorption value may be obtainable with a gas that has a relative humidity of from less than or equal to 25% to 90%.

In certain embodiments, the metal-organic framework of formula I disclosed herein may display a CO₂ adsorption value of from 2 to 3 (e.g., about 2.3) mmol/g and from 90 to 150 (e.g., about 100) selectivity over N₂ at 298 K and under 1 atmosphere of total pressure provided by a gas stream of 15% CO₂ and 85% N₂ vol:vol. In certain embodiments, this CO₂ adsorption value and selectivity may be obtainable with a gas that has a relative humidity of from less than or equal to 25% to 90%.

In certain embodiments, the metal-organic framework of formula I disclosed herein may display an O₂ adsorption value of from 0.5 to 4 (e.g., from about 1 to about 3) mmol/g at 298 K and under 1 atmosphere of O₂. In certain embodiments, this O₂ adsorption value may be obtainable with a gas that has a relative humidity of from less than or equal to 25% to 90%.

In embodiments of the invention mentioned herein, the metal-organic framework of formula I may be one or more (e.g., one) selected from:
(a) Al(HCOO)₃;
(b) Al_{0.75}Fe_{0.25}(HCOO)₃;
(c) Al_{0.5}Fe_{0.5}(HCOO)₃;
(d) Al_{0.25}Fe_{0.75}(HCOO)₃;
(e) Al_{0.15}Fe_{0.85}(HCOO)₃;
(f) V(HCOO)₃ and;
(g) V_{0.3}Al(HCOO)₃.

In more particular embodiments of the invention mentioned herein, the metal-organic framework of formula I may be one or more (e.g., one) selected from:
(a) Al(HCOO)₃;
(b) Al_{0.75}Fe_{0.25}(HCOO)₃;
(c) Al_{0.5}Fe_{0.5}(HCOO)₃;
(d) Al_{0.25}Fe_{0.75}(HCOO)₃; and
(e) Al_{0.15}Fe_{0.85}(HCOO)₃.

Aluminium formate, Al(HCOO)₃, an earth-abundant, inexpensive and highly porous metal-organic framework (MOF), can be obtained from a non-porous precursor. Al(HCOO)₃ is thermally stable to around 250° C. and is also stable in the presence of water, acids, alkalis and organic solvents. Al(HCOO)₃ has excellent and highly selective adsorption capacity for carbon dioxide gas in the presence of nitrogen gas and water vapour, at and above room temperature. It can be applied in the removal of carbon dioxide from flue gases in industrial combustion processes. It could also be used for the selective adsorption of molecular oxygen from air.

As noted above, Al(HCOO)₃ is very easy to make from readily available starting materials comprising an aqueous solution of aluminium oxide and formic acid (this also holds true for the other materials listed above, particularly those including iron and vanadium with aluminium (e.g. iron and aluminium)). Al(HCOO)₃ is very inexpensive compared to other metal-organic frameworks or solid sorbents that have been proposed for carbon dioxide capture.

As disclosed herein (e.g. see the examples below), Al(HCOO)₃ can selectively adsorb carbon dioxide from a flue gas that also contains nitrogen and water vapour. It is highly selective for CO₂ compared with N₂. It is also selective for the adsorption of oxygen from air. In contrast, sorbates for air separation (e.g., lithium-containing zeolites) are based upon the selective adsorption of N₂ rather than O₂. This requires removing the largest component in air (N₂: 80%; O₂ 19%). It is believed that these properties also apply to the other metal-organic frameworks of formula I disclosed herein.

As disclosed herein (e.g., see the examples), Al(HCOO)₃ can be used with water-containing flue gases above room temperature, e.g. at 50° C., while maintaining high CO₂ uptake and sorption selectivity. As noted herein, this may be particularly the case when the relative humidity of the water vapour is from less than or equal to 25% to 90%, such as less than or equal to 25% relative humidity. It is noted that many other metal-organic frameworks or solid sorbents are unstable in the presence of water vapour or lose significant CO₂ uptake capacity above room temperature.

The MOFs used herein (e.g. (HCOO)₃) have excellent stability against corrosive gases (e.g., SO₂ and NO₂), while maintaining high CO₂ uptake and sorption selectivity. Details of this stability may be found in the examples section below.

The metal-organic frameworks of formula I (e.g., Al(HCOO)₃) may be a mechanically robust material that is not particularly sensitive to water. This contrasts with other metal-organic frameworks, which tend to have poor mechanical properties and are sensitive to humidity.

In a second aspect of the invention that may be mentioned herein, there is provided a method of adsorbing CO₂ and/or O₂ from a gas, comprising subjecting a metal-organic framework of formula I as described herein to a flow of a gas comprising one or both of CO₂ and O₂, optionally wherein the gas further comprises nitrogen and water vapour. In embodiments of the invention where water vapour is present, this may be present in an amount less than or equal to 25% to 90% relative humidity.

As noted herein, while the gas used may contain water vapour in some circumstances (including up to 90% relative humidity), it may be preferred that the relative humidity of the gas is maintained at less than or equal to 25%. If this relative humidity is preferred, then for a postcombustion flue gas saturated with moisture, a drying means or apparatus may be situated upstream from the adsorbent material of formula I. For example, the drying technology may be a cooling means or apparatus and/or a condensation means or apparatus. In any event, it is noted that the compounds of formula I disclosed herein are resilient in the presence of water, meaning that they do not need special handling and storage, which makes their use in an industrial scale more practical than the conventional sorbents, which are highly hygroscopic.

The metal-organic frameworks described herein are also capable of releasing the adsorbed materials, such as CO₂ and/or O₂. Thus, in a third aspect of the invention, there is provided a method of releasing CO₂ and/or O₂ from a metal-organic framework of formula I as described herein to which CO₂ and/or O₂ has been adsorbed, the process comprising:
(a) providing a metal-organic framework of formula I to which CO₂ and/or O₂ has been adsorbed; and
(b) activating it by subjecting it to:
   (i) a temperature of from 90 to 160° C. (e.g., from 100 to 150° C., such as 120° C.) under reduced pressure for a period of time (e.g. from 1 to 2 hours); or
   (ii) a temperature of from 170 to 250° C. (e.g., from 175 to 185° C., such as about 180° C.) under 1 atmosphere pressure for a period of time (e.g. from 1 to 2 hours).

As an example, the metal-organic framework Al(HCOO)₃ containing adsorbed carbon dioxide can release the CO₂ on mild heating, enabling the regeneration of the Al(HCOO)₃. In contrast, other metal-organic frameworks or solid sorbents are relatively unstable on heating, making their regeneration more difficult.

In a fourth aspect of the invention, there is provided a method of obtaining an activated metal-organic framework of formula I as described herein, the method comprising the steps of:
(a) providing an unactivated metal-organic framework of formula I; and
(b) activating it by subjecting it to:
   (i) a temperature of from 90 to 160° C. (e.g., from 100 to 150° C., such as 120° C.) under reduced pressure for a period of time (e.g. from 1 to 2 hours); or
   (ii) a temperature of from 170 to 250° C. (e.g., from 175 to 185° C., such as about 180° C.) under 1 atmosphere pressure for a period of time (e.g. from 1 to 2 hours).
   for a period of time, whereby the BET surface area of the metal-organic framework of formula I is increased to a value of from 500 to 600 m²/g as obtained from a 298 K CO₂ sorption isotherm following step (b).

Any parameters for measurement disclosed herein may be derived from the experimental section below. Further details of the methods of preparation and use may be found in the experimental section below.

Further aspects and embodiments of the invention will now be discussed by reference to the following non-limiting examples below.

### EXAMPLES

### Materials

The gas cylinders of Ar (99.95%), 15/85 CO₂/N₂ mixed gas, N₂ (99.95%), and He (99.95%) were purchased from Air Liquide Singapore Pte Ltd. Aluminium hydroxide (Al(OH)₃), formic acid (>96%), FeCl₃·6H₂O, VCl₃, vanadium acetylacetonate, ethanol, dihydroxyterephthalic acid, nickel acetate tetrahydrate, 2,5-dihydroxyterephthalic acid, ZrOCl₂·8H₂O, acetic acid, methanol, acetonitrile, tetrahydrofuran, acetone, H₂SO₄, HCl, HNO₃, and NaOH were purchased from Sigma-Aldrich, Singapore. Formic acid (>98%) was purchased from TCI-Chemicals, Japan.

### Analytical Techniques

### Inductively Coupled Plasma Mass Spectrometry (ICP-MS)

ICP analysis was carried out on Perkin Elmer Avio 500 Inductively Coupled Plasma-Optical Emission Spectrometer (ICP-OES). Sample was digested with HNO₃/HCl (1:3) on a hotplate for 1 h and topped up to 10 mL with H₂O. A clear solution was observed prior to analysis.

### CHNS Elemental Analysis

CHNS elemental analysis was carried out on ThermoFisher Scientific FlashSmart CHNS Elemental Analyser. Sample was digested with HNO₃/HCl (1:3) on a hotplate for 1 h and topped up to 10 mL with H₂O, a Clear solution was observed prior to analysis.

### XRD for Stability Analysis

PXRD patterns were measured on a Bruker D8 ADVANCED diffractometer with Cu Kα radiation (λ=1.5418 Å, 40 kV and 40 mA). All the PXRD patterns were recorded from 10° to 60° (20) with a step of 0.02° and a scan speed of 1 s/step under ambient condition.

### TGA

TGA measurements were carried out on Q500 Thermogravimetry Analyzer. The TGAs analysis was performed under a N₂ gas flow (60 mL/min+40 mL/min, purge+protective). Both the samples (as-made Al(HCOO)₃ and ALF (≈15 mg) were heated from room temperature to 400° C. (673 K) with a heating rate of 10° C./min.

### TGA on 85/85 Humid Water Treated ALFs

TGA was carried out on a Q500 Thermogravimetry Analyzer. All the TGA analyses were done under the N₂ gas flow (60 mL/min+40 mL/min, purge+protective). Post 85/85 humid water treated ALFs (≈15 mg) were heated from room temperature to 400° C. (673 K) with a heating rate of 5° C./min.

### Single-Crystal X-Ray Diffraction (SC-XRD)

SC-XRD data were measured on the sample at 200° C. (473 K) using a Bruker AXS D8 Venture Mo microfocus source equipped with a Photon 100 CMOS active pixel sensor detector. The data collection and integration were achieved through the APEX3 software. The structures were solved by direct methods, and refinement of the structure was performed by least squares procedures on weighted F2 values using the SHELXL-2014 program package included in the WinGx system programs for Windows (G. M. Sheldrick, Acta Cryst. 2015, 71, 3-8).

### General Procedure for Density-Functional Theory (DFT) Calculations

DFT calculations were performed using the Vienna ab initio Simulation Package (VASP) code (G. Kresse & J. Furthmüller, Phys. Rev. B. 1996, 54, 11169; and G. Kresse & J. Furthmüller, Comput. Mater. Sci. 1996, 6, 15-50) with the projected augmented wave (PAW) pseudopotentials (P. E. Blöchl, Phys. Rev. B. 1994, 50, 17953; and G. Kresse & J. Hafner, J. Condens. Matter Phys. 1994, 6, 8245-8257), where the following electrons were treated explicitly: H 1s¹, C 2s²2p², O 2s²2p⁴, and Al 3s²3p¹. The exchange-correlation functional was calculated using the generalized gradient approximation (GGA) (J. P. Perdew, K. Burke & M. Ernzerhof, Phys. Rev. Lett. 1996, 77, 3865), and the van der Waals interactions were treated using the Grimme's method (DFT+D3, S. Grimme et al., J. Chem. Phys. 2010, 132, 154104). A plane wave kinetic energy cutoff of 520 eV and a 3×3×3 Monkhorst-Pack (J. D. Pack & H. J. Monkhorst, Phys. Rev. B. 1977, 16, 1748) k-point mesh were used. Structural relaxations were performed until the interatomic forces were less than 0.01 eV/A. The adsorption energy of adsorbate M (M=CO₂, N₂ and H₂O) inside ALF was calculated as:

$${E}_{adsorption} = ( E [ {Al ( HCOO )}_{3} , nM ] - E [ {Al ( HCOO )}_{3} ] - nE [ M ] ) / n$$

where E is the DFT total energies and n is the number of the adsorbate molecule in the cubic unit cell. The total energy of the adsorbate molecule was calculated by putting a single molecule at the center of a 15×15×15 Å³ box. The energy landscape of ALF was calculated by putting an adsorbate molecule at the center of the cavities (SCs and LCs), aligned along the [001] direction, and moved along a translation vector t=(x, y, z) where x, y and z=−0.1, −0.05, 0, 0.05 and 0.1 in fractional units. Then, all of the oxygen atoms of CO₂ were relaxed using DFT, whereas other atoms and the unit cell were kept fixed. For N₂ calculations, one of the nitrogen atoms in N₂ was kept fixed whereas for H₂O adsorption, oxygen atoms of H₂O were fixed.

For the calculation of the mechanical properties, the same method as discussed above was used. Geometry optimization was performed based on the primitive cell of the experimental crystal structure until the interatomic forces are less than 0.01 eV/A. Then, the structure of Al(HCOO)₃ was re-optimized under following strains:

$$( \begin{matrix}1 + δ & 0 & 0 \\ 0 & 1 & δ / 2 \\ 0 & δ / 2 & 1\end{matrix} )$$

where δ=±0.5% and ±1%. The elastic constants were extracted from stress-strain relationship using the method in a previous paper (Z. Deng et al., J. Mater. Chem. A 2016, 4, 12025-12029).

### Example 1. Preparation of MOFs

We describe the CO₂ adsorption behaviour of arguably the simplest of all MOFs, aluminium formate, Al(HCOO)₃, which can be made from inexpensive and widely available starting materials, such as Al(OH)₃ and HCOOH. Metal(III) formates, M^{III}(HCOO)₃, where M=Al, Fe, Ga, In, and Mn (Y.-Q. Tian et al., Inorg. Chem. 2007, 46, 1612-1616), for small molecular separations and gas capture applications have not been reported previously. The parent structure of these compounds is of the ReO₃-type (H. A. Evans et al., Nat. Rev. Mater. 2020, 5, 196-213), but they have only hitherto been reported as their CO₂/water adducts, e.g., Al(HCOO)₃·(CO₂)_{3/4}(H₂O)_{1/4}(HCOOH)_{1/4} with CO₂, water and/or formic acid filling the perovskite A-site cavities. This material, referred to here as the as-made Al(HCOO)₃, (Y.-Q. Tian et al., Inorg. Chem. 2007, 46, 1612-1616) was prepared by reacting aluminium hydroxide with a solution of formic acid.

Reflux Synthesis and Activation of as-Made Al(HCOO)₃
Preparation of Al(HCOO)₃(CO₂)_{0.75}(H₂O)_{0.25}(HCOOH)_{0.25} (as-made Al(HCOO)₃)

As-made aluminium formate was synthesized by modifying a reported procedure (Y.-Q. Tian et al., Inorg. Chem. 2007, 46, 1612-1616). In a typical synthesis, formic acid (100 mL) and aluminium hydroxide (1.2 g, 0.015 mol) were refluxed in a 250 mL three-necked round-bottomed flask at 100° C. (373 K) for 48 h. Upon completion of the reaction, excess formic acid was extracted by centrifugation, and the white solid was rinsed with a copious amount of ethanol and separated using vacuum filtration. The air-dried sample provided a white solid product of Al(HCOO)₃(CO₂)_{0.75}(H₂O)_{0.25}(HCOOH)_{0.25}/(guest included/as-made Al(HCOO)₃) (yield=95%). Based on our chemical analysis, it is likely that the actual as-made compound was Al(HCOO)₃(CO₂)_{0.75}(H₂O)_{0.50}, with two molecules in the LCs. Analytical CHN data for AlC_{3.75}H₄O₈ (molecular weight: 204 g/mol): calculated weight percentages C: 22.06%, H: 1.96% and observed C: 22.58%, H: 2.32%.

### Hydrothermal Synthesis of Al(HCOO)₃ Single Crystals

In a typical synthesis, formic acid (7 mL) and aluminium hydroxide (50 mg, 0.234 mmol) were added into a Teflon liner and stirred at room temperature for 30 min until they formed a homogeneous suspension. Then, the contents were placed in a 23 mL Teflon lined Parr stainless steel autoclave and heated at 130° C. (403 K) for three days, followed by slow cooling to room temperature, giving colorless cubic crystals of aluminium formate (Al(HCOO)₃(CO₂)_{0.75}(H₂O)_{0.25}(HCOOH)_{0.25}). The resulting crystals were washed with a copious amount of ethanol and separated using vacuum filtration. The air-dried sample gave a yield of 83% of as-made Al(HCOO)₃ single crystals.

### Activation of Al(HCOO)₃

Activation (removal of the guest species) of the as-made Al(HCOO)₃ material, which is reported here for the first time, can be done either in vacuo at temperatures between at 423 K, or by heating at 453 K in air at ambient pressure. The air-dried, as-made Al(HCOO)₃(CO₂)_{0.75}(H₂O)_{0.25}(HCOOH)_{0.25} (0.5 g, 2.16 mmol) prepared above was heated at 150° C. (423 K) for 24 h under high vacuum [1×10⁻⁴ torr (mmHg)] or heated in air/ambient conditions at 180° C. (453 K) for 24 h to yield 0.39 g of the guest-free ALF. Analytical CHN data for AlC₃H₃O₆ (molecular weight: 162.03 g/mol): calculated. C: 22.24, H: 1.87, and observed C: 21.23, H: 1.93.

Reflux Synthesis and Activation of as-Made V(HCOO)₃
Preparation of as-Made V(HCOO)₃

In a typical synthesis, 150 mL of formic acid and vanadium acetylacetonate (8.0 g, 0.023 mol) was refluxed in a 250 mL two-necked round-bottomed flask at 90° C. for 48 h. After completion of the reaction, excess formic acid was extracted using centrifugation. The green solid product was rinsed with a copious amount of ethanol and separated using vacuum filtration. The vacuum dried sample gave a yield of 95% of as-made V(HCOO)₃. Analytical CHN data for as-made V(HCOO)₃ (molecular weight: 235.0079 g/mol): calculated weight percentages C: 20.44%, H: 1.72% and observed C: 20.19%, H: 2.13%.

### Hydrothermal Synthesis of V(HCOO)₃ Single Crystals

In a typical synthesis, formic acid (7.0 mL) and vanadium acetylacetonate (100 mg, 0.287 mmol) were added into a Teflon liner and stirred at room temperature for 30 min until they formed a homogeneous green suspension. Then, the contents were placed in a 23 mL Teflon lined Parr stainless steel autoclave and heated at 130° C. for three days followed by slow cooling to room temperature, giving green colour cubic crystals of vanadium formate (V(HCOO)₃(CO₂)_{0.75}(H₂O)_{0.25}(HCOOH)_{0.25}). The resulting crystals were washed with a copious amount of ethanol and separated using vacuum filtration. The vacuum dried sample gave a yield of 90% of V(HCOO)₃(CO₂)_{0.75}(H₂O)_{0.25}(HCOOH)_{0.25} (guest included/as-made V(HCOO)₃) single crystals.

### Activation of V(HCOO)₃

As-made V(HCOO)₃(CO₂)_{0.75}(H₂O)_{0.25}(HCOOH)_{0.25} (0.5 g, 0.0026 mol) was heated at 90° C. under high vacuum [1×10⁻⁴ mmHg] for 24 h, yielding quantitative amounts of the guest-free V(HCOO)₃ (VF). Analytical CHN data for VC₃H₃O₆ (molecular weight: 185.993 g/mol): calculated. C: 19.37%, H: 1.63%, and observed C: 15.45%, H: 2.26%.

### Synthesis of MOF-74-Ni

MOF-74-Ni was synthesized based on a literature method (S. Cadot et al., J. Mater. Chem. 2014, 2, 17757-17763). In a 100 mL round-bottom flask equipped with a condenser, a suspension of dihydroxyterephthalic acid (1.03 g, 5.1 mmol) in deionized water (40 mL) was heated to reflux under strong magnetic stirring. In a separate flask, nickel acetate tetrahydrate (2.51 g, 10 mmol) was dissolved in deionized water (10 mL) at 80° C. (353 K). The obtained light green nickel solution was added in one portion to the boiling ligand suspension under continuous stirring. The reaction mixture was further refluxed for 1 h. The final suspension was filtered, and the yellow microcrystalline powder was washed with warm deionized water (50×3 mL) and methanol (20×2 mL) before being dried overnight at 80° C. (353 K). The powder was degassed at 150° C. (423 K) for 20 h before the measurement of gas sorption isotherms.

### Synthesis of UiO-66-(OH)₂

UiO-66-(OH)₂ was prepared according to a literature method (Z. Hu et al., AlChE J. 2017, 63, 4103-4114; and Y. Wang et al., ACS Sustain. Chem. Eng. 2018, 6, 11904-11912). Briefly, 2,5-dihydroxyterephthalic acid (1 g, ≈5 mmol) and ZrOCl₂·8H₂O (1.7 g, ≈5.2 mmol) were added in a 50 mL water/acetic acid (20/30, v/v) mixture and heated under reflux (≈105° C., ≈378 K) for 1 day to afford a dark khaki powder. The powder was washed with deionized water three times before soaking in water and methanol each for 3 days at room temperature, during which the solvent was refreshed every day. After the final removal of methanol by decanting, the sample was activated under vacuum at 120° C. (393 K) overnight for further modifications and characterizations.

### Example 2. Characterization of as-Made Al(HCOO)₃ and ALF

### NPD of ALF and CO₂-Dosed ALF

Neutron diffraction measurements were performed on ALF powder (1.23 g) at the National Institute of Standards and Technology Center for Neutron Research (NCNR). Data were collected at the high-resolution neutron powder diffractometer, BT-1, utilizing a Ge(311) monochromator with an in-pile 60′ collimator, corresponding to a neutron wavelength of 2.079 Å. The sample was loaded into a vanadium sample can in a He environment glove box and sealed with a soldered lead O-ring onto a copper heating block containing a valved outlet for gas loading. After mounting the sample onto a bottom-loaded closed cycle refrigerator (CCR), the sample was reactivated at elevated temperatures under vacuum to remove possible residual helium. The sample was cooled to base temperature, and measured at various temperatures upon heating for sufficient time to be able to perform high-quality Rietveld refinements (the scans were on average 4 hours' worth of scan time), or with 1-hour scans to obtain unit cell values on heating. For CO₂ dosing data sets, a custom calibrated gas dosing manifold setup with a known volume and an attached pressure gauge were used to either maintain static pressure or deliver specific stoichiometric equivalents. NPD data were analyzed using the TOPAS 6 software suite (A. A. Coelho, J. App. Cryst. 2018, 51, 210-218). For consistency, Pawley refinement of the activated sample at 15 K was used to establish the peak shape used for all subsequent Pawley (G. S. Pawley, J. App. Cryst. 1981, 14, 357-361) and Rietveld refinements. Due to the high symmetry and quality of the NPD data, the CO₂ molecules did not require rigid body modelling. The CO₂ molecules were refined as atoms with the thermal parameter of the large CO₂ atoms fixed to the SC CO₂ atom values.

### Variable Temperature XRD

Variable temperature PXRD patterns were measured on a PanAlytical X'pert PRO MRD X-ray diffractometer with Cu Kα radiation (λ=1.5418 Å, 30 kV and 40 mA). PXRD patterns were recorded on pelletized (10 mm×10 mm) as-made Al(HCOO)₃ at various temperatures between 25° C. to 280° C. (298 K to 553 K) with a heating rate of 5° C./min, a step of 0.025° and a scan speed of 1 s/step.

Stability of Material Monitored from PXRD

As-made Al(HCOO)₃ (0.5 g) was soaked in water (10 mL), 12 M H₂SO₄, 12 M HCl and 12 M HNO₃ acidic solutions (10 mL), and 0.5 M NaOH basic solutions (10 mL) for 24 h at room temperature. For chemical stability tests, 0.5 g of ALF was soaked in methanol, acetonitrile, ethanol and tetrahydrofuran organic solvents (10 mL) and heated on a hot plate set at 323 K (50° C.) for 7 days. The vacuum-filtered samples of tested ALF were dried at 323 K (50° C.) for 1 h before PXRD analysis.

### Results and Discussion

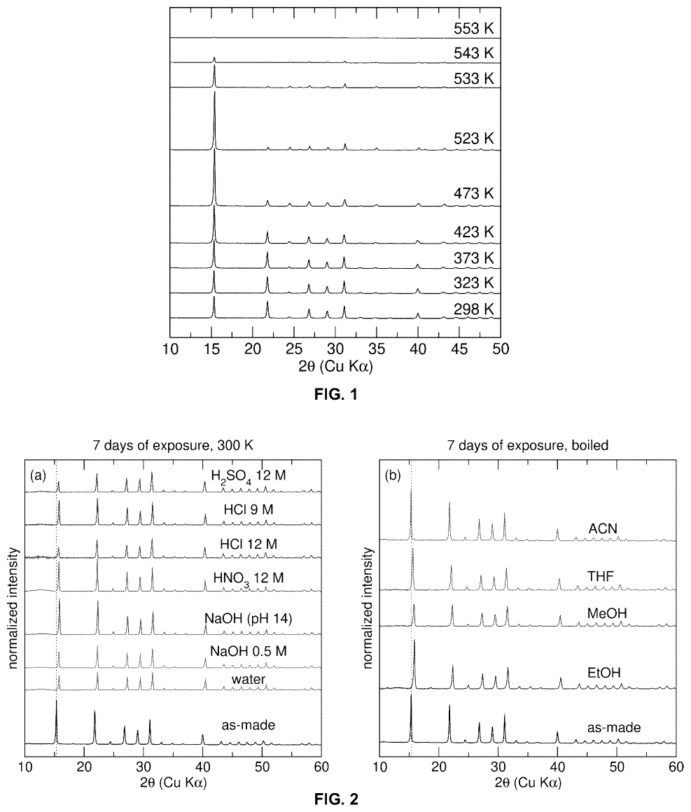

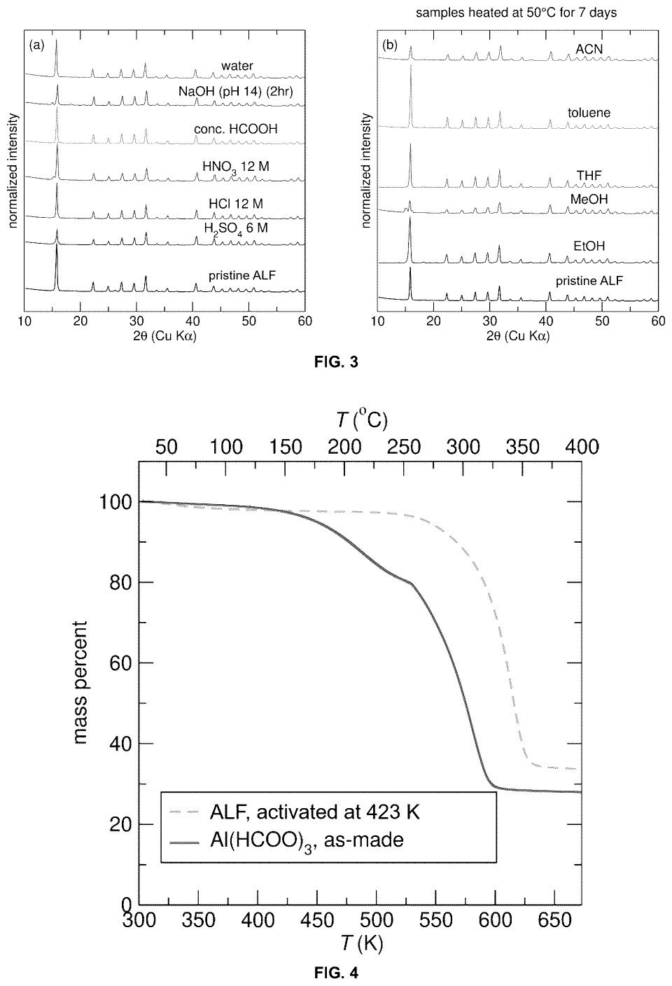

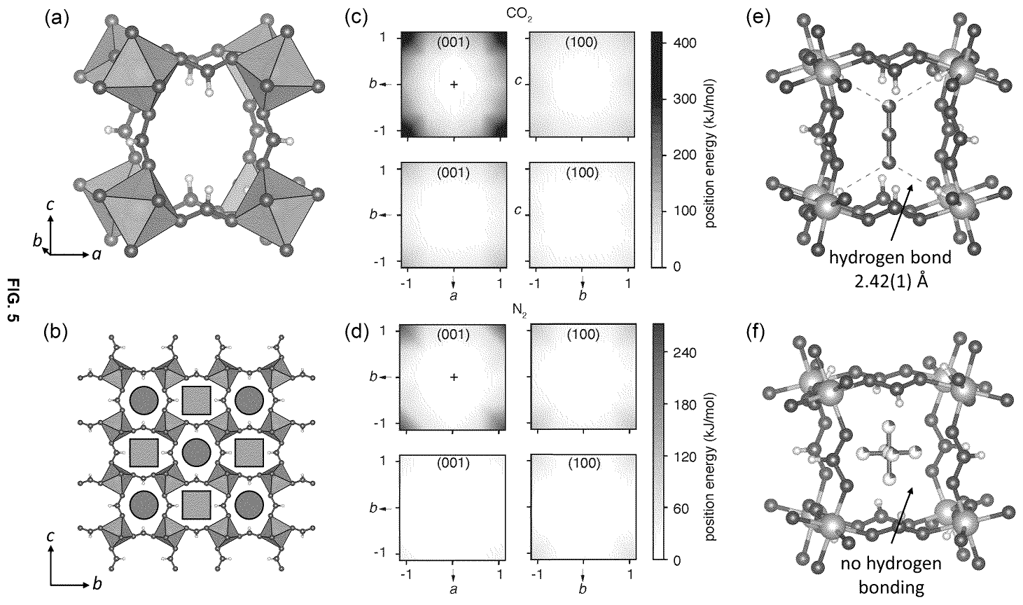

ALF displayed remarkable resilience to air/solvents/corrosive media, and was thermally stable up to ˜523 K in air (FIG. 1-4). Both as-made Al(HCOO)₃ and ALF retained crystallinity well in concentrated acid, base, and pure water environments, as seen in FIG. 2-3. However, the stability of both the as-made Al(HCOO)₃ and ALF fared better in basic or acid environments for extended periods. If soaked in water at room temperature for more than 12 h, the crystallinity of the activated material gradually begins to degrade. We believe this is related to the slow kinetics of H₂O adsorption into the material. The as-made material is slightly more robust than the activated one, and we believe this is related to the hydrophobic nature of the CO₂ within the SCs.

FIG. 5a shows the crystal structure of ALF, obtained from Rietveld refinement with NPD data; the fractional coordinates agree with the structure obtained by SC-XRD (Table 1) and energy minimization using DFT calculations (Tables 2-3). The crystal structure of ALF has two types of cavities, which are referred to as the SCs and the LCs. There are three times as many SCs as LCs, and the SC and LC pore volumes at 300 K are 43(3) Å³ and 79(9) Å³, respectively (obtained using PLATON, A. L. Spek, J. Appl. Cryst. 2003, 36, 7-13). For the SCs, four of the twelve formate ligands point their hydrogens inward (FIG. 5a), and for the LCs, all twelve of the formate ligand point their hydrogens outward.

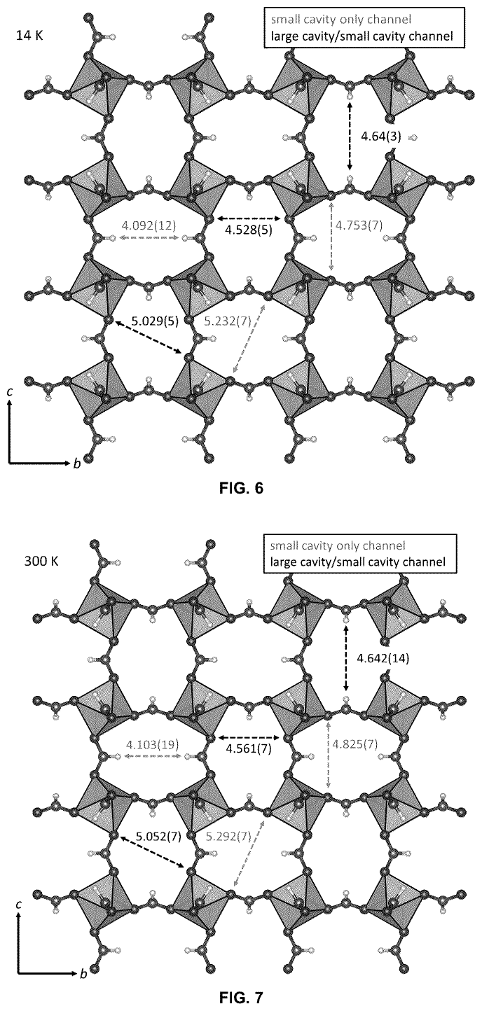

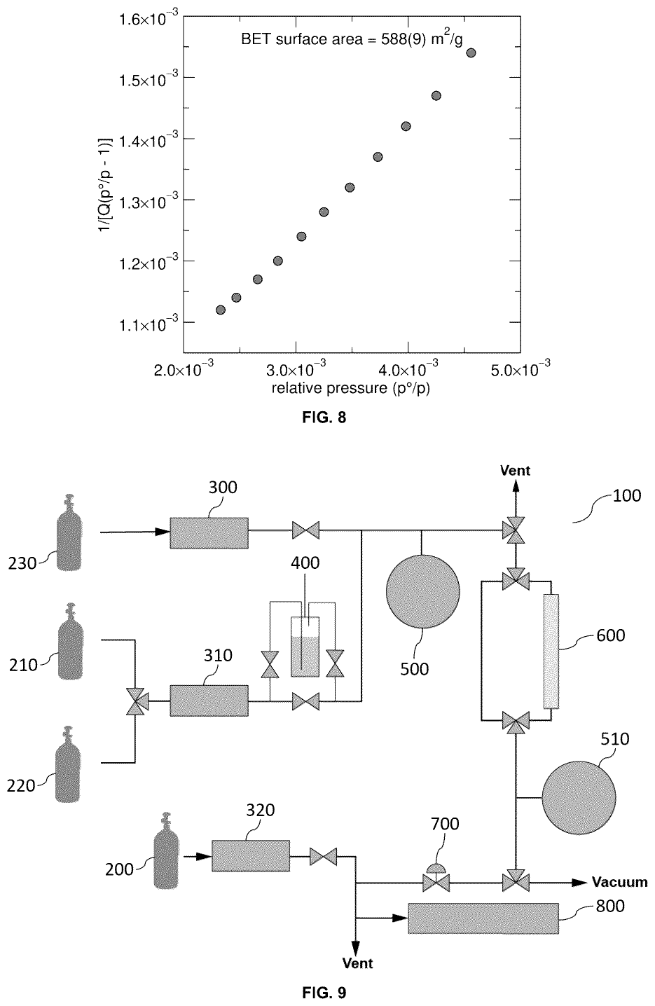

The inward-pointing formate hydrogens facilitated a favorable hand-in-glove relation between CO₂ and the SCs. Furthermore, the crystal structure contained two types of interpenetrating channels (FIG. 5b). One channel comprised only SCs (squares), and the other comprised alternating SCs and LCs (circles). Due to a favourable window size along the SC/LC channels relative to the SC/SC channels [4.561(7) A and 4.103(19) Å, respectively (FIG. 6-7)], favored CO₂ adsorption in the SC/LC channels. The adsorption energy was ˜50 kJ/mol per CO₂ for the small pore and ˜37 kJ/mol per CO₂ for the large pore, matching well with the experimental isosteric heat of adsorption (HOA) of CO₂, ˜48 kJ mol⁻¹, determined from variable temperature CO₂ adsorption isotherms. This HOA value is comparable to other well-studied MOFs. The BET surface area of ALF was estimated to be 588±8 m² g⁻¹ (error is 16; FIG. 8).

TABLE 1
Details of X-ray data collection and the structure refinement
of ALF. Values in parentheses indicate 1σ. CCDC Number 2075733.

| | |
|---|---|
| Empirical formula | AlC₃H₃O₆ |
| Formula weight | 162.03′ |
| Temperature | 473(2) K |
| Wavelength | 0.71073 Å |
| Crystal system | Cubic |
| Space group | Im-3 |
| Unit cell dimensions (a = b = c) | 11.4305(6) Å |
| Unit cell angle (alpha = beta = gamma) | 90° |
| Volume | 1493.5(2) Å³ |
| Z | 8 |
| Density (calculated) | 1.441 Mg/m³ |
| Absorption coefficient | 0.247 mm⁻¹ |
| F(000) | 656 |
| Crystal size | 0.096 × 0.091 × 0.070 mm³ |
| Theta range for data collection | 2.520 to 28.264°. |
| Index ranges | −15 <= h <= 10, −13 <= |
| | k <= 15, −15 <= l <= 14 |
| Reflections collected | 2730 |
| Independent reflections | 359 |
| R(int) | 0.0386 |
| Completeness to theta = 25.242° | 100.0% |
| Absorption correction | Semi-empirical from equivalents |
| Max. and min. transmission | 0.7457 and 0.6729 |
| Refinement method | Full-matrix least-squares on F² |
| Data/restraints/parameters | 359/0/19 |
| Goodness-of-fit on F² | 1.104 |
| Final R indices [I > 2sigma(I)] | R1 = 0.0687, wR2 = 0.1782 |
| R indices (all data) | R1 = 0.0772, wR2 = 0.1923 |
| Extinction coefficient | n/a |
| Largest diff. peak and hole | 2.105 and −0.292 Å⁻³ |

TABLE 2
Details of X-ray data collection and the structure refinement of
V(HCOO)₃. Values in parentheses indicate 1σ. CCDC Number 2174485.

| | |
|---|---|
| Molecular formula | VC_{3.75}H₄O_{7.75} |
| Formula weight | 224.007 |
| Temperture | 298(2) K |
| Wavelength | 0.71073 Å |
| Crystal system | Cubic |
| Space group | Im-3 |
| Unit cell dimensions | 11.7910(4) Å |
| (a = b = c) | |
| Unit cell angle (α = β = γ) | 90° |
| Volume | 1639.28(2) Å³ |
| Z | 2 |
| Density (calculated) | 1.807 Mg/m³ |
| Absorption coefficient | 1.219 mm⁻¹ |
| F(000) | 884.0 |
| Crystal size | 0.096 × 0.091 × 0.070 mm³ |
| Theta range for data | 2.520 to 28.264°. |
| collection | |
| Index ranges | −11 <= h <= 16, −13 <= |
| | k <= 16, −14 <= l <= 16 |
| Reflections collected | 3160 |
| Independent reflections | 472 |
| R(int) | 0.0442 |
| Completeness to theta = | 100.0% |
| 25.242° | |
| Absorption correction | Semi-empirical from equivalents |
| Max. and min. transmission | 0.918 and 0.890 |
| Refinement method | Full-matrix least-squares on F² |
| Data/restraints/ | 457/0/27 |
| parameters | |
| Goodness-of-fit on F² | 1.252 |
| Final R indices | R1 = 0.0766, wR2 = 0.1826 |
| [I > 2sigma(I)] | |
| R indices (all data) | R1 = 0.0872, wR2 = 0.2000 |
| Extinction coefficient | n/a |
| Largest diff. peak and hole | 1.759 and −0.561 Å⁻³ |

TABLE 3
DFT calculated lattice parameters (Å) of the ALF compared
to experiments. It was noticed that the symmetry of the ALF
will be reduced when CO₂ is adsorbed at the LC site.
Therefore, the arithmetic averages were taken as the
lattice parameters here. Experimental value from 14K
NPD data on ALF. Values are in units of Å.

| DFT, | Exp | DFT, | DFT, |
|---|---|---|---|
| empty | (14K, neutron) | CO₂@SCs | CO₂@SCs + LCs |
| 11.410 | 11.360 | 11.430 | 11.430 |

TABLE 4
DFT relaxed atomic fractional coordinates of ALF compared
with low temperature NPD results obtained at 14K. The NPD
results are shown in brackets. Values in [ ] denote 1σ

| | x | y | z | Site |
|---|---|---|---|---|
| Al | 0.25000 | 0.25000 | 0.25000 | 8c |
| | (0.25000) | (0.25000) | (0.25000) | |
| C | 0.26089 | 0.24107 | 0.00000 | 24g |
| | (0.2584[3]) | (0.2437[3]) | (0.00000) | |
| H | 0.20649 | 0.32109 | 0.00000 | 24g |
| | (0.2043[6]) | (0.3199[5]) | (0.00000) | |
| O | 0.29084 | 0.19622 | 0.09719 | 48h |
| | (0.2908[3]) | (0.1993[2]) | (0.09628[17]) | |

### Example 3. Isotherm and Breakthrough Adsorption of ALF

To validate the CO₂/N₂ separation performance of ALF, dynamic breakthrough experiments have been performed by flowing CO₂/N₂ (15/85) mixtures through the packed column of ALF pre-activated at 473 K. NPD experiments were carried out on ALF by following the protocol in Example 2.

### Breakthrough Measurements

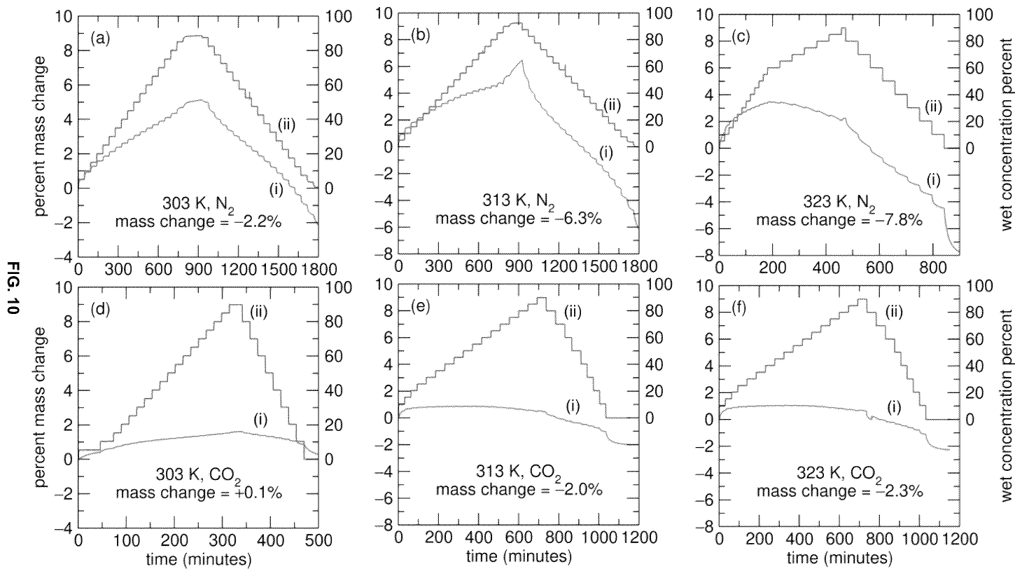

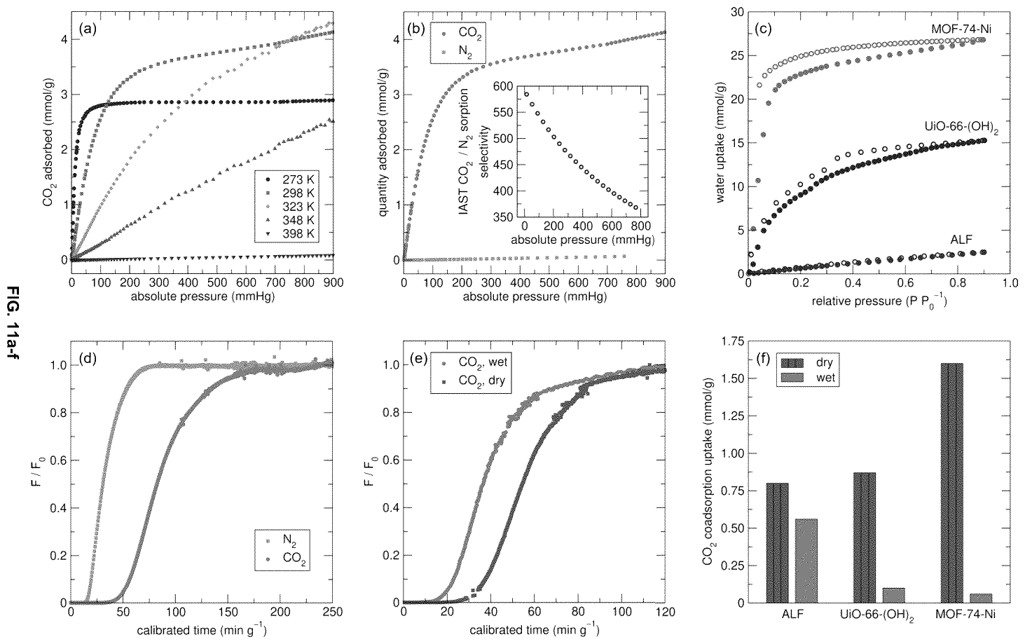

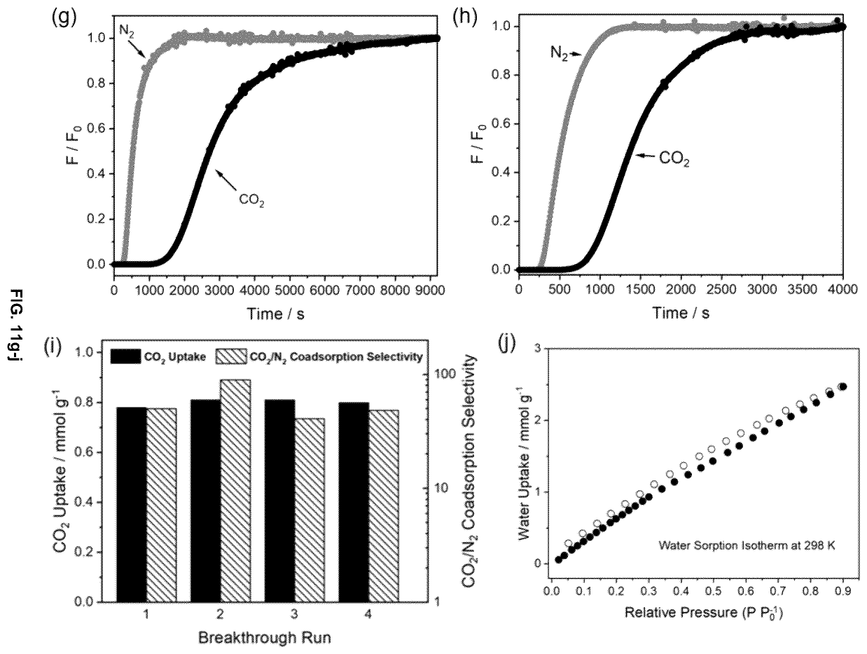

The breakthrough experiments were conducted using a home-built setup shown in FIG. 9. As shown, there is an experimental setup 100 that includes a gas cylinder of Ar (99.95%) 200, a gas cylinder of 15/85 CO₂/N₂ mixed gas 210, a gas cylinder of N₂ (99.95%) 220, a gas cylinder of He (99.95%) 230, mass flow controller (MFC)-1 300, MFC-2 310, MFC-3 320, a water reservoir 400, pressure gauges 500 and 510, a ¾ stainless steel column 600, a back pressure regulator 700, and a mass spectrometer 800. The stainless-steel columns used for loading MOF powders were 4 cm long, and their internal column diameter was 0.3 cm. Metal mesh and cotton wool were placed at both ends of the column to prevent the system from being contaminated by sample powders/pellets. A glass fibre heating tape was used for controlling the setup temperature for column activation, regeneration, and breakthrough experiments at a temperature above room temperature. The temperature of the heating tape (Omega DHT102040LD) was detected and controlled by an Omega thermocouple (5SC-TT-K-30-36) and a micro-controller (Omron E5CC), respectively. Gas composition at the exit of the column was determined by mass spectrometer 800 (Hiden QGA quantitative gas analysis system). The flow rate of each component gas was calculated by an internal Ar flow reference with a fixed flow rate of 5±0.05 sccm (standard cubic centimeter per min).

Before the breakthrough experiments, the adsorption columns were activated by purging a constant He flow (5±0.1 sccm) through the column at pre-determined temperatures (180° C., 150° C., and 120° C. [453 K, 423 K, and 393 K] for ALF, MOF-74-Ni, and UiO-66-(OH)₂, respectively) for at least 12 h until no solvent or moisture signal could be detected by the mass spectrometer. For dry gas breakthrough experiments, a 15/85 premixed CO₂/N₂ flow with a total flow rate of 2±0.05 sccm was stabilized for 40 min before being introduced into the column. As for the experiments of wet gas breakthrough, a N₂ flow (2±0.05 sccm) purging through the water reservoir (relative humidity (RH)) 80.5% at 25° C. (298 K) as determined by Omega RH318 hygro-thermometer) was used to saturate the adsorption columns before introducing the 15/85 CO₂/N₂ mixed gas (2±0.05 sccm) into the column.

### Adsorption Capacity and Selectivity Calculations Based on Breakthrough Data

Based on the mass balance of certain gas component in the mixed gas across the whole packed column (In-Out=Accumulation) including the dead volume of the setup (volume inside the setup excluding the column), it can be derived that,

$$ε {v}_{0} {C}_{0} {At}_{c} - {\int }_{0}^{{t}_{c}} ε {v}_{t} {C}_{t} Adt = LA ε {C}_{e} + LA ( 1 - ε ) {q}_{e} + {V}_{d} {C}_{e} \qquad Equation 1$$

where ε is the bed porosity estimated based on the crystal density of the adsorbents, v₀ is the total interstitial gas velocity (m s⁻¹) at the column inlet; C₀ is the inlet gas concentration (mol m⁻³), A is the cross sectional area of column (m²), t_{c} is the elution time (s), vₜ is the interstitial gas velocity (m s⁻¹) at the exit of the column, Cₜ is the exit gas concentration (mol m⁻³), Cₑ is the average gas concentration in the column (mol m⁻³), V_{d} is the dead volume of the setup (m³), L is the column length (m), and qₑ is the equilibrium concentration of adsorbate in the adsorbent (mol m⁻³) corresponding to the average column pressure Pₑ (calculated vide infra).

By dividing both sides of Equation 1 with the gas molar flow rate of this component at the column inlet, Equation 1 is rearranged to

$${\int }_{0}^{{t}_{c}} ( 1 - \frac{{F}_{t}}{{F}_{0}} ) dt = \frac{L}{{v}_{0}} ( \frac{{C}_{e}}{{C}_{0}} + \frac{1 - ε}{ε} \frac{{q}_{e}}{{C}_{0}} ) + \frac{{V}_{d} {C}_{e}}{{F}_{0}} \qquad Equation 2$$

The gas concentration at the inlet of the column can be calculated by the following equation,

$${C}_{0} = \frac{{y}_{0} {P}_{in}}{R \times T} \qquad Equation 3$$

where y₀ and Pᵢₙ are the gas composition and pressure (kPa) at the inlet (upstream) of the column, respectively.

According to Darcy's law, a linear pressure profile in the bed was assumed. Therefore, the average column pressure (Pₑ) and average gas concentration (Cₑ) can be calculated as below:

$${P}_{e} \approx \frac{{P}_{in} + {P}_{out}}{2} \qquad Equation 4$$

$${C}_{e} \approx \frac{{y}_{t} {P}_{e}}{RT} = \frac{{y}_{t} ( {P}_{in} + {P}_{out} )}{2 RT} \qquad Equation 5$$

where yₜ and Pₒᵤₜ are the gas composition and pressure (kPa) at the outlet (downstream) of the column, respectively. Equation 2 can be further rearranged as

$${\int }_{0}^{{t}_{c}} ( 1 - \frac{{F}_{t}}{{F}_{0}} ) dt = \frac{L}{{v}_{0}} ( \frac{{P}_{i n} + {P}_{out}}{2 {P}_{i n}} + \frac{1 - ε}{ε} \frac{{q}_{e}}{{C}_{0}} ) + \frac{{V}_{d} {C}_{e}}{{F}_{0}} \qquad Equation 6$$

The dead volume item in the above equation can be obtained by performing dead volume breakthrough experiments using the bypass of the setup, and perform the integration as follows:

$${\int }_{0}^{{t}_{c}^{′}} ( 1 - \frac{{F}_{t}}{{F}_{0}} ) dt = {\overline{t}}_{blank} = \frac{{V}_{d} {C}_{e}}{{F}_{0}} \qquad Equation 7$$

where t_{c}′ is the elution time of the dead volume breakthrough experiments, and t̅_{blank} is the mean residence corresponding to the setup dead volume.

Breakthrough selectivity was calculated using Equation 8,

$$S = \frac{{q}_{e 1} / {c}_{e 1}}{{q}_{e 2} / {c}_{e 2}} \qquad Equation 8$$

where Cₑᵢ is the equilibrium concentration of component i in gas phase, and qₑᵢ is the gas concentration of component i in the adsorbent.

### Point by Point (PBP) Correction of Breakthrough Curves of Wet CO₂ (FIG. 55)

Because the dead volumes of dry gas and wet gas breakthrough experiments are different, it is necessary to employ the PBP correction method (A. Rajendran, V. Kariwala & S. Farooq, Chem. Eng. Sci. 2008, 63, 2696-2706) to calibrate the breakthrough curves before comparing the breakthrough time of CO₂ under dry and wet conditions. In this method, the corrected breakthrough time was calculated as,

$${t}_{corrected} = t - {t}_{b} \qquad Equation 9$$

where t is the breakthrough time of a specific normalized flow rate F/F₀ in the breakthrough of adsorption column, and t_{b} be the breakthrough time of the same normalized flow rate in the breakthrough experiment of a bypass column.

### Gas Adsorption Experiments

Single component gas sorption isotherms were measured on a Micromeritics 3-FLEX surface area and porosity analyzer instrument. For all the analysis, as-made Al(HCOO)₃ (100 mg) was heated at 150° C. (423 K) for 24 h using smart VacPrep Micromeritics high vacuum degas instrument. After 24 h, the sample tubes were transferred into the analysis chamber and continued further in-situ activation at 150° C. (423 K) for additional 6 h using in-situ pre-heating Micromeritics 3-FLEX vacuum chamber. The temperature on the analysis bath was precisely controlled using a custom-made Heidolph magnetic stirrer Hei-Tec hotplate with Pt 1000 temperature sensor control system. A saturated solution of dry-ice and acetone mixture was used for the 195 K isotherms and liquid N₂ was used for the 77 K N₂ isotherms measurements.

Calculation of CO₂/N₂ Sorption Selectivity

The gas adsorption isotherms of CO₂ and N₂ were firstly fitted to the Langmuir (Equation 10) and Henry model (Equation 11), respectively,

$$q = \frac{{q}_{s a t} bp}{1 + bp} \qquad Equation 10$$

$$q = {K}_{H} p \qquad Equation 11$$

where q is the amount of adsorbed gas (mmol g⁻¹), p is the bulk gas phase pressure (kPa), qₛₐₜ is the saturation amount (mmol g⁻¹), K_{H} is the Langmuir-Freundlich parameter (kPa⁻¹), and is the Henry constant (mmol g⁻¹ kPa⁻¹).

Ideal adsorbed solution theory starts from the Raoults' Law type of relationship between fluid and adsorbed phase,

$${P}_{i} = {Py}_{i} = {P}_{i}^{0} {x}_{i} \qquad Equation 12$$

$${\sum }_{i = 1}^{n} {x}_{i} = {\sum }_{i = 1}^{n} \frac{{P}_{i}}{{P}_{i}^{0}} = 1 \qquad Equation 13$$

where Pᵢ is partial pressure of component i (kPa), P is total pressure (kPa), yᵢ and xᵢ represent mole fractions of component i in gas and adsorbed phase (dimensionless). Pᵢ⁰ is equilibrium vapour pressure (kPa).

In IAST, Pᵢ⁰ is defined by relating to spreading pressure π,

$$\frac{π S}{R T} = {\int }_{0}^{{P}_{i}^{0}} \frac{{q}_{i} ( {P}_{i} )}{{P}_{i}} {dP}_{i} = \prod ( Constant ) \qquad Equation 14$$

where π is spreading pressure, S is specific surface area of adsorbent (m² g⁻¹), R is gas constant (8.314 J K⁻¹ mol⁻¹), T is temperature (K), q₁(Pᵢ) is the single component equilibrium obtained from isotherm (mmol g⁻¹).

For a Langmuir model, we have an analytical expression for the integral,

$${\int }_{0}^{{P}_{i}^{0}} \frac{{q}_{i} ( {P}_{i} )}{{P}_{i}} {dP}_{i} = \prod ( Constant ) = {q}_{s a t} ln ( 1 + {b}_{A} {P}_{0}^{i} ) \qquad Equation 15$$

For a Henry model, the analytical expression for the integral is

$${\int }_{0}^{{P}_{i}^{0}} \frac{{q}_{i} ( {P}_{i} )}{{P}_{i}} {dP}_{i} = \prod ( Constant ) = {K}_{H} {P}_{i}^{0} \qquad Equation 16$$

The isotherm parameters will be known from the previous fitting. For a binary component system, the unknowns will be Π, P₁⁰, and P₂⁰, which can be obtained by simultaneously solving Equation 12 and 14 via the Python package pyIAST (C. M. Simon, B. Smit & M. Haranczyk, Comput. Phys. Commun. 2016, 200, 364-380).

The adsorbed amount for each component in a mixture is

$${q}_{i}^{mix} = {x}_{i} {q}_{T} \qquad Equation 17$$

$$\frac{1}{{q}_{T}} = {\sum }_{i = 1}^{n} \frac{{x}_{i}}{{q}_{i} ( {P}_{i}^{0} )} \qquad Equation 18$$

Where qᵢ^{mix} is the adsorbed amount of component i (mmol g⁻¹), q_{T} is the total adsorbed amount (mmol g⁻¹).

The adsorption selectivity S_{ads} can be calculated using Equation 19.

$${S}_{IAST} = \frac{{q}_{1} / {q}_{2}}{{p}_{1} / {p}_{2}} \qquad Equation 19$$

### TGA CO₂ Cycling

TGA cycling experiments were measured on Q500 Thermogravimetry Analyzer. Cycling experiments were carried out under CO₂ gas flow (60 mL/min) with protective N₂ gas (40 mL/min) for mass balance. For analysis, fresh ALF (12 mg) was loaded on to the aluminium pan and equilibrated at 40° C. (313 K) for 120 min then heated up to 120° C. (393 K) with a heating rate of 2° C./min and then cooled down to 40° C. (313 K) with a cooling rate of 25° C./min. The same experimental condition was repeated for 5 conjugative cycles without changing the sample amount and material from the TGA chamber.

For humid CO₂/N₂ experiments, TGA cycling tests between 40° C. (313 K) to 80° C. (353 K) were conducted for 50 cycles using 3% humid CO₂/N₂(15/85). CO₂/N₂(15/85) gas flow rate was 20.0 mL/min, and CO₂/N₂(15/85) gas was exposed to the sample at 313 K for 30 min in each cycle before activation at 353 K.

### DFT Calculated Lattice Parameters

Thermal expansion coefficients were calculated by performing the phonon calculations at different volumes (±1% and ±2%) using the finite displacement method with the Phonopy code (A. Togo & I. Tanaka, Scr. Mater. 2015, 108, 1-5) at the quasi-harmonic approximation (QHA) level. A higher kinetic energy cutoff of 800 eV and a denser 4×4×4 Monkhorst-Pack were used for all calculations. Interatomic forces were further relaxed until smaller than 0.001 eV/A.

### Hydrolytic Stability Tests

Humidity studies were conducted on ALF samples made from as-made Al(HCOO)₃ (100 mg) samples that were activated for 24 h at 180° C. (453 K). Each ALF sample during the humidity stability studies was exposed to 85% humid water at 85° C. (85/85) for time periods in between 1 h to 24 h in a Labec QHT-30 temperature and humidity chamber with a relative humidity (RH) range of 25-98% and a temperature range of 20-120° C. After completion of respective exposure times (1 h to 24 h), each sample was then analyzed with PXRD, TGA, and CO₂ sorption tests.

CO₂ adsorption isotherms were measured following the hydrolytic treatment described above. Prior to the measurements, the samples (≈70 mg) were re-activated at 180° C. (453 K) for 24 h using smart VacPrep Micromeritics high vacuum degas instrument. All the isotherms were measured at 50° C. (323 K) on a Micromeritics 3-FLEX surface area and porosity analyzer instrument. After 24 h, the sample tubes were transferred into the analysis chamber and underwent further in-situ activation at 150° C. (423 K) for an additional 6 h using in-situ pre-heating Micromeritics 3-FLEX vacuum chamber. The temperature on the analysis bath was precisely controlled using Heidolph magnetic stirrer Hei-Tec hotplate with Pt 1000 temperature sensor control system.

### DVS Experiments

Dynamic water vapor sorption measurements were performed on a gravimetric instrument (Hiden IGAsorp-CT, Warrington, UK) using CO₂ or N₂ as the carrier gas. The sample was first loaded at laboratory ambient conditions (21° C. (294 K), 40% RH) and dried in situ by flowing dry nitrogen gas through the sample chamber at 120° C. (393 K) for 6 h. After drying, the temperature was lowered to 50° C. (323 K). When CO₂ was used as the carrier gas, the inlet gas was switched at this point and the sample equilibrated for at least 2 h until the mass was stable within 0.01 mg/min. Thereafter, the sample chamber was regulated to the measurement temperature (either 313 K, 323 K, or 333 K) and held for another 2 h.

An adsorption-desorption cycle was performed by sequentially ramping the relative humidity (RH) from 0% to 90%/95%, and back to 0% in fixed increments no more than 10% RH. RH is controlled by varying the proportion of dry and wet gas flowing into the sample chamber. For runs with CO₂ as carrier, direct measurement of RH is not possible due to sensor incompatibility and hence the RH is approximated by the relative proportion of wet gas, which is termed “wet concentration”. The mass change of the sample was recorded in real time and normalized against the initial (dry) weight. Cycles were repeated at least two times at each temperature, and the data for the second run are reported in FIG. 10.

Due to mass loss of the samples throughout the measurements, only the run at 30° C. (313 K) and CO₂ as carrier is reflective of multicomponent equilibria in ALF sorbent. The equilibrium uptake was estimated by instrument-accompanying analysis method, which regresses real time kinetic data against an exponential uptake function. Isothermal uptake data for this run were reported as % mass change against ‘wet concentration’ analogous to the DVS runs.

### Results and Discussion

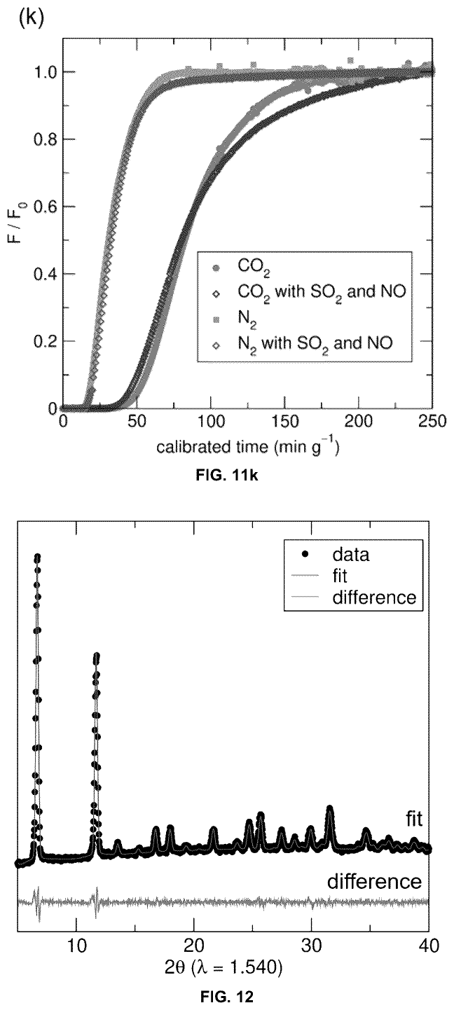

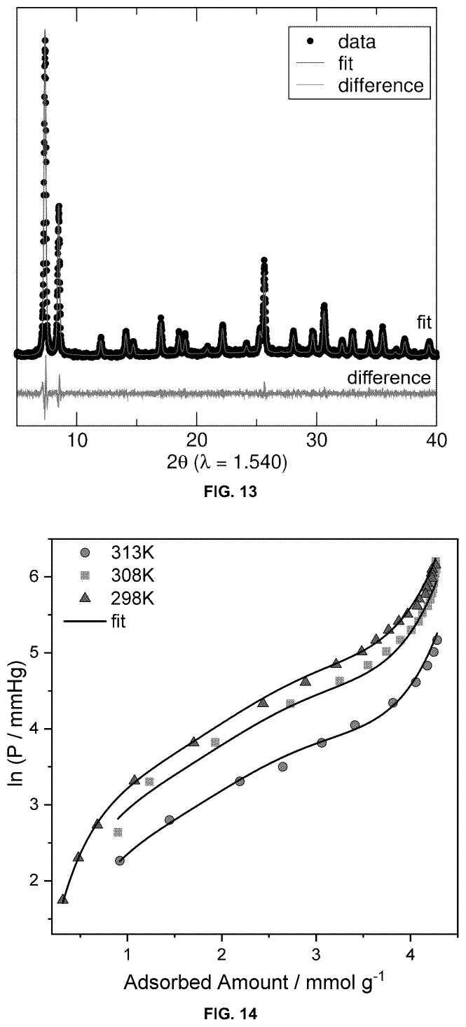

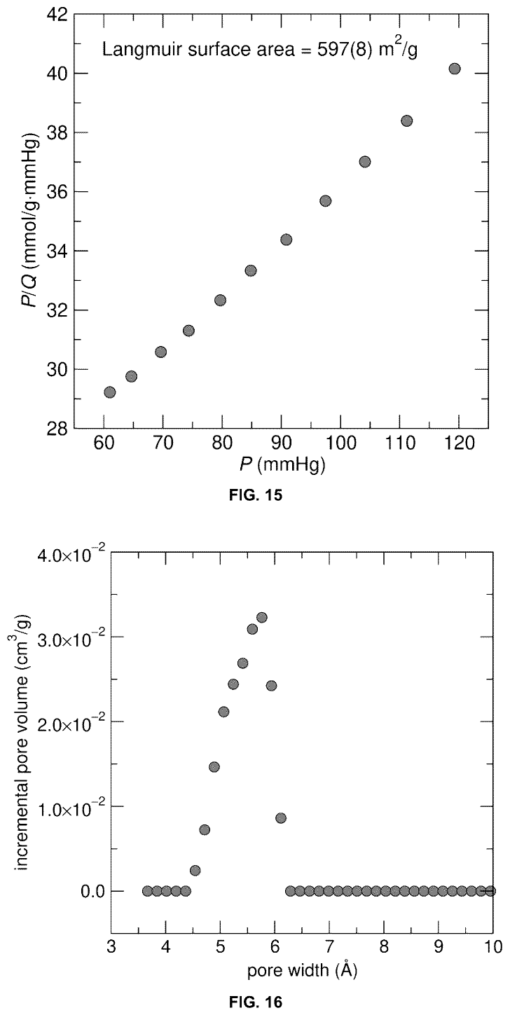

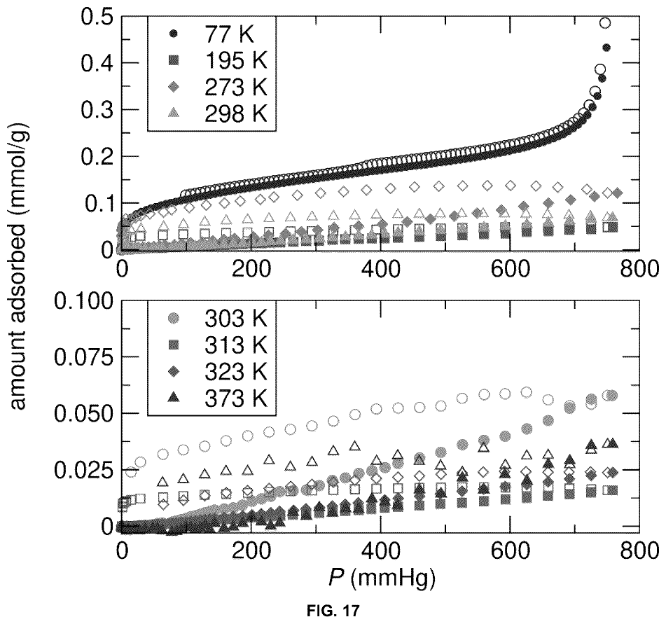

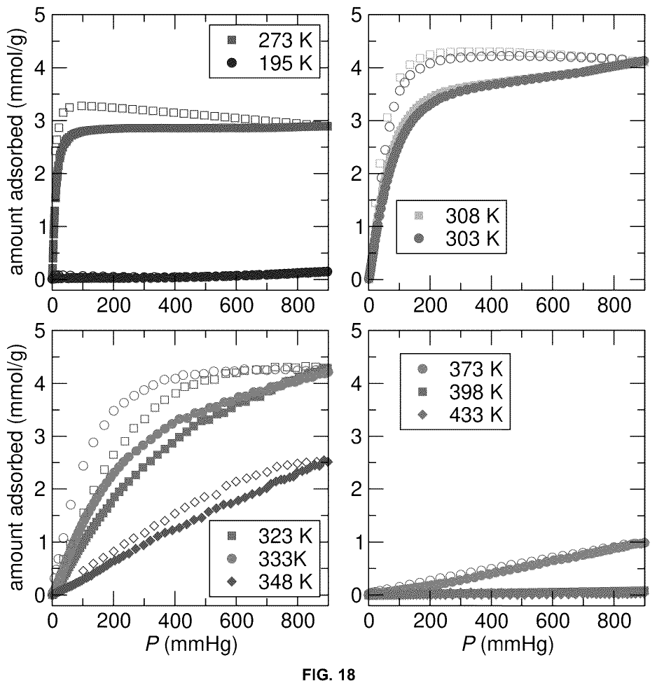

As shown in FIG. 11a-b, despite the microporosity of ALF, it did not adsorb N₂ at 298 K, and indeed at all practically useful temperatures (see FIG. 17), but readily adsorbed CO₂ at and above 273 K. Interestingly, the low-pressure CO₂ uptake was substantial, and persisted to 323 K with noticeable desorption hysteresis loops, suggesting appreciable diffusion barriers for CO₂ in the SC/SC channels of ALF (see FIG. 18). ALF's affinity for water was much reduced compared with other leading MOFs that are known to be hydrophilic, such as MOF-74-Ni and UiO-66-(OH)₂ (FIG. 11c), but it is not negligible, as discussed below.

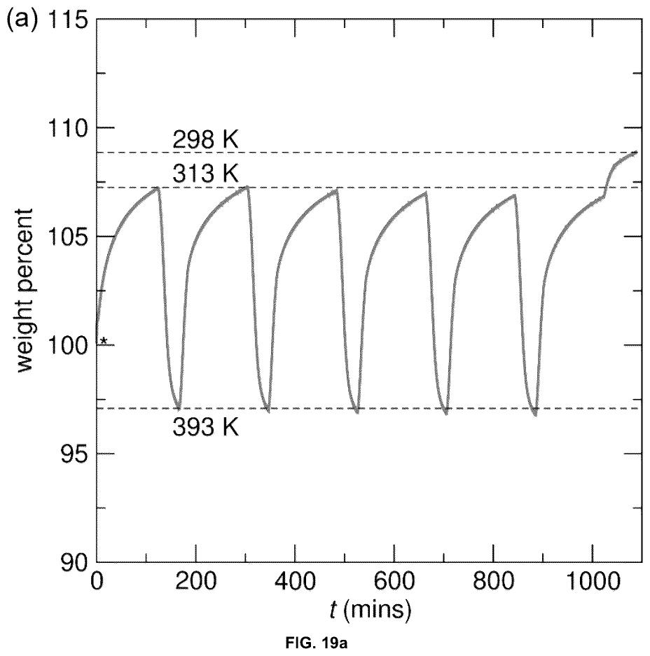

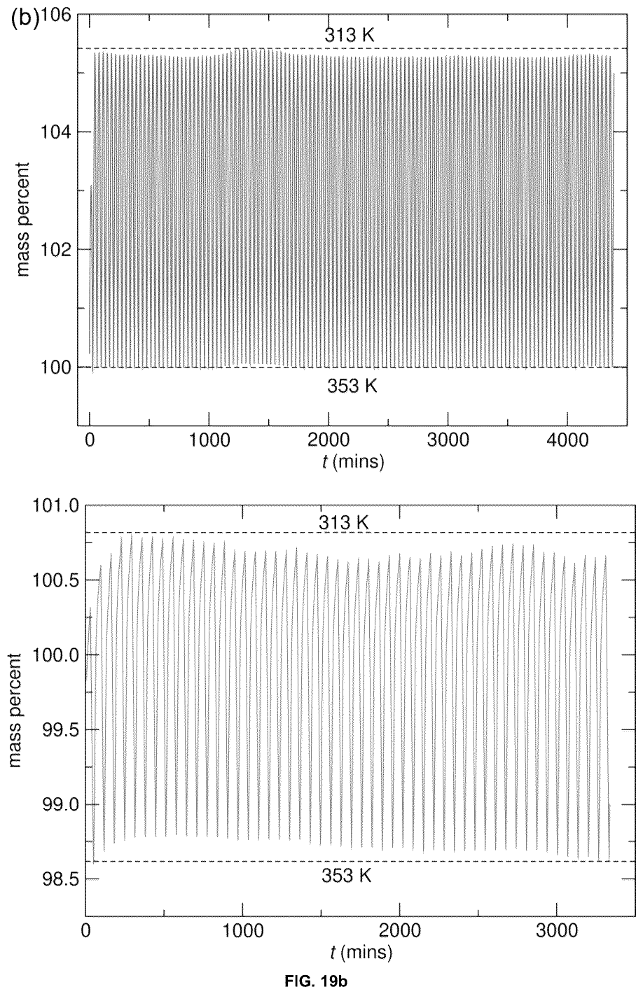

Although most experimental screening efforts concentrate on CO₂ uptake at near-ambient temperature (298 K), the practical implementation favors a slightly higher operating temperature due to other pretreatment units for post-combustion flue gas. ALF performed well under these conditions, as shown by our dynamic column breakthrough experiments at 323 K using a simulated feed (15/85 mixture of CO₂ and N₂). The CO₂ concentration front was substantially delayed compared to that of N₂ because of selective adsorption by ALF packed within the column (FIG. 11d). The calculated capacity of CO₂ coadsorption was 0.9 mmol g⁻¹, whereas the N₂ counterpart was barely detectable (<0.1 mmol g⁻¹). Furthermore, these characteristics are largely retained in the presence of SO₂ and NO (FIG. 11k, suggesting excellent stability of ALF against corrosive gases. In terms of the system's cyclability, the guest-free MOF could be regenerated by heating to 353 K under a CO₂ atmosphere and was stable over more than 100 cycles (FIG. 19, top panel). At 298 K, N₂ eluted through the column a few min before CO₂ broke through (FIG. 11g), which confirms the feasibility of capturing CO₂ from N₂. The coadsorption CO₂ uptake of ALF was about 2.3 mmol/g (3.3 mmol/cm³). At 323 K, the column was still able to separate CO₂ from N₂ as shown in FIG. 11h, maintaining an impressive CO₂ uptake of 0.89 mmol g⁻¹ (1.3 mmol/cm³) and a CO₂/N₂ sorption selectivity of about 100 based on 4 repeated experiments (FIG. 11i).

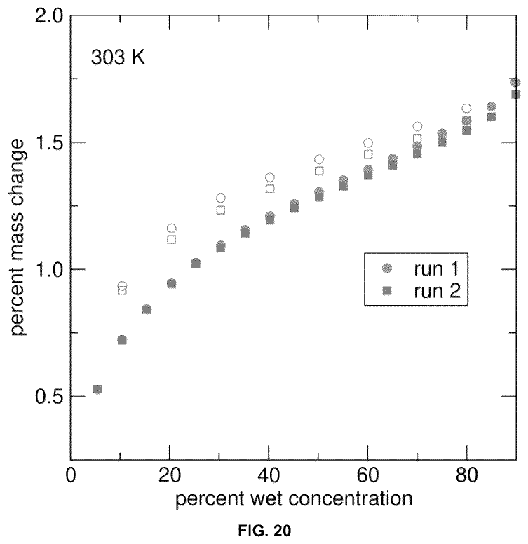

Considering that water vapor in post-combustion flue gas may not only compete with CO₂ for gas sorption sites in MOFs but also amorphize the crystalline frameworks, it is crucial to study water sorption in ALF and investigate how moisture in the feeding gas will compromise the CO₂ capture performance of the column. Therefore, we explored the performance of ALF under wet flue gas conditions. Experiments in which columns were pre-saturated by moisture (RH=80.5%) maintained 70% of their CO₂ dynamic capacity (FIG. 11e). In addition, CO₂ broke through the column slightly earlier than the dry scenario, and the reduction in CO₂ uptake capacity was only about 17% compared to the uptake of the dry column. This suggests that CO₂ is capable of out-competing H₂O guests for sites within ALF. Usually, this level of CO₂-preference versus H₂O in MOFs requires chemisorption sites like alkyl amine moieties (Table 5). In FIG. 11f, the performance of ALF was compared with other leading MOFs, and it was shown that ALF outperformed MOF-74-Ni and UiO-66-(OH)₂ under wet conditions. While these results suggest that ALF exhibits promising physisorptive CO₂ capture characteristics under wet post-combustion flue gas conditions, further experiments have shown that the system is nevertheless sensitive to moisture under certain circumstances. As can be seen from DVS experiments performed on ALF at 303 K, 313 K, and 323 K with N₂ or CO₂ carrier gases (FIG. 10), at 303 K, ALF could withstand water concentrations up to 90% saturation without degradation with CO₂ carrier gas. However, at 313 K and 323 K, there was =2% mass loss with CO₂ carrier gas. Under N₂, degradation occurred at all tested temperatures. A noticeable difference between the N₂ and CO₂ experiments is that the degradation of ALF is approximately 3 to 4-fold less when CO₂ is used as the carrier gas. This indicates that the presence of CO₂ imparts a partial defence against water-induced material degradation. These DVS experiments indicate that although ALF likely cannot be used to directly treat post combustion flue gas saturated with moisture, it shows promise when coupled with a suitable upstream drying technology. Drying to ALF's stability envelope (≈25% RH at 323 K) may be realised by relatively cheap and facile approaches such as cooling and condensation (K. T. Leperi, R. Q. Snurr & F. You, Ind. Eng. Chem. Res. 2016, 55, 3338-3350), contrasting the necessity for deep drying to as low as <100 ppm [dew point: −40° C. (233 K)] to circumvent binding site poisoning for highly hygroscopic sorbents. Isothermal uptake data for the DVS run at 30° C. (313 K) were reported as % mass change against ‘wet concentration’ analogous to the DVS runs and shown in FIG. 20. Furthermore, ALF's resilience to humidity near room temperature facilitates easy handling and storage without inert atmosphere or other cumbersome precautions if used on an industrial scale.

Interestingly, ALF only adsorbed 55 cm³/g (2.4 mmol/g or 3.5 mmol/cm³) of water at 90% RH and 298 K, which is much lower than the water uptake of other MOF materials for CO₂ capture such as MOF-74-Mg (D.-A. Yang et al., Energy Environ. Sci. 2012, 5, 6465-6473) and UiO-66(Zr)—(OH)₂ (Z. Hu et al., AlChE J. 2017, 63, 4103-4114). Moreover, the linear isotherm (FIG. 11j) contrasts noticeably with the type I H₂O sorption isotherms of those hydrophilic MOFs, suggesting a much weaker water affinity of ALF. These CO₂ capture results along with the ready availability of ALF promise unlimited potential of the material for industrial CO₂ capture applications.

TABLE 5
A summary of CO₂ capture properties of selected porous adsorbents in literature.

| | | | | | | | | | |
|---|---|---|---|---|---|---|---|---|---|
| | | | | | | | | CO₂ Uptake | |
| | | | | | | | | after | |
| | | | | | | | | Contact | |
| | | | | | | | | with Water/ | |
| | | | | | | | | mmol g⁻¹ | |
| | BET | | | | Low | | | (Percentage | |
| | Surface | Pore | CO₂ | CO₂ | Coverage | | Water | of Retained | |
| | Area/m² | Size/Å | Uptake/ | Uptake/ | Qₛₜ/kJ | CO₂/N₂ | Competition | CO₂ | |
| Adsorbents | g⁻¹ | (Å²) | mmol g^{-1 a)} | mmol cm^{-3 b)} | mol⁻¹ | Selectivity ^{c)} | Studied | Uptake; RH) | Reference |

Physisorbents - MOFs

| | | | | | | | | | |
|---|---|---|---|---|---|---|---|---|---|
| ALF | 588 | 4.1, 4.5 | 2.7 | 3.9 | 47.9 | 368 | Yes ^{d)} | 0.56 (70.0%; | This work |
| | | | | | | | | 80%) at 323 | |
| | | | | | | | | K | |
| MOF-74-Ni | 941 | 10 | 3.4 | 4.1 | 38 | 32 | Yes ^{d)} | 0.06 (3.8%; | This work, |
| | | | | | | | | 80%) at 323 | Inorg. |
| | | | | | | | | K | Chem. |
| | | | | | | | | | 2019, 58, |
| | | | | | | | | | 2717-2728 |
| UiO-66-(OH)₂ | 1230 | 3.9 × 5.8 | 2.5 | 3.4 | 33 | 105 | Yes ^{d)} | 0.10 (11.5%; | This work, |
| | | | | | | | | 80%) at 323 | AlChE J. |
| | | | | | | | | K | 2017, 63, |
| | | | | | | | | | 4103-4114 |
| MOF-74-Mg | 1640 | 10 | 5.8 | 5.3 | 52 | 182 | Yes ^{e)} | Degraded | Nat. |
| | | | | | | | | after contact | Commun. |
| | | | | | | | | with | 2012, 3, 1- |
| | | | | | | | | moisture | 9; Proc. |
| | | | | | | | | | Nat. Acad. |
| | | | | | | | | | Sci. U.S.A. |
| | | | | | | | | | 2009, 106, |
| | | | | | | | | | 20637- |
| | | | | | | | | | 20640; |
| | | | | | | | | | Angew. |
| | | | | | | | | | Chem. Int. |
| | | | | | | | | | Ed. 2015, |
| | | | | | | | | | 54, 14372- |
| | | | | | | | | | 14377; and |
| | | | | | | | | | Energy |
| | | | | | | | | | Environ. |
| | | | | | | | | | Sci. 2011, |
| | | | | | | | | | 4, 3030- |
| | | | | | | | | | 3040 |
| ZnF(daTZ) | 479 | 4.2 | 0.96 | 1.8 | 33 | 120 | Yes ^{e)} | 0.94 (98%; | J. Am. |
| | | | | | | | | 99%) at 298 | Chem. |
| | | | | | | | | K | Soc. 2020, |
| | | | | | | | | | 142, 2750- |
| | | | | | | | | | 2754 |
| IISERP-MOF2 | 470 | 4.7 | 1.6 ^{f)} | 2.0 | 33 | 1800 | Yes ^{e)} | 3.7 (92.7%; | J. Am. |
| | | | | | | | | 50%) at 298 | Chem. |
| | | | | | | | | K | Soc. 2017, |
| | | | | | | | | | 139, 1734- |
| | | | | | | | | | 1737 |
| MUF-16 | 214 | 3.6 × 7.6 | 1.2 ^{g)} | 1.9 | 32.3 | 631 ^{h)} | Yes ^{e)} | N.A. (N.A.; | ACS Appl. |
| | | | | | | | | 82%) at 293 | Mater. |
| | | | | | | | | K | 2021, 13, |
| | | | | | | | | | 2141- |
| | | | | | | | | | 12148 |
| SIFSIX-2-Cu-i | 734 | 5.2 | 1.7 ^{g)} | 2.1 | 31.9 | 140 ⁱ⁾ | Yes ^{e)} | 1.6 (≈81%; | Nature |
| | | | | | | | | 74%) at 298 | 2013, 495, |
| | | | | | | | | K | 80-84 |
| UTSA-16 | 687 | 4.3 × 9.5 | 2.1 | 3.5 | 39.7 | 315 | Yes ^{j)} | N.A. | Nat. |
| | | | | | | | | | Commun. |
| | | | | | | | | | 2012, 3, 1- |
| | | | | | | | | | 9; Phys. |
| | | | | | | | | | Chem. |
| | | | | | | | | | Chem. |
| | | | | | | | | | Phys. |
| | | | | | | | | | 2016, 18, |
| | | | | | | | | | 220-227; |
| | | | | | | | | | and Chem. |
| | | | | | | | | | Eng. J. |
| | | | | | | | | | 2020, 402, |
| | | | | | | | | | 126166 |
| NbOFIVE-1-Ni | 280 | 3.2 | 2.2 | 3.9 | 50 | N.A. | Yes ^{j)} | N.A. (N.A.; | J. Am. |
| | | | | | | | | 75%) at 298 | Chem. |
| | | | | | | | | K | Soc. 2016, |
| | | | | | | | | | 138, 9301- |
| | | | | | | | | | 9307 |
| SIFSIX-3-Cu | 300 | 3.5 | 2.5 | 4.0 | 54 | N.A. | Not studied | N.A. | Nat. |
| | | | | | | | | | Commun. |
| | | | | | | | | | 2014, 5, 1- |
| | | | | | | | | | 7 |
| Qc-5-Cu-sql-b | 222 | 3.3 | 0.8 ^{g)} | 1.2 | 36 | 40000 | Not studied | N.A. | Angew. |
| | | | | | | | | | Chem. Int. |
| | | | | | | | | | Ed. 2016, |
| | | | | | | | | | 128, |
| | | | | | | | | | 10424- |
| | | | | | | | | | 10428 |

Physisorbents - Covalent Organic Frameworks (COFs)

| | | | | | | | | | |
|---|---|---|---|---|---|---|---|---|---|
| [HO₂C]_{100%}-H₂P- | 364 | 14 | 4.0 ^{k)} | 1.0 | 43.5 | 77 | Not studied | N.A. | Angew. |
| COF | | | | | | | | | Chem. Int. |
| | | | | | | | | | Ed. 2015, |
| | | | | | | | | | 127, 3029- |
| | | | | | | | | | 3033 |
| ATFG-COF | 520 | 6, 13 | 0.89 | 0.84 | ≈50 | 65 | Not studied | N.A. | Chem. |
| | | | | | | | | | Mater. |
| | | | | | | | | | 2015, 27, |
| | | | | | | | | | 7874-7881 |
| JUC-505 | 1584 | 16.8 | 4.3 | 3.9 | N.A. | 65.6 ^{l)} | Not studied | N.A. | Nat. Chem. |
| | | | | | | | | | 2019, 11, |
| | | | | | | | | | 587-594 |

Physisorbents - Zeolites

| | | | | | | | | | |
|---|---|---|---|---|---|---|---|---|---|
| Zeolite 13X | 570 | 10 | 2.7 | 3.1 | 54 | 146 | Yes ^{j)} | 0.01 (0.18%; | Energy |
| | | | | | | | | 74%) at 294 | Environ. |
| | | | | | | | | K | Sci. 2011, |
| | | | | | | | | | 4, 3030- |
| | | | | | | | | | 3040; and |
| | | | | | | | | | Adsorption |
| | | | | | | | | | 2020, 26, |
| | | | | | | | | | 765-779 |
| Fe-MOR(0.25) | 282 | 5.3 | 3.2 | 7.4 | 11 | 10¹³² | Yes ^{e)} | N.A. (N.A.; | Science |
| | | | | | | | | 73%) at 298 | 2021, 373, |
| | | | | | | | | K | 315-320 |
| SGU-29 | N.A. | 4.5 × 7.3 | 3.5 | 6.9 | 51.3 | 3515 ⁱ⁾ | Yes ^{e)} | 2.6 (98%; | Science |
| | | | | | | | | 90%) at 298 | 2015, 350, |
| | | | | | | | | K | 302-306 |

Chemisorbents

| | | | | | | | | | |
|---|---|---|---|---|---|---|---|---|---|
| MOF-74-Mg- | 1012 | N.A. | 5.2 | 6.1 | 118 | N.A. | Yes ^{d)} | 4.8 (98%; | Chem. Sci. |
| (N₂H₄)_{1.8} | | | | | | | | 82%) at 313 | 2016, 7, |
| | | | | | | | | K | 6528-6533 |
| Co₂Cl₂(bbta)(OH) | 1286 | ≈11 | 4.0 | 5.4 | 110 | 262 | Yes ^{d)} | 2.5(≈100%; | Energy |
| | | | | | | | | 82%) at 313 | Environ. |
| | | | | | | | | K | Sci. 2015, |
| | | | | | | | | | 8, 1011- |
| | | | | | | | | | 1016 |
| mmem- | 675 | N.A. | 3.5 | 3.8 | 70 | N.A. | Yes ^{e)} | 2.7 (N.A.; | Nature |
| Mg₂(dobpdc) | | | | | | | | N.A.) at 313 | 2015, 519, |
| | | | | | | | | K | 303-308 |
| mmen-CuBTTri | 870 | N.A. | 2.4 | 2.5 | 96 | 327 ^{m)} | Not studied | N.A. | Chem. Sci. |
| | | | | | | | | | 2011, 2, |
| | | | | | | | | | 2022-2028 |
| Mg₂(dobpdc)(3- | N.A. | N.A. | 3.5 ⁿ⁾ | N.A. | 99 | N.A. | Yes ^{d)} | 2.0 (N.A.; | Science |
| 4-3) | | | | | | | | N.A.) at 373 | 2020, 369, |
| | | | | | | | | K | 392-396 |
| (PEI-25-APTES- | <319 | <316 | 3.1 ^{o)} | N.A. | 56 | N.A. | Yes ^{p)} | 2.4 (86%; | Energ. Fuel |
| 25)-PQCS2129 | | | | | | | | N.A.) at 333 | 2012, 26, |
| | | | | | | | | K | 2483-2496 |

^{a)} Unless otherwise stated, the uptake was measured at 298 K and 0.15 bar.
^{b)} Calculated based on the gravimetric uptakes on the left and crystallographic density of the sorbents.
^{c)} Determined by IAST theory for a 15/85 CO₂/N₂ mixture at 298 K and 1 bar.
^{d)} Wet gas breakthrough after column pre-saturation.
^{e)} Wet gas breakthrough without column pre-saturation.
^{f)} CO₂ uptake at 303 K and 0.15 bar.
^{g)} CO₂ uptake at 293 K and 0.1 bar.
^{h)} The IAST selectivity is derived based on a flue gas composition of 15% CO₂ and 85% N₂ at a total pressure of 1 bar at 293 K.
ⁱ⁾ The IAST selectivity is derived based on a flue gas composition of 10% CO₂ and 90% N₂ at a total pressure of 1 bar at 298 K
^{j)} Wet gas breakthrough experiment without column pre-saturation but CO₂ being replaced by H2O was observed.
^{k)} The uptake was measured at 273 K and 1 bar.
^{l)} The selectivity was estimated by the ratio of the Henry's constants of CO₂ and N₂ at 295 K.
^{m)} The IAST selectivity is derived based on a flue gas composition of 15% CO2, 75% N2 and 10% other gases, at a total pressure of 1 bar at 298 K
ⁿ⁾ CO₂ uptake at 373 K and 0.1 bar
^{o)} CO₂ uptake at 313 K and 0.1 bar
^{p)} Wet gas breakthrough without column pre-saturation but CO₂ concentration level reached the baseline level at the end of breakthrough experiment.

TABLE 6
Data obtained from breakthrough experiments of the columns packed
with ALF using dry 15/85 CO₂/N₂ mixed gas at 50° C. (323K).

| Cycles | 1 | 2 | 3 | 4 |
|---|---|---|---|---|
| CO₂ Corrected Mean Residence | 959 | 1011 | 1036 | 977 |
| Time/s | | | | |
| N₂ Corrected Mean Residence | 21 | 13.2 | 27 | 22 |
| Time/s | | | | |
| CO₂ qₑ/C₀ | 178.8 | 188.5 | 189.1 | 185.8 |
| N₂ qₑ/C₀ | 3.6 | 2.1 | 4.6 | 3.8 |
| CO₂/N₂ Selectivity | 50 | 89 | 41 | 48 |
| CO₂ specific capacity/ | 0.79 | 0.81 | 0.81 | 0.80 |
| mmol g⁻¹ | | | | |
| N₂ specific capacity/mmol g⁻¹ | 0.089 | 0.052 | 0.11 | 0.094 |

TABLE 7
Data obtained from breakthrough experiments of the columns packed
with ALF using wet 15/85 CO₂/N₂ mixed gas at 50° C. (323K).

| Cycles | 1 | 2 | 3 |
|---|---|---|---|
| CO₂ Corrected Mean Residence Time/s | 737 | 807 | 745 |
| CO₂ qₑ/C₀ | 125.4 | 137.4 | 126.8 |
| CO₂ specific capacity/mmol g⁻¹ | 0.57 | 0.62 | 0.57 |

TABLE 8
Data obtained from breakthrough experiments of the
columns packed with MOF-74-Ni and UiO-66-(OH)₂ using wet 15/85
CO₂/N₂ mixed gas at 50° C. (323K).

| | CO₂ Corrected Mean | CO₂ qₑ/ | CO₂ specific capacity/ |
|---|---|---|---|
| Cycles | Residence Time/s | C₀ | mmol g⁻¹ |
| MOF-74-Ni | 84.7 | 50.9 | 0.062 |
| UiO-66-(OH)₂ | 93.5 | 56.3 | 0.10 |

To probe why ALF adsorbs CO₂ so effectively, DFT calculations were performed to map the energy landscapes of both CO₂ and N₂ inside the two cavities (SCs and LCs) of ALF (FIG. 5c-d, N. Nijem et al., J. Am. Chem. Soc. 2012, 134, 15201-15204). The DFT adsorption energies of CO₂, N₂, and H₂O were computed within the generalized gradient approximation, where the exchange-correlation functional was approximated as proposed by Perdew-Burke-Ernzerhof (J. P. Perdew, K. Burke & M. Ernzerhof, Phys. Rev. Lett. 1996, 77, 3865). Van der Waals forces were accounted for with the DFT-D3 correction scheme proposed by Grimme et al. (S. Ehrlich et al., Chem. Phys. Chem. 2011, 12, 3414-3420).

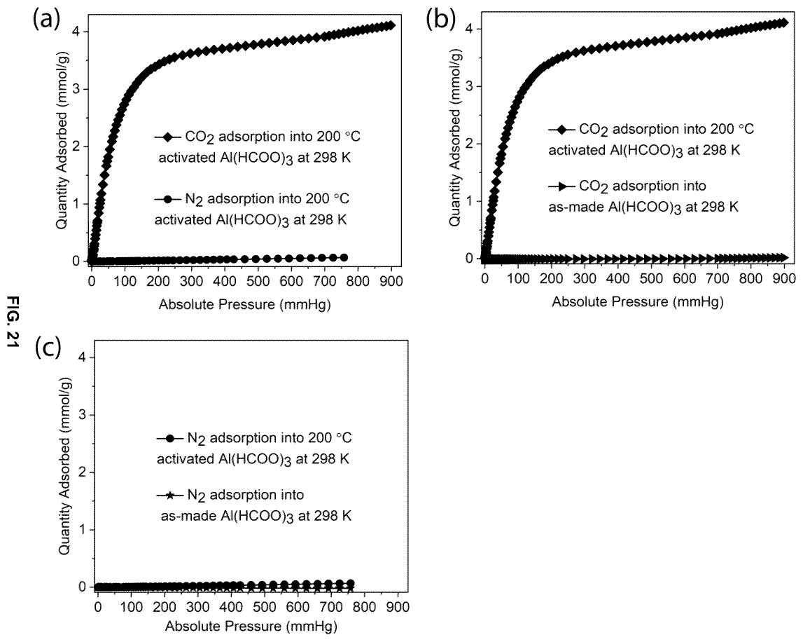

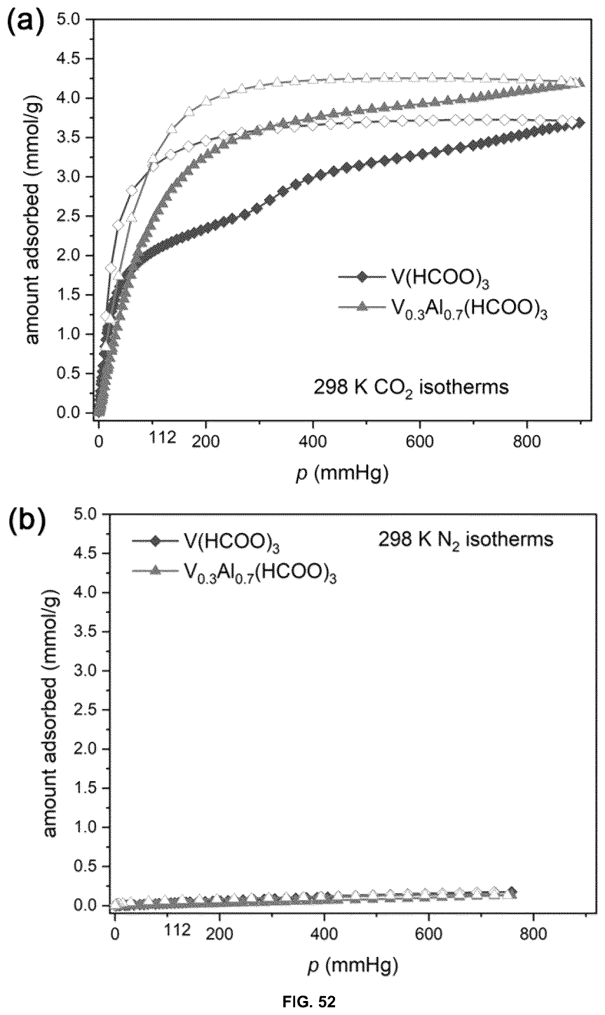

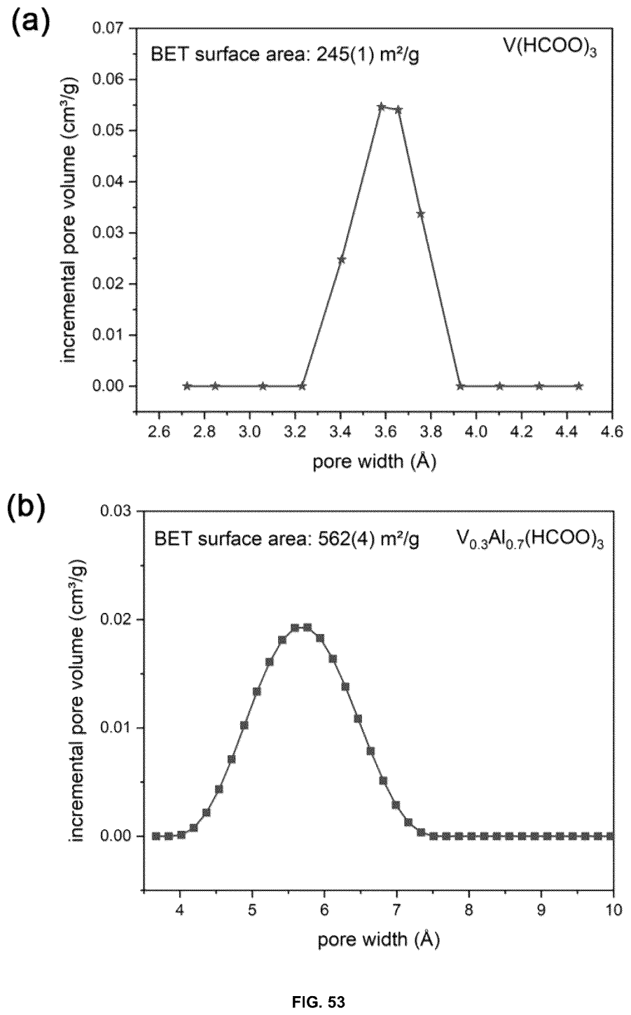

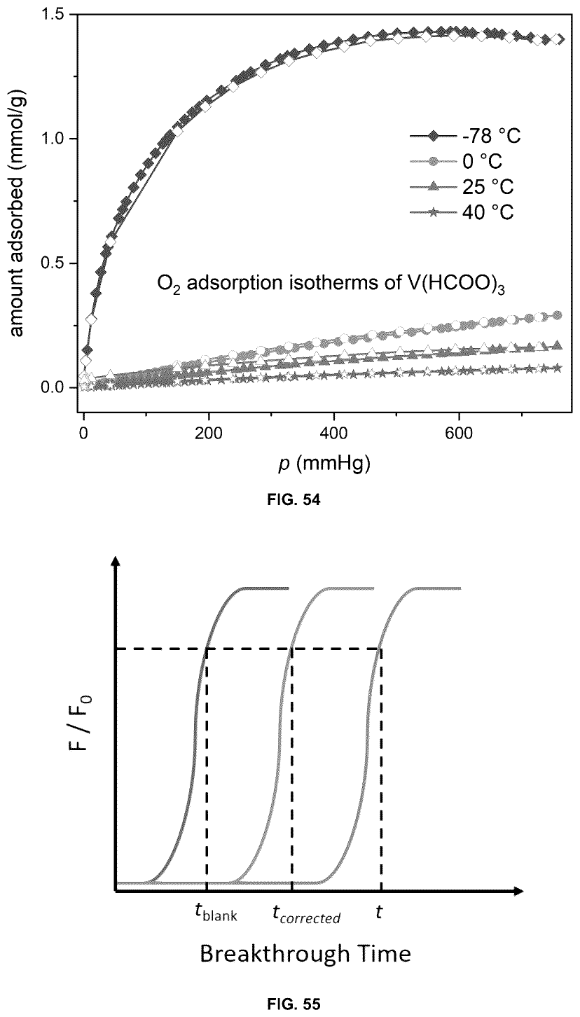

ALF showed excellent adsorption of CO₂ at room temperature, giving a loading of ˜4 mmol/g (˜5.7 mmol/cm³) at 1 atm, but virtually no adsorption of nitrogen (FIG. 21a). The capacity can be fine-tuned by doping the Al(COOH)₃ with other trivalent metal ions such as Fe, V, i.e., Al₁₋ₓFeₓ(HCOO)₃V₁₋ₓAlₓ(HCOO)₃. The remarkable selectivity is a consequence of the smaller diameter of CO₂ compared with N₂ and provides the basis for the separation of CO₂ from flue gas, as described below. For comparison, FIGS. 21b and 52 show that there was no adsorption of CO₂ into the as-made Al(HCOO)₃; nor was there any adsorption of N₂ into the as-made Al(HCOO)₃ (FIG. 21c).

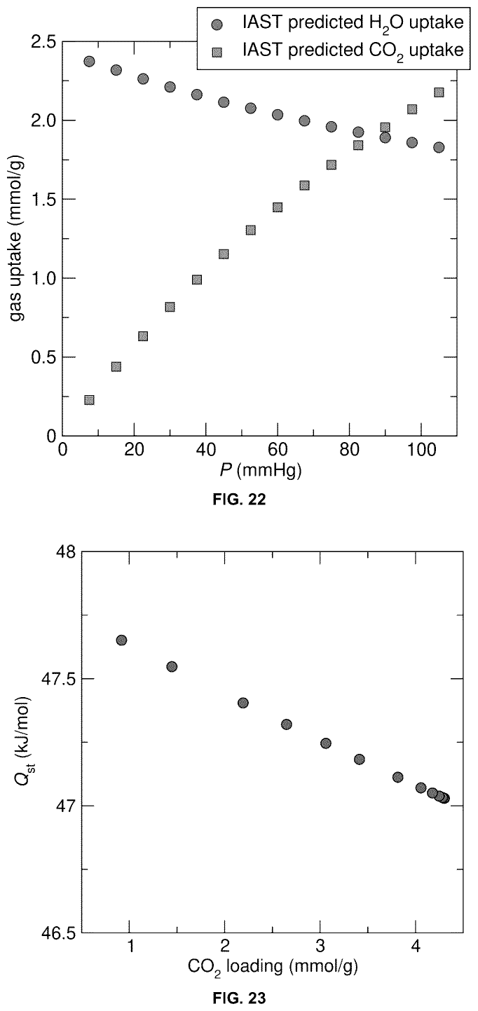

From the adsorption energies of CO₂ and N₂ in ALF presented in Table 9, two main conclusions were drawn: i) the adsorption energy was greater for CO₂ than N₂ in both cavities, and ii) CO₂ preferentially adsorbed in the SC of ALF, whereas N₂ showed no preference for either cavity. These results are further emphasized in FIGS. 5c and 5d which show that in the SCs, CO₂ preferred to orient along the c-axis toward the inward-pointing hydrogens, whereas the energy landscape was flat in the LC with a slight preference for the center of the cavity. For N₂, the energy landscape was flat for both the SC and LC, with a slight preference to the center of the cavity. DFT calculations (Table 9) also showed that H₂O (˜51.3 kJ/mol) adsorption was slightly more favorable than CO₂ (˜48.4 kJ/mol) in the SC, whereas the CO₂ adsorption was strongly preferred in the LC. The similarity in adsorption energies of CO₂ and H₂O implies less adverse competition for binding sites between CO₂ and H₂O, compared to other hydrophilic materials (˜60 kJ/mol<ΔH<−100 kJ/mol) where H₂O binding energies/enthalpies are substantially higher. This is initially suggested by the substantial retention of dynamic capacity in the wet gas breakthrough experiments and modelled mixture adsorption profiles (FIG. 22).

TABLE 9
Adsorption energies from first-principles calculations (in kJ/mol)
and experimental isosteric enthalpy of adsorption. The isosteric
enthalpy of adsorption is measured at low molecular loadings (≈1
mmol/g) from the CO₂ gas adsorption isotherms (FIG. 23), and
is in good agreement with the DFT results for the SC.

| | SC | LC | Isosteric enthalpy of |
|---|---|---|---|
| Molecule | (kJ/mol) | (kJ/mol) | adsorption (kJ/mol) |
| CO₂ | −48.4 | −36.2 | −47.7 |
| N₂ | −28.4 | −28.6 | — |
| H₂O | −51.3 | −28.8 | — |

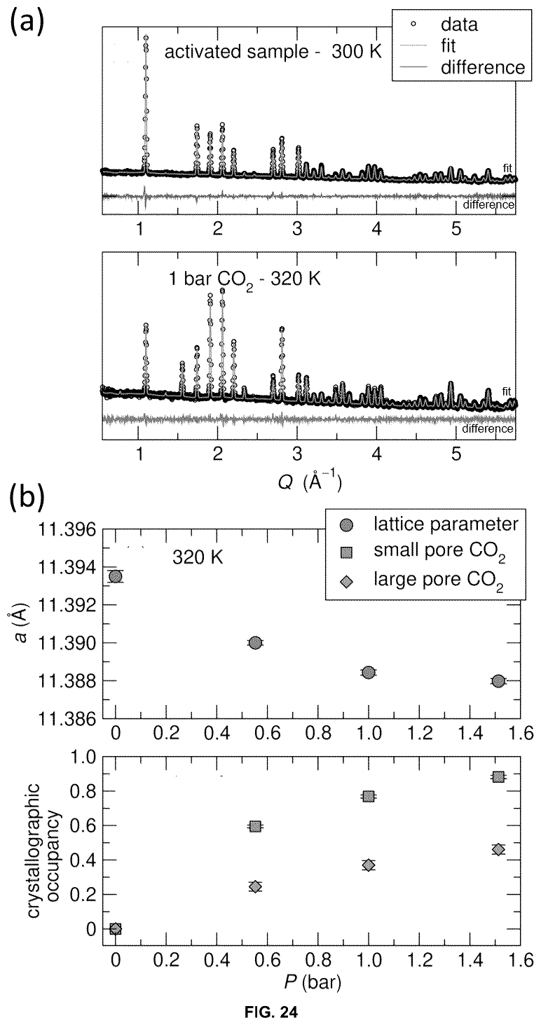

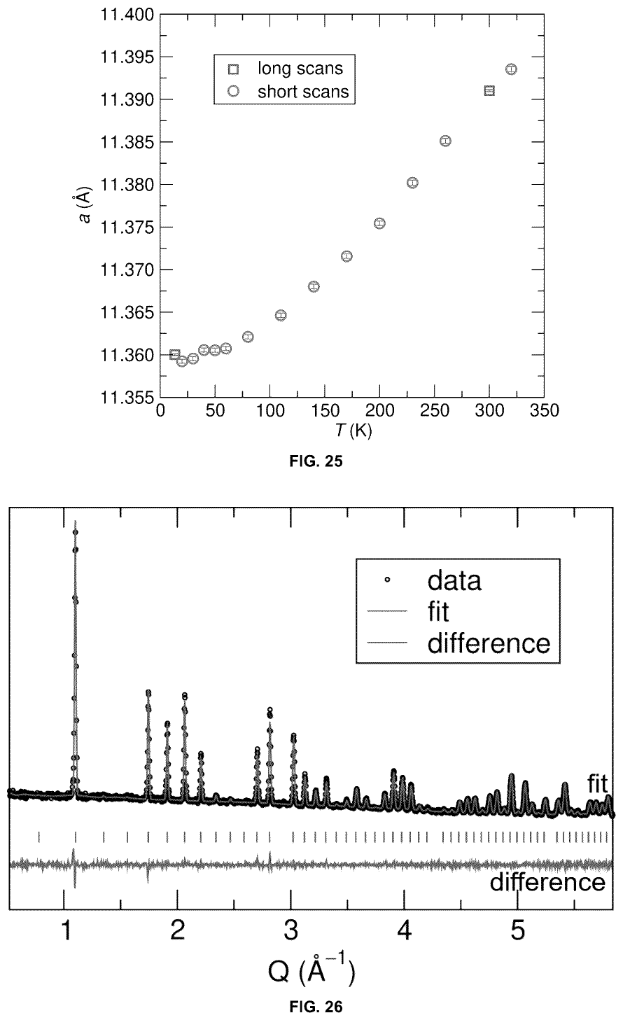

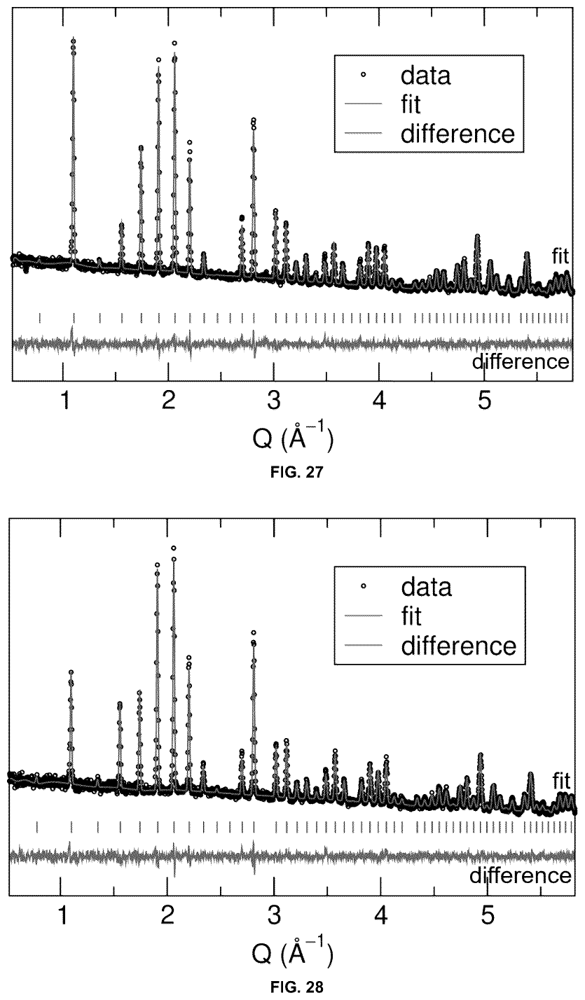

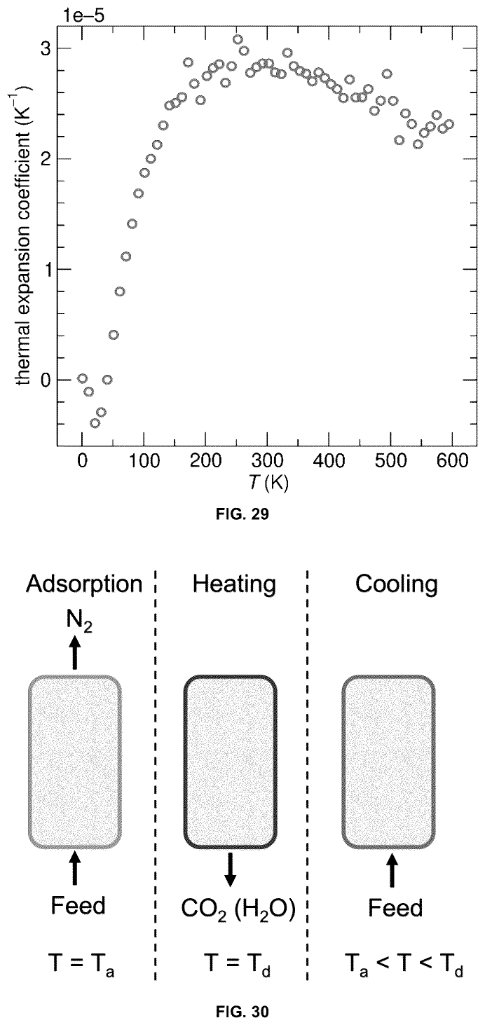

FIG. 24a illustrates the Rietveld refinement fits of ALF with and without CO₂. Non-deuterated samples of ALF were used for all NPD experiments, which led to a sloping background because of the incoherent scattering of hydrogen. As seen in FIG. 25, with increasing temperature, the unit cell of ALF increased monotonically between 60 K and 320 K with a near-constant unit cell value between 15 K and 60 K. As ALF has an ReO₃-type structure (H. A. Evans et al., Nat. Rev. Mater. 2020, 5, 196-213), it would reasonably be expected to observe negative thermal expansion. However, only approximate zero thermal expansion (ZTE) was seen below 50 K. The volumetric thermal expansion coefficient for ALF between 60 K and 300 K was =33×10⁻⁶ K⁻¹ (FIG. 29).

FIG. 24a-b show selected results from NPD experiments on CO₂ adsorbed into ALF performed at 320 K with various partial pressures of CO₂. This temperature was chosen based on the isotherms of pure CO₂ (FIG. 18), which indicated that, relative to 300 K, CO₂ adsorption at 320 K had improved kinetics. It can be seen from the top panel of FIG. 24b that when ALF was exposed to increasing pressures of CO₂, the lattice parameter of ALF gradually contracted. We note that the increased CO₂ adsorption seen between 273 K and 323 K (FIG. 11a) is likely due to the expansion of the ALF unit cell over this temperature range, as well as the increased dynamics of the formate groups.

The bottom panel of FIG. 24b shows the increasing crystallographic occupancies of CO₂ in both the SCs and LCs as the pressure increases. It was noted that the occupancy of CO₂ in the SCs was consistently higher than that in the LCs (FIG. 24b), which was consistent with the adsorption energies from DFT (Table 9). At the highest CO₂ loading in FIG. 24b, the occupancy of the SC was =90%, whereas that of the LC was =50%, giving an approximate overall composition of Al(HCOO)₃ (CO₂)_{0.78} (recalling that there are three times as many SCs than LCs). This occupancy corresponds to a CO₂ loading of =4.8 mmol/g. The CO₂ loading into ALF under these conditions is slightly increased when compared with the initial level of CO₂ present in the as-made Al(HCOO)₃ as the latter only accommodated CO₂ in the SCs (Y.-Q. Tian et al., Inorg. Chem. 2007, 46, 1612-1616).

### Example 4. Comparison Between the SCs Hand-In-Glove Hydrogen Bonding Association with CO₂

Equilibrium-Based Process Modelling for ALF and Comparison with Literature-Reported Sorbents

The essential principle behind adsorption separation is to exploit the difference in interactions of various components of the gas mixture with the porous media. A typical process will involve an adsorption phase where the feed gas is contacted with the porous media and CO₂ is preferentially sequestered, as well as a desorption phase at a different condition permitting the release of the trapped CO₂ from the sorbent. In general, regeneration is affected by decreasing the pressure (accordingly, pressure- or vacuum-swing adsorption, P/VSA) or increasing the temperature (accordingly, TSA).

The water affinity in ALF and a variety of other reported sorbents implies an uptake of water similar, if not exceeding, CO₂; hence, water is recovered alongside CO₂ as a heavy component. It is preferable to operate with part, if not all, of the cycle at an elevated temperature so as to circumvent the use of high vacuum (PL<<0.1 bar) for the sorbent regeneration. Since the saturation pressure of water is ˜ 7 kPa at 313 K, it is impossible to extract water as a pure stream from the sorbent by applying vacuum higher than this level.

In light of the above consideration, we applied an equilibrium-based model of a TSA cycle with the purpose of estimating the process-level performance of ALF relative to other benchmark adsorbents. The model was described by Ajenifuja et al. (A. Ajenifuja, L. Joss & M. Jobson, Ind. Eng. Chem. Res. 2020, 59, 3485-3497) and covers a basic three-step process with adsorption, heating, and cooling steps (FIG. 30), with the following simplifying assumptions:
1. The bed is well-mixed during the heating and cooling steps;
2. During the adsorption step, a discontinuous profile separating the initial concentration from the feed concentration propagates through the bed until breakthrough;
3. The pressure drop in the bed is negligible;
4. The adsorbed and gas phases are in thermal and chemical equilibrium;
5. Heat-transfer resistances are negligible;
6. The specific heat capacity of the gas phase is negligible; and
7. The gas phase is accurately described by the ideal gas law.

The CO₂ capture performance was analyzed based on 4 performance indicators of the adsorbents, namely, product purity, product recovery, cyclic working capacity, and specific thermal energy requirement.

The CO₂ purity is defined as

$$Product purity = \frac{{N}_{CO 2 , recovered}}{{N}_{CO 2 , recovered} + {N}_{N 2 , recovered}} \qquad Equation 20$$

Where N_{CO2/N2,recovered} is the molar amount of CO₂ or N₂ recovered in the heating step.

The recovery is defined as

$$Recovery = \frac{{N}_{CO 2 , recovered}}{{y}_{CO 2 , feed} {N}_{feed}} \qquad Equation 21$$

Where y_{CO2,feed} is the CO₂ composition in the feed, and N_{feed} is the total molar amount of gases fed into the bed.

The cyclic working capacity, WC, is the molar amount of CO₂ recovered per unit mass of the adsorbent

$$W C = \frac{{N}_{CO 2 , recovered}}{m} \qquad Equation 22$$

The specific thermal energy requirement, SPₜₕₑᵣₘₐₗ, is the amount of heat required during the heating step per unit production of CO₂

$${sp}_{thermal} = \frac{{Q}^{heat}}{{N}_{CO 2 , recovered} \cdot {Mw}_{CO 2}} \qquad Equation 23$$

Where Q^{heat} is the total amount of energy input required by the heating step and Mw_{CO2} is the molecular weight of CO₂.

### FT-IR Spectroscopy

FT-IR spectra were obtained using an Agilent Technologies Cary 600 series FTIR spectrometer operating at ambient temperature. KBr was used as the window material for all the measurements. For the CO₂ reloaded experiments, CO₂ gas was passed into activated ALF (0.5 g) for 2 h at ambient conditions and the FT-IR spectra was measured by pressing it into a transparent thin pellet with KBr. For the water stability tests, 0.5 g of activated ALF was soaked in distilled water (7 mL) at room temperature for 12 h. The vacuum filtered air-dried ALF was directly taken for FT-IR analysis.

### Results and Discussion

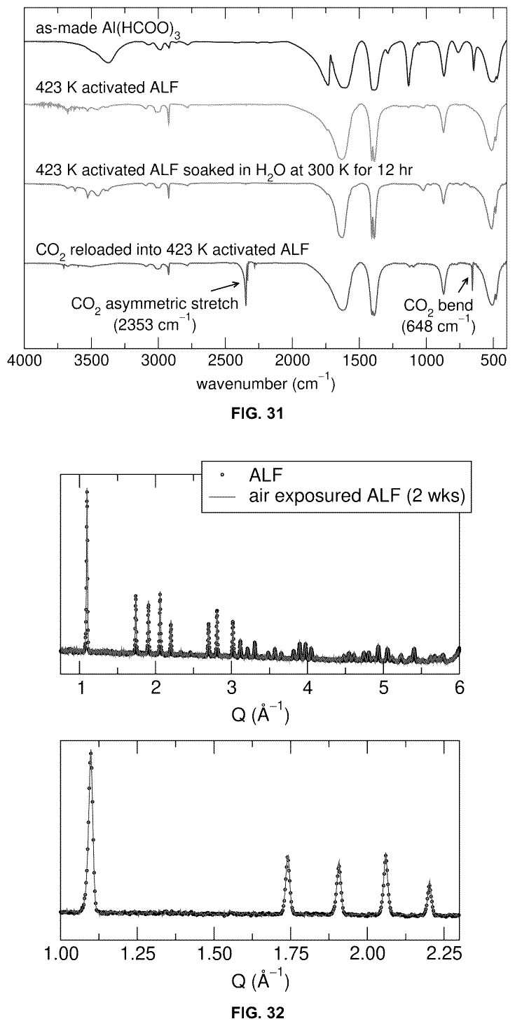

The comparison between the SCs hand-in-glove hydrogen bonding association with CO₂ relative to the LCs is shown in FIG. 5e-f. In our model, CO₂ moved through the LC/SC channel more efficiently because of the larger window size along the LC/SC channel. Thus, the distinctive feature of ALF is that these windows appeared to be just large enough to permit the facile adsorption of CO₂ but not large enough to permit the adsorption of N₂, noting that the kinetic diameter of CO₂ (≈3.3 Å) is slightly smaller than that of N₂ (≈3.64 Å) (A. F. Ismail, K. Khulbe & T. Matsuura, Gas Separation Membranes: Polymeric and Inorganic, Springer, 2015 ISBN 3319010956.). This subtle size difference enabled ALF to achieve the observed kinetic separation of CO₂ and N₂. It is also important to note that although ALF has a favourable HOA for H₂O (FIG. 24b), in practice, it is not as hydrophilic as UiO-66-(OH)₂ and MOF-74-Ni (FIG. 11c). Even soaking of ALF in water did not present any diffraction (FIG. 3) or spectroscopic evidence (FIG. 31) for H₂O being inside the material at 12 h of exposure. As can be seen from the different FT-IR spectra (FIG. 31), upon activation, there was a loss of the —OH signal near ≈3400 cm⁻¹ due to the loss of H₂O. Upon reloading ALF with CO₂, the asymmetric stretch of CO₂ near=2350 cm⁻¹ appeared. The inventors believe that the emergence of the asymmetric CO₂ stretch is due to the quenching of the asymmetric stretch by the hydrogen bonding in the SC, and only when CO₂ exists in the LC after CO₂ reloading does this stretch appear. This was also confirmed with a neutron experiment, where the material was exposed to air for over three weeks, with no observed increase to the incoherent background in the pattern (FIG. 32). These results indicate that water adsorption is kinetically inhibited, enabling ALF to adsorb CO₂ from a flue gas stream that is rich in both N₂ and water.

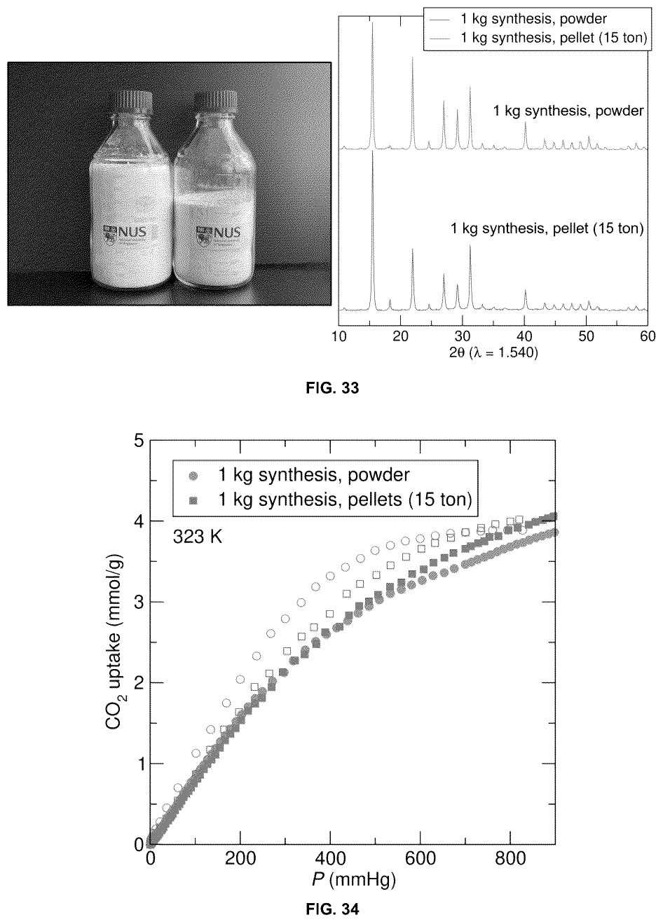

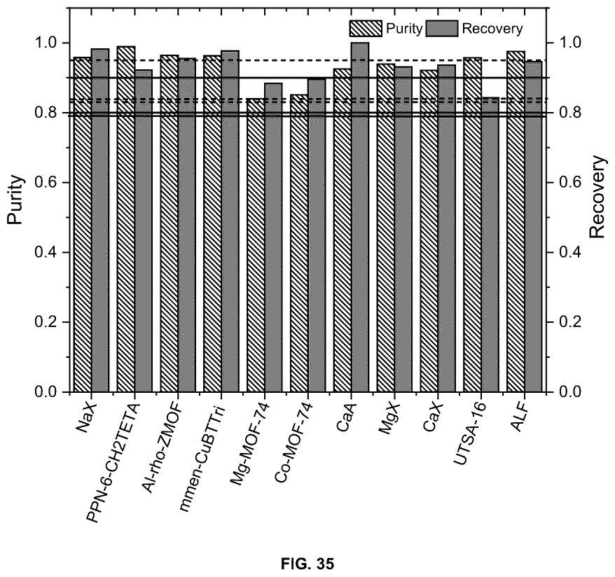

ALF has some other attractive features that set it apart from other MOF sorbents. Importantly, it is readily prepared on a kilogram scale in the laboratory (FIG. 33) with formic acid acting as both a reactant and a solvent, so no additional solvent is required. We estimated that the materials cost for obtaining ALF on the metric tonne scale from two commodity chemicals, aluminum hydroxide and formic acid, is only ˜ $1000 per tonne, making it substantially cheaper than any of the other MOF alternatives. We proposed that this cost reduction could enable the inclusion of a drying step in the flue gas treatment process costing as low as $2 per tonne CO₂ captured in certain embodiments (M. M. F. Hasan et al., Ind. Eng. Chem. Res. 2012, 51, 15665-15682). Furthermore, ALF has excellent mechanical properties (Table 10) that are superior to those of most MOFs (J. C. Tan & A. K. Cheetham, Chem. Soc. Rev. 2011, 40, 1059-1080), wherein it can be pelletized and even ball-milled while retaining performance (FIG. 34). ALF also benefits from good volumetric performance on account of its relatively high density (Table 5). Lastly, preliminary process modelling indicates that ALF meets the purity and recovery requirements set forth by the US Department of Energy when operated in a simple heat-regenerated cycle. The performance, again, is favourable compared to that of other leading MOF systems (Table 11; FIG. 35-37).

TABLE 10
Calculated polycrystalline Young's modulus (E, in GPa),
bulk modulus (B, in GPa), shear modulus (G, in GPa) and
Poisson's ratio (v) from DFT. Exp. is for experiment.

| Compound | Work | E | B | G | v |
|---|---|---|---|---|---|
| ALF | DFT, this work | 30.56 | 18.32 | 12.51 | 0.22 |
| Mg—MOF-74 | DFT (Chem. Sci. 2018, 9, | 8.97 | 10.05 | 3.32 | 0.35 |
| | 5197-5206) | | | | |
| MOF-5 | DFT (Phys. Rev. B. 2007, | 9.57 | 17.57 | 3.39 | 0.41 |
| | 76, 184106) | | | | |
| ZIF-8 | Exp. (Phys. Rev. Lett. | 3.15 | 7.75 | 1.10 | 0.43 |
| | 2012, 108, 095502) | | | | |
| HKUST-1 | DFT (J. Phys. Chem. Lett. | 7.23 | 24.53 | 2.49 | 0.45 |
| | 2013, 4, 925-930) | | | | |
| UiO-66 | DFT (J. Phys. Chem. Lett. | 42.38 | 41.02 | 15.96 | 0.33 |
| | 2013, 4, 925-930) | | | | |
| MIL-47 | DFT (Phys. Rev. Lett. | 25.31 | 20.18 | 9.80 | 0.29 |
| | 2012, 109, 195502) | | | | |

TABLE 11
Ranking by working capacity of “top sorbents” as identified
in Ajenifuja et al. (A. Ajenifuja, L. Joss & M. Jobson, Ind.
Eng. Chem. Res. 2020, 59, 3485-3497), filtered using a minimum
performance threshold of 83% purity and 80% recovery.

| | | | WC/mol | SP_TH/MJ | | |
|---|---|---|---|---|---|---|
| Ranking | Pur | Rec | CO₂ kg⁻¹ | kg⁻¹ CO₂ | Tₐ/K | T_{d}/K |
| CaA | 0.925 | 1.000 | 2.946 | 2.075 | 298 | 418 |
| Mg-MOF-74 | 0.840 | 0.884 | 2.777 | 1.762 | 298 | 418 |
| NaX | 0.958 | 0.982 | 2.749 | 2.057 | 298 | 418 |
| Co-MOF-74 | 0.851 | 0.895 | 2.352 | 2.136 | 298 | 418 |
| PPN-6- | 0.989 | 0.922 | 2.313 | 2.382 | 298 | 418 |
| CH2TETA | | | | | | |
| CaX | 0.921 | 0.936 | 2.238 | 2.139 | 298 | 418 |
| UTSA-16 | 0.957 | 0.843 | 2.204 | 2.232 | 298 | 418 |
| MgX | 0.939 | 0.931 | 2.153 | 2.241 | 298 | 418 |
| Al-rho-ZMOF | 0.964 | 0.955 | 1.891 | 2.566 | 298 | 418 |
| mmen-CuBTTri | 0.963 | 0.977 | 1.855 | 2.812 | 298 | 418 |

To validate the modelling procedure, we repeated the screening exercise in Ajenifuja et al. (A. Ajenifuja, L. Joss & M. Jobson, Ind. Eng. Chem. Res. 2020, 59, 3485-3497), using a feed of 12% CO₂ and 88% N₂ at operating pressure of 1 bar. The sorbents were screened for adsorption temperatures (Tₐ) ranging from 298 K to 358 K and desorption temperatures T_{d} ranging from 318 K to 418 K, corresponding to the use of cooling water and low-pressure steam for the cold and hot utilities. The isotherm parameters for sorbents other than ALF were adopted from Khurana and Farooq (K. Maninder & S. Farooq, Ind. Eng. Chem. Res. 2016, 55, 2447-2460). Due to the limited availability of specific heat capacity data for the pool of sorbents considered, this parameter was set at 1070 J kg⁻¹ K⁻¹. The application of a performance filter of 83% purity and 80% recovery perfectly reproduces the ranking by working capacity in the study of Ajenifuja and coworkers (A. Ajenifuja, L. Joss & M. Jobson, Ind. Eng. Chem. Res. 2020, 59, 3485-3497). It is worth noting that 83% purity and 80% recovery threshold falls short of the often quoted 95% purity, 90% recovery DOE targets (Compendium of Carbon Capture Technology, U.S. Dept. of Energy, 2020), which have been proposed on the basis of capture unit efficiency and downstream processing considerations. Therefore, we repeated the evaluation using 95% purity and 90% recovery targets alongside ALF material. Only ALF and four other materials were capable of meeting these more stringent targets using 3-step configuration (FIG. 35). The remainder demand harsher regeneration conditions and/or cycle complexity, for which the cost increase may be substantial. Within this reduced pool, PPN-6-CH2TETA and mmen-CuBTTri operate on chemisorptive mechanism, whereas NaX (also known as zeolite 13X), ALF, and the hypothetical Al-rho-ZMOF are physisorbents.

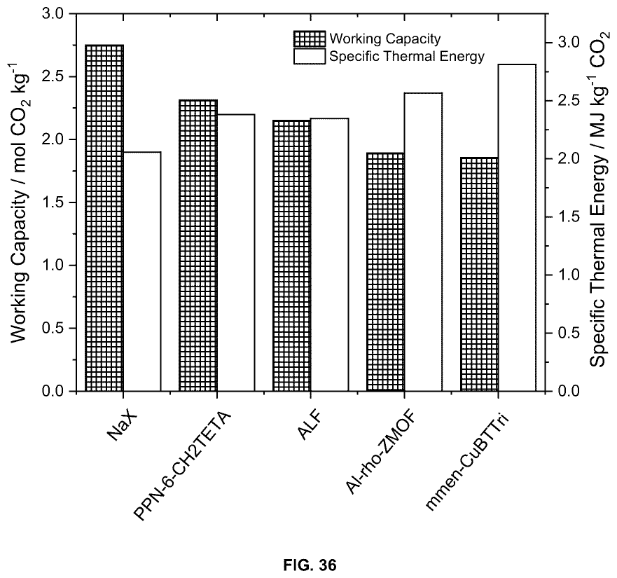

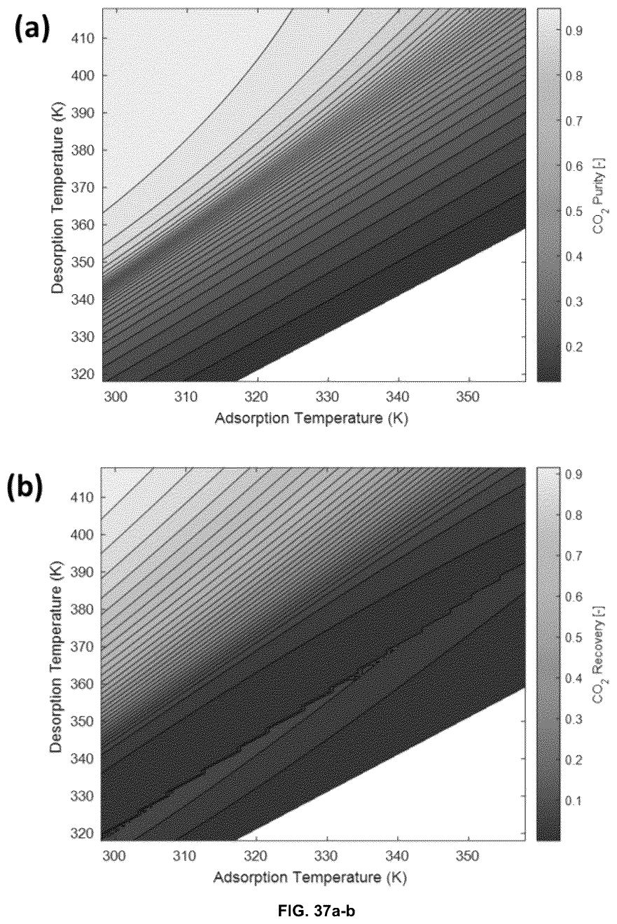

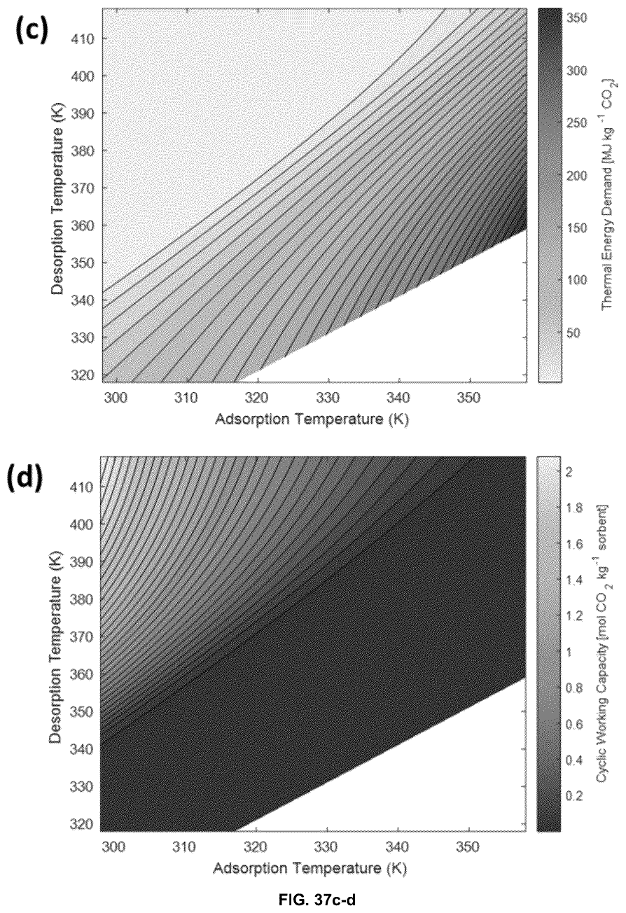

From FIG. 36, the efficiency metrics of ALF, both in terms of mass and energy, compared favorably with the considered sorbents. This is due in part to a relatively large temperature operating window under which a sizeable quantity of pure product may be recovered (FIG. 37a-b), deriving in turn from the exceptional selectivity and facile regenerability of this material. The low isosteric heat of ALF is conducive to reduce the energy consumption relative to typical chemisorbents. Further, the compositional, structural, and synthetic simplicity of ALF presents a clear manufacturing cost and scalability advantage compared with other synthetic sorbents. While the impact of H₂O sorption is challenging to estimate in the absence of more exhaustive thermodynamic and kinetic data collection, the clearly reduced hygroscopicity of ALF, in contrast to hygroscopic NaX, expands its scope of application in a multinary separation involving water in comparison to known physisorbents.

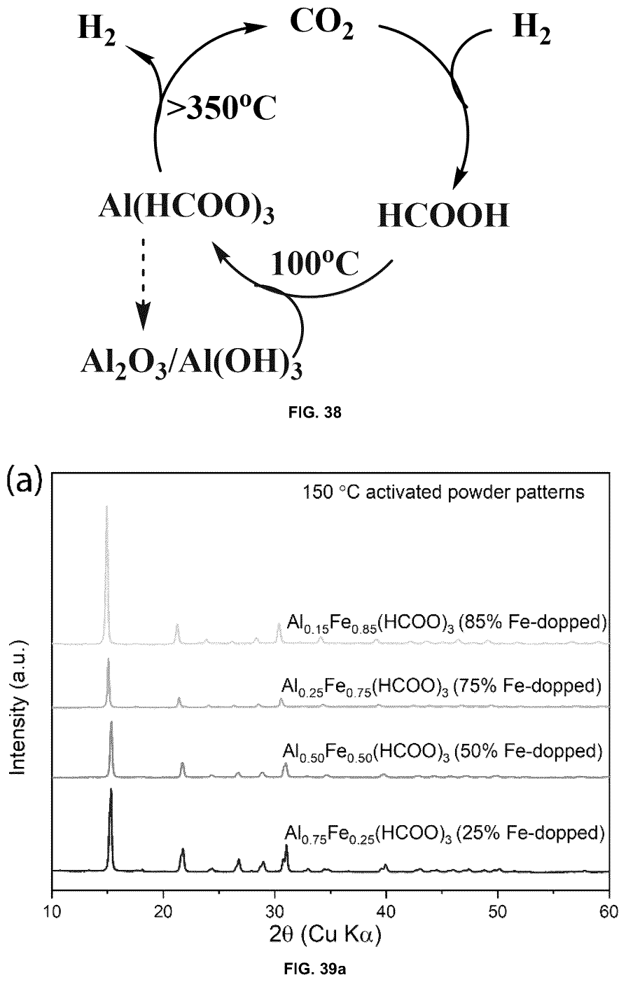

Taken together, the MOF, ALF, which can be synthesized from inexpensive and earth-abundant aluminum hydroxide and formic acid, has an excellent affinity for CO₂ compared with N₂. The origin of this remarkable behavior stems from the relative kinetic diameters of CO₂ (≈3.3 Å) and N₂ (≈3.64 Å). This minute difference of =0.34 Å is sufficient to permit CO₂ to adsorb into the pore structure while excluding the N₂. Furthermore, ALF is hydrophobic compared to most MOFs, so it is able to capture CO₂ from wet flue gas emissions under realistic operating conditions above room temperature. There is one other intriguing feature of this remarkable material, which is that ALF could offer a remarkably efficient vehicle for long-term CO₂ storage if the selective reduction of CO₂ to formic acid with solar hydrogen becomes more efficient (FIG. 38, D. Chen et al., J. Mater. Chem. A 2016, 4, 2657-2662). CO₂ could then be stored in the MOF framework itself, according to the overall reaction Al₂O₃+6 CO₂+3 H₂→2 Al(HCOO)₃. This reaction would yield a storage capacity for CO₂ of 81 wt % (not including additional CO₂ that could be stored in the channels).

### Example 5. Preparation of ALF Doped with Other Trivalent Cations

ALF samples that have been doped with other trivalent cations, such as Fe, Ga, In, V, Mn, Co, Ru, and Cr, i.e A₁₋ₓBₓ(COOH)₃ (A and B are two different trivalent metals of Fe/Al/Ga/In/Mn/Cr/Co/Ru) were obtained.

Reflux Synthesis and Activation of Al_{0.5}Fe_{0.5}(HCOO)₃(CO₂)_{0.75}(H₂O)_{0.25}(HCOOH)_{0.25} (as-Made Al_{0.5}Fe_{0.5}(HCOO)₃)

A mixture of aluminium hydroxide (3.0 g, 0.0384 mol), formic acid (150 mL), and [Fe^{III}₃(m-O)(HCOO)₇(H₂O)₂] (3.0 g, 0.00561 mol) were refluxed in a 250 mL two-necked round-bottomed flask at 100° C. for 48 h. After completion of the reaction, excess formic acid was extracted by centrifugation, and the pale-greenish white solid product was rinsed with a copious amount of ethanol and separated via vacuum filtration. The vacuum dried sample gave a yield of 95% of Al_{0.5}Fe_{0.5}(HCOO)₃(CO₂)_{0.75}(H₂O)_{0.25}(HCOOH)_{0.25} (as-made Al_{0.5}Fe_{0.5}(HCOO)₃). The air-dried Al_{0.5}Fe_{0.5}(HCOO)₃(CO₂)_{0.75}(H₂O)_{0.25}(HCOOH)_{0.25} (0.5 g, 0.00229 mol) was heated at 150° C. under high vacuum [1×10⁻⁴ mmHg] for 24 h, yielding 0.38 g of the guest-free Al_{0.5}Fe_{0.5}(HCOO)₃.

Reflux Synthesis and Activation of as-Made V_{0.3}Al_{0.7}(HCOO)₃(CO₂)_{0.75}(H₂O)_{0.25}(HCOOH)_{0.25}

A mixture of vanadium acetylacetonate (0.5 g, 0.00143 mol), formic acid (75 mL), and aluminium hydroxide (0.5 g, 0.0064 mol) were refluxed in a 100 mL two-necked round-bottomed flask at 100° C. for 48 h. After completion of the reaction excess formic acid was extracted using centrifugation. The pale-green solid product was rinsed with a copious amount of ethanol and separated using vacuum filtration. The vacuum dried sample gave a yield of 93% of V_{0.3}Al_{0.7}(HCOO)₃(CO₂)_{0.75}(H₂O)_{0.25}(HCOOH)_{0.25} (guest included/as-made V_{0.3}Al_{0.7}(HCOO)₃). The V:Al ratio in the MOF was confirmed by ICP-MS analysis. Analytical CHN data for as-made V_{0.3}Al_{0.7}(HCOO)₃ (M. Wt. 218.237 g/mol): calculated weight percentages C: 22.01%, H: 1.85% and observed C: 22.36%, H: 2.41%. As-made V_{0.3}Al_{0.7}(HCOO)₃(CO₂)_{0.75}(H₂O)_{0.25}(HCOOH)_{0.25} (0.5 g, 0.0023 mol) was heated at 120° C. under high vacuum [1×10⁻⁴ mmHg] for 24 h, yielding quantitative amounts of the guest-free V_{0.3}Al_{0.7}(HCOO)₃. Analytical CHN data for V_{0.3}Al_{0.7}C₃H₃O₆ (M. Wt. 169.221 g/mol): calculated. C: 21.29%, H: 1.79%, and observed C: 22.36%, H: 2.41%.

### Example 6. Characterization and Activity of ALF Doped with Other Trivalent Cations

The activity of doped ALF was evaluated by following the protocol in Example 3.

### Results and Discussion

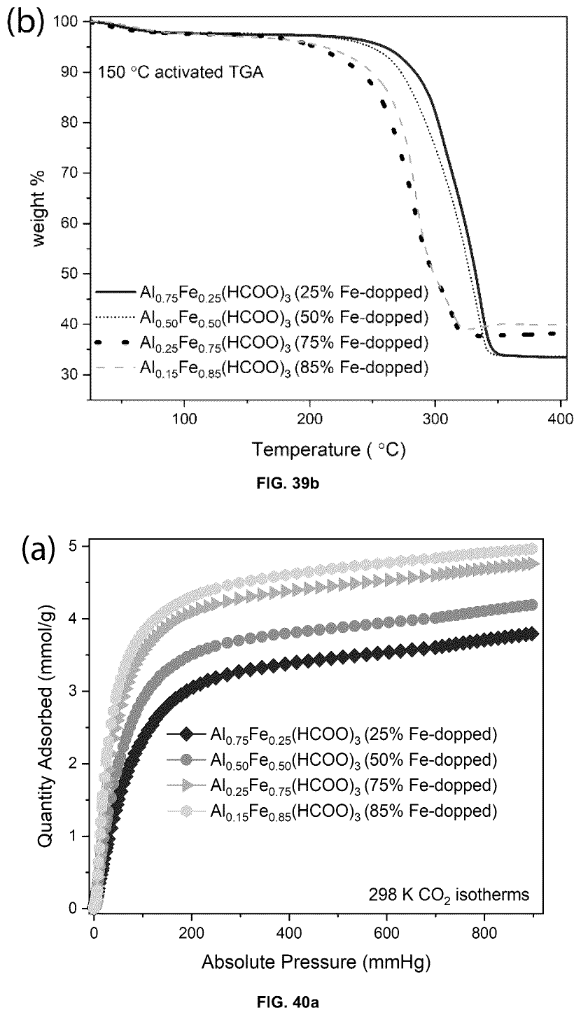

The level of metal atom doping and its relative atomic concentrations were confirmed with ICP-MS and SC-XRD analysis. PXRD patterns and crystal structures of Fe-doped and V-doped materials (Al₁₋ₓFeₓ(COOH)₃ and V₁₋ₓAlₓ(COOH)₃)) reveal that all the V and Fe-doped materials are isostructural with the ALF structure (FIG. 39a).

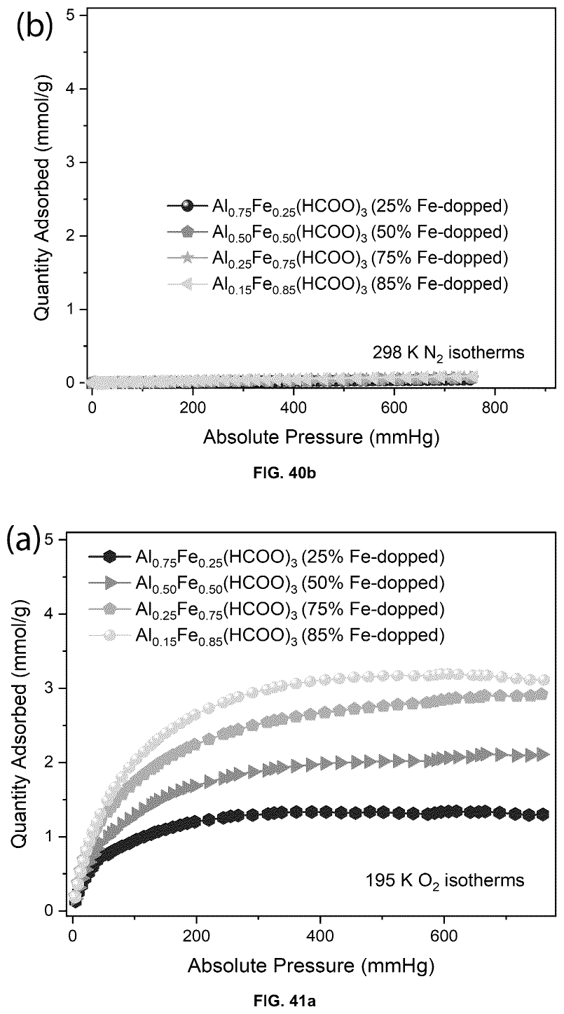

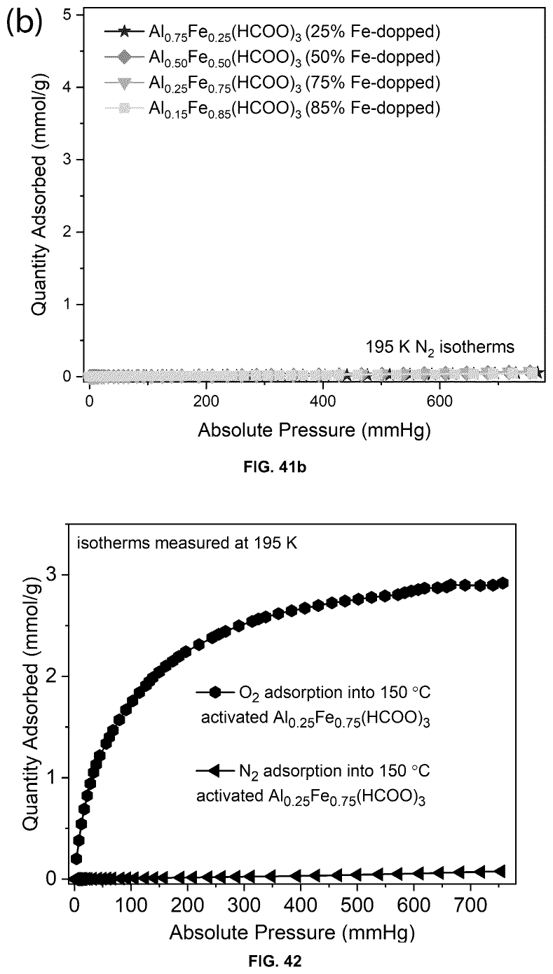

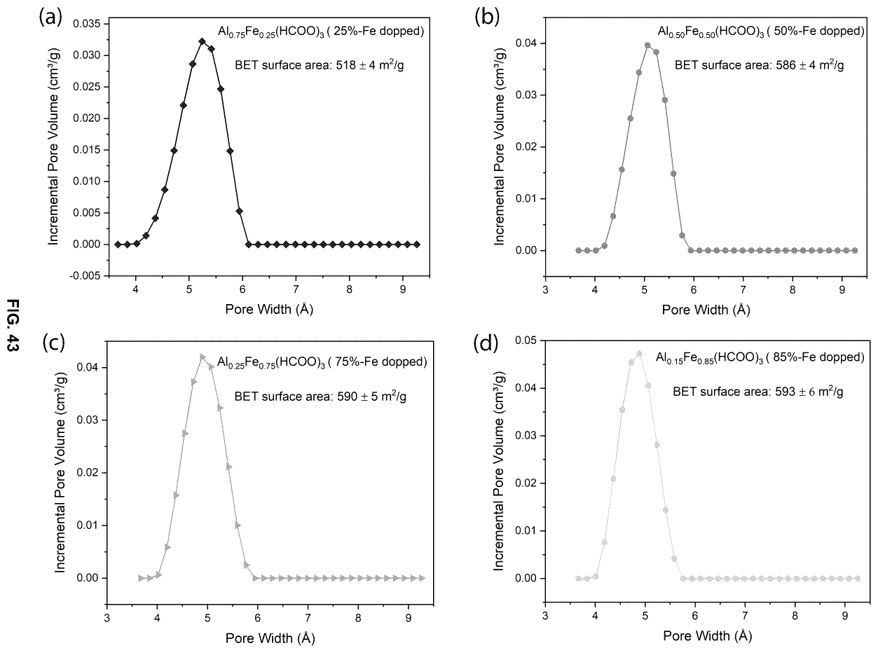

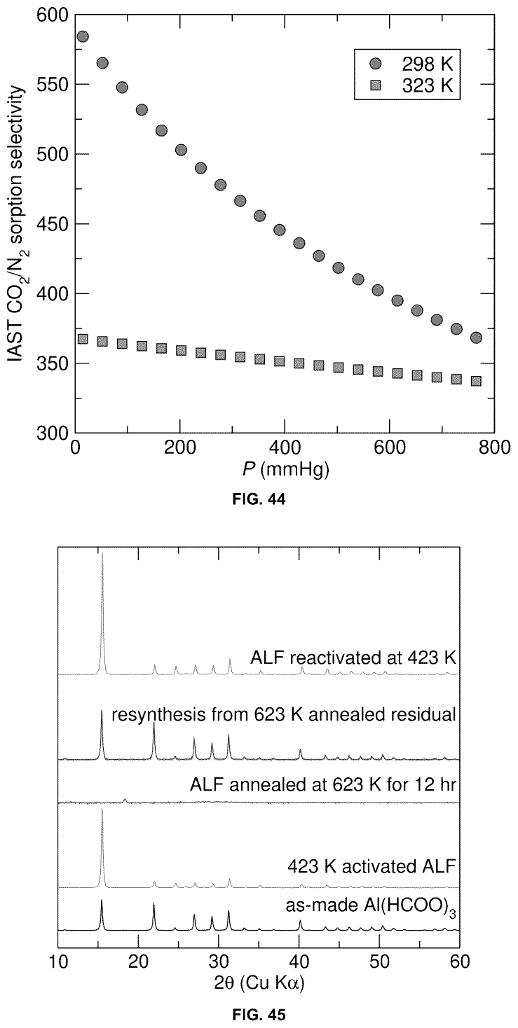

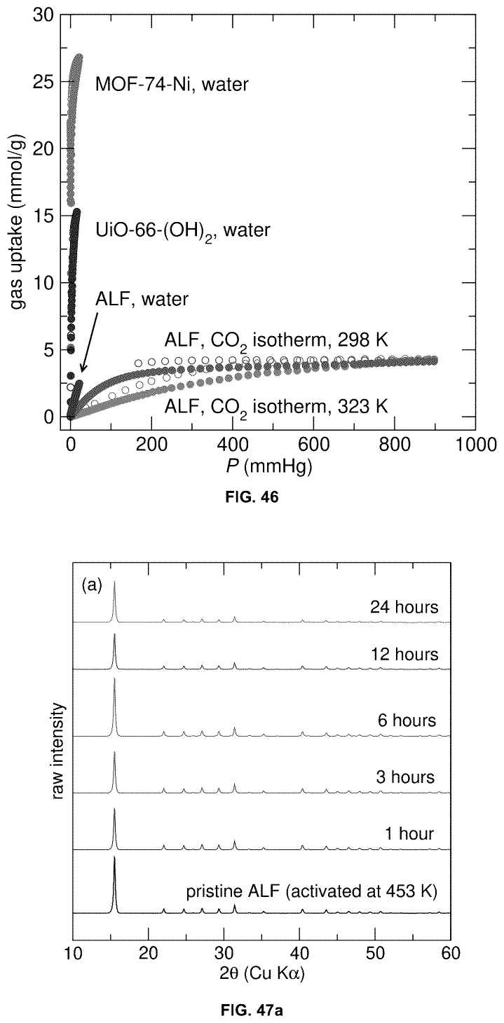

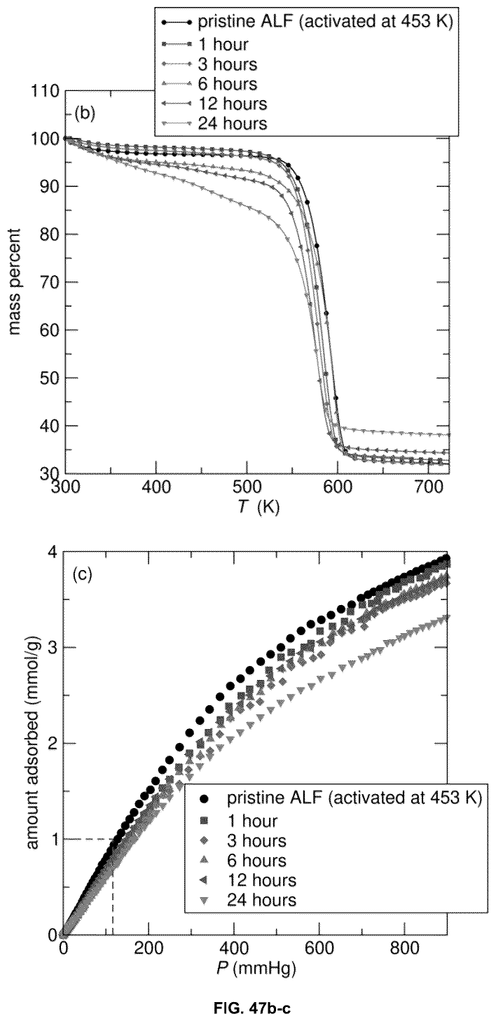

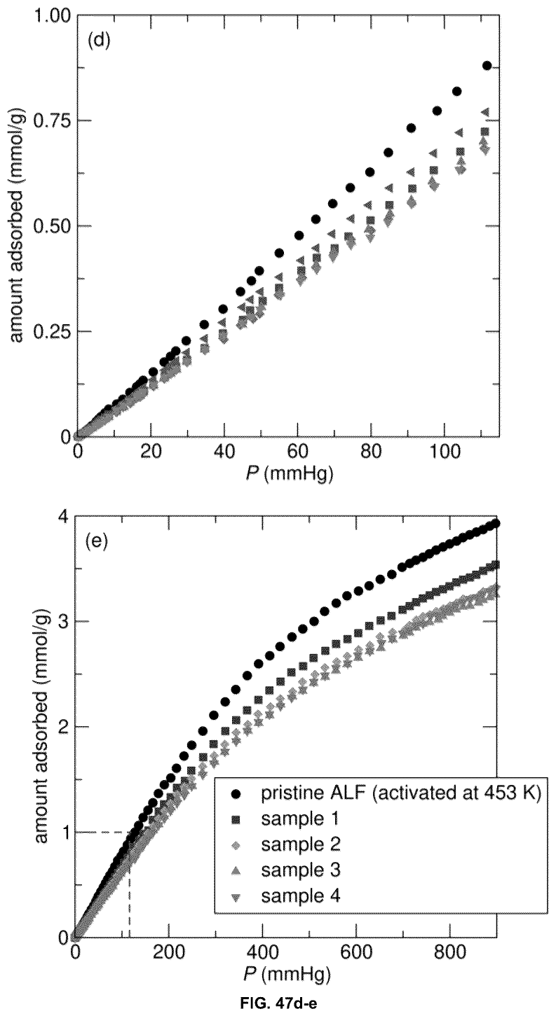

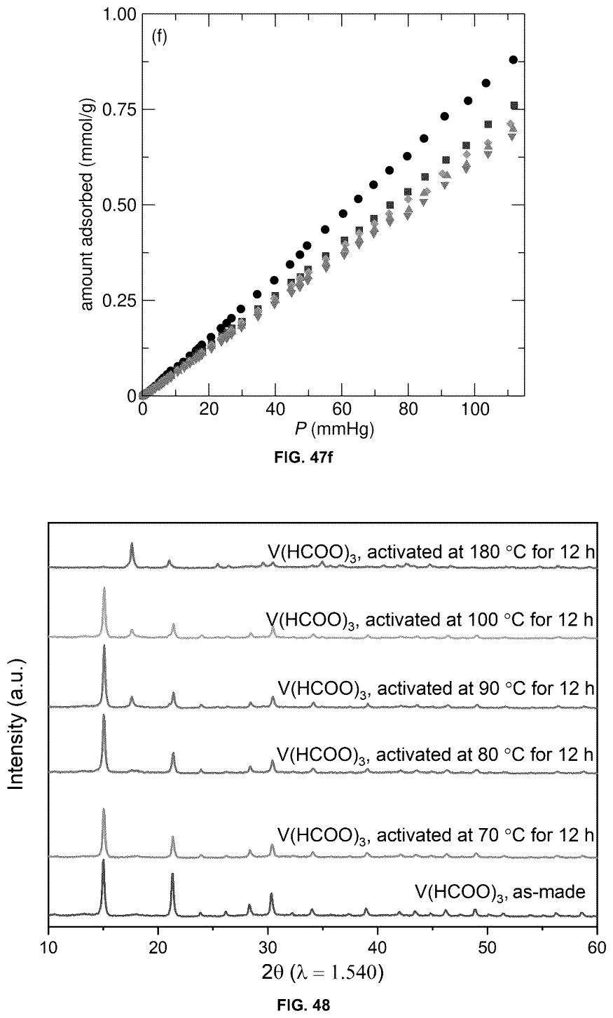

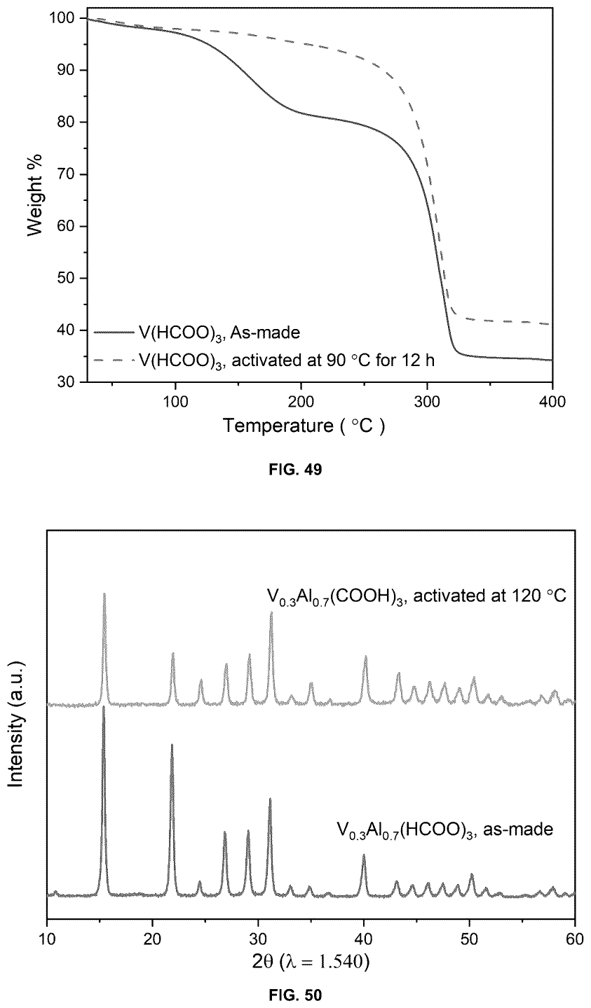

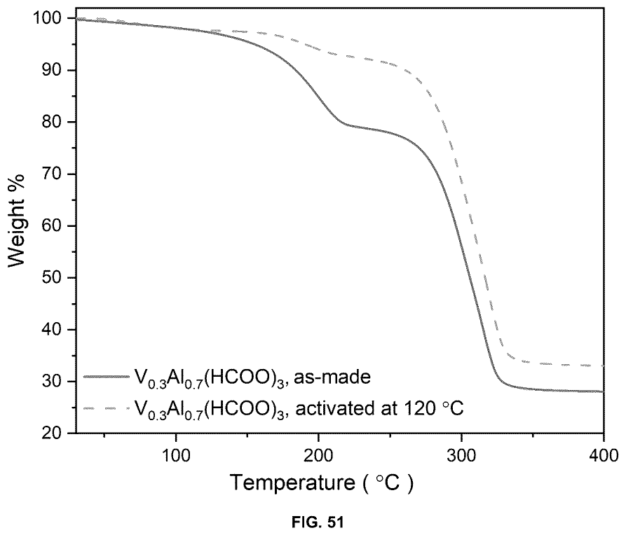

Some of these doped materials, especially Al₁₋ₓFeₓ(COOH)₃, showed enhanced adsorption properties (FIG. 39-41). Single component gas adsorptions isotherms clearly reveal that Fe-doped materials have higher CO₂ adsorption capacity and selectivities than neat ALF (FIGS. 11b, 21 and 40). In addition to the selective adsorption of CO₂ from wet flue gases, there is potential in using ALF for the adsorption of O₂ from air. The mechanism is the same as in the flue gas application: adsorption of the larger N₂ molecule is negligible compared with the adsorption of the smaller O₂. Preliminary results are shown in FIG. 42, where it is seen that the adsorption of O₂ was particularly favourable at 195 K (dry-ice temperature) and with an Fe-doped sample of ALF. These Fe-doped materials showed excellent affinity for O₂ over N₂ at 195 K (FIG. 41). Notably, 85% Fe-doped ALF displayed superior O₂ and CO₂ adsorption capacity over N₂ at relevant temperatures. The BET surface area of AlₓFe₁₋ₓ(HCOO)₃ MOFs were estimated from 298 K CO₂ sorption isotherms, while pore size distribution profiles were obtained by fitting the DFT model to the CO₂ adsorption isotherms. The results suggest that all these materials have uniform micropores (FIG. 43).

1. An activated metal-organic framework of formula I: 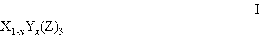
where:
X is a metal in the +3 oxidation state;
Y is one or more metals in the +3 oxidation state, provided that each of the metals that represent X are different to each of the one or metals that represent Y;
x is from 0 to 0.9999, wherein
Z is selected from the group consisting of: HCOO⁻, R¹COO⁻, H₂PO₂⁻, NO₂⁻, 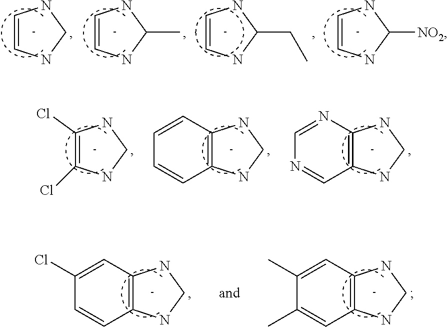
R¹ is C₁ to C₆ alkyl; and
the metal-organic framework has a BET surface area of from 250 to 1,000 m²/g as obtained from a 298 K CO₂ sorption isotherm.

2. The metal-organic framework of formula I according to claim 1, wherein the BET surface area is from 500 to 600 m²/g.

3. The metal-organic framework of formula I according to claim 1, wherein the metal-organic framework has a set of unit-cell parameters where a=b=c=from 11.303 to 11.894 Å, α=β=γ=90°, Volume=from 1562 to 1600 Å³, space group: I m-3.

4. The metal-organic framework of formula I according to claim 1, wherein x is from 0 to 0.99.

5. The metal-organic framework of formula I according to claim 1, wherein X is selected from Al, Fe, Mn, Y, Sc, Ga, In, Ti, Fe, Mn, V, Cr, Co, Tl, Bi, Ru, Os, Re, Ir, Rh, Ce, La, Pr, Nd, Sm, Eu, Gd, Tb, Dy, Ho, Er, Tm, Yb and Lu.

6. The metal-organic framework of formula I according to claim 5, wherein X is Al.

7. The metal-organic framework of formula I according to claim 1, wherein Y, when present, is selected from one or more of the group consisting of Al, Fe, Mn, Y, Sc, Ga, In, Ti, Fe, Mn, V, Cr, Co, Tl, Bi, Ru, Os, Re, Ir, Rh, Ce, La, Pr, Nd, Sm, Eu, Gd, Tb, Dy, Ho, Er, Tm, Yb and Lu.

8. The metal-organic framework of formula I according to claim 7, wherein Y, when present, is Fe.

9. The metal-organic framework of formula I according to claim 1, wherein Z is selected from the group consisting of: HCOO⁻, R¹COO⁻, H₂PO₂⁻, and NO₂⁻.

10. The metal-organic framework of formula I according to claim 9, wherein Z is HCOO⁻.

11. The metal-organic framework of formula I according to claim 1, wherein the metal-organic framework displays a CO₂ adsorption value of from 3 to 6 m mmol/g at 298 K and under 1 atmosphere of CO₂.

12. The metal-organic framework of formula I according to claim 1, wherein the metal-organic framework displays a CO₂ adsorption value of from 2 to 3 mmol/g and from 90 to 150 selectivity over N₂ at 298 K and under 1 atmosphere of total pressure provided by a gas stream of 15% CO₂ and 85% N₂ vol:vol.

13. The metal-organic framework of formula I according to claim 1, wherein the metal-organic framework displays an O₂ adsorption value of from 0.5 to 4 mmol/g at 298 K and under 1 atmosphere of O₂.

14. The metal-organic framework of formula I according to claim 1, wherein it is selected from:
(a) Al(HCOO)₃;
(b) Al_{0.75}Fe_{0.25}(HCOO)₃;
(c) Al_{0.5}Fe_{0.5}(HCOO)₃;
(d) Al_{0.25}Fe_{0.75}(HCOO)₃; and
(e) Al_{0.15}Fe_{0.85}(HCOO)₃;
(f) V(HCOO)₃; and
(g) V_{0.3}Al_{0.7}(HCOO)₃.

15. A method of adsorbing CO₂ and/or O₂ from a gas, comprising subjecting a metal-organic framework of formula I according to claim 1 to a flow of a gas comprising one or both of CO₂ and O₂.

16. The method according to claim 15, wherein the gas further comprises nitrogen and water vapour.

17. The method according to claim 15, wherein the gas has a relative humidity of from less than or equal to 25% to 90%.

18. The method according to claim 17, wherein the gas has a relative humidity of less than or equal to 25%.

19. A method of releasing CO₂ and/or O₂ from a metal-organic framework of formula I according to claim 1 to which CO₂ and/or O₂ has been adsorbed, the process comprising:
(a) providing a metal-organic framework of formula I to which CO₂ and/or O₂ has been adsorbed; and
(b) activating it by subjecting it to:
(i) a temperature of from 90 to 160° C. under reduced pressure for a period of time; or
(ii) a temperature of from 170 to 250° C. under 1 atmosphere pressure for a period of time.

20. A method of obtaining an activated metal-organic framework of formula I according to claim 1, the method comprising the steps of:
(a) providing an unactivated metal-organic framework of formula I; and
(b) activating it by subjecting it to:
(i) a temperature of from 90 to 160° C. under reduced pressure for a period of time; or
(ii) a temperature of from 170 to 250° C. under 1 atmosphere pressure for a period of time,
for a period of time, whereby the BET surface area of the metal-organic framework of formula I is increased to a value of from 500 to 600 m²/g as obtained from a 298 K CO₂ sorption isotherm following step (b).
